(19) United States
(12) Patent Application Publication
(10) Pub. No.: US 2014/0067445 A1
(43) Pub. Date: Mar. 6, 2014

(54) STORAGE MEDIUM STORING ANALYSIS PROGRAM, ANALYSIS METHOD AND ANALYSIS APPARATUS

(71) Applicant: FUJITSU LIMITED, Kawasaki-shi (JP)

(72) Inventor: Hidenori ISHIKAWA, Yokohama (JP)

(73) Assignee: FUJITSU LIMITED, Kawasaki-shi (JP)

(21) Appl. No.: 13/968,759

(22) Filed: Aug. 16, 2013

(30) Foreign Application Priority Data
Sep. 3, 2012 (JP) 2012-193283

(51) Int. Cl. G06Q 10/06

(52) U.S. Cl. CPC G06Q 10/063
USPC 705/7.11

(57) ABSTRACT

A computer-readable storage medium stores a program for causing a computer to execute a process. The process includes: analyzing log data related to a business which includes information regarding a calling relationship between programs in a transaction in which a plurality of programs are executed in order to implement a business process; and generating information which indicates an execution sequence of a plurality of programs in the transaction by excluding a program that has a program executed immediately before and a program executed immediately after, based on the analyzing.

### CROSS-REFERENCE TO RELATED APPLICATION

This application is based upon and claims the benefit of priority of the prior Japanese Patent Application No. 2012-193283 filed on Sep. 3, 2012, the entire contents of which are incorporated herein by reference.

### FIELD

The embodiments discussed herein are related to a storage medium storing an analysis program, an analysis method, and an analysis apparatus.

### BACKGROUND

Recently, many business processes are operated on an IT (Information Technology) system. The IT system that implements the business process is called a business system. The business process includes a plurality of activities. Each activity which constitutes the business process is configured by a series of processes executed on a computer which constitutes the business system. A series of processes executed by the computer is called a transaction.

A plurality of programs are sequentially called out and executed by the computer during the transaction. Also, when the plurality of programs are sequentially called out and executed by the computer, log data which includes information regarding the calling relationship between the plurality of programs are output. Further, the log data which output when the plurality of programs are sequentially called out and executed by the computer is collected and stored by, for example, the business system or a log data collection apparatus coupled to the business system. Further, the log data is also called a transaction log data, and the log data collection apparatus is also called a transaction log data collection apparatus.

Japanese Laid-Open Patent Publication No. 2006-4346 is known as an example of related art.

### SUMMARY

According to an aspect of the invention, a computer-readable storage medium stores a program for causing a computer to execute a process. The process includes: analyzing log data related to a business which includes information regarding a calling relationship between programs in a transaction in which a plurality of programs are executed in order to implement a business process; and generating information which indicates an execution sequence of a plurality of programs in the transaction by excluding a program that has a program executed immediately before and a program executed immediately after, based on the analyzing.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the configuration of an information processing system provided with an analysis apparatus according to the present embodiment.

FIG. 2 is a view illustrating an exemplary configuration of an information processing system provided with the analysis apparatus according to the present embodiment.

FIG. 3 is a view for explaining a business process and a transaction realized by a business system according to the present embodiment.

FIG. 4 is a view for explaining the business process and the transaction realized by the business system according to the present embodiment.

FIG. 5 is a view for explaining a transaction log data collection apparatus and a transaction log data storage DB according to the present embodiment.

FIG. 6 is a view illustrating information which indicates an execution sequence of a plurality of components in a transaction for implementing the business process according to the present embodiment.

FIG. 7 is a view for explaining the identification of a target for visualization in information which indicates an execution sequence of a plurality of components in a transaction for implementing the business process according to the present embodiment.

FIG. 8 is a view for explaining the grouping of information which indicates an execution sequence of a plurality of components in a transaction for implementing the business process according to the present embodiment.

FIG. 9 is a view illustrating an example of the hardware configuration of the analysis apparatus according to the present embodiment.

FIGS. 10A and 10B are flowcharts illustrating the process performed by a transaction log data analysis engine according to the present embodiment.

FIGS. 11A, 11B, 11C and 11D are views each illustrating information of the execution sequence of a plurality of components in the respective transactions for implementing the business process according to the present embodiment.

FIG. 12 is a view illustrating information which indicates the execution sequence of a plurality of components in all transactions for implementing the business process according to the present embodiment.

FIG. 13 is a view illustrating a transaction log data stored in the transaction log data storage DB according to the present embodiment.

FIG. 14 is a view illustrating component information extracted by a transaction log data analysis engine according to the present embodiment.

FIG. 15 is a view illustrating component information stored in a component information storage DB by the processing of the transaction log data analysis engine according to the present embodiment.

FIG. 16 is a view illustrating component information stored in the component information storage DB by the processing of the transaction log data analysis engine according to the present embodiment.

FIG. 17 is a view illustrating component information stored in the component information storage DB by the processing of the transaction log data analysis engine according to the present embodiment.

FIG. 18 is a view illustrating component information stored in the component information storage DB by the processing of the transaction log data analysis engine according to the present embodiment.

FIG. 19 is a view illustrating component information stored in the component information storage DB by the processing of the transaction log data analysis engine according to the present embodiment.

FIGS. 20A and 20B are views illustrating component information stored in the component information storage DB by the processing of the transaction log data analysis engine according to the present embodiment.

FIGS. 21A and 21B are views illustrating component information stored in the component information storage DB by the processing of the transaction log data analysis engine according to the present embodiment.

FIGS. 22A and 22B are views illustrating component information stored in the component information storage DB by the processing of the transaction log data analysis engine according to the present embodiment.

FIGS. 23A and 23B are views illustrating component information stored in the component information storage DB by the processing of the transaction log data analysis engine according to the present embodiment.

FIGS. 24A and 24B are views illustrating component information stored in the component information storage DB by the processing of the transaction log data analysis engine according to the present embodiment.

FIGS. 25A and 25B are views illustrating component information stored in the component information storage DB by the processing of the transaction log data analysis engine according to the present embodiment.

FIGS. 26A and 26B are views illustrating component information stored in the component information storage DB by the processing of the transaction log data analysis engine according to the present embodiment.

FIGS. 27A and 27B are views illustrating component information stored in the component information storage DB by the processing of the transaction log data analysis engine according to the present embodiment.

FIGS. 28A and 28B are views illustrating component information stored in the component information storage DB by the processing of the transaction log data analysis engine according to the present embodiment.

FIGS. 29A are 29B are views illustrating component information stored in the component information storage DB by the processing of the transaction log data analysis engine according to the present embodiment.

FIGS. 30A and 30B are views illustrating component information stored in the component information storage DB by the processing of the transaction log data analysis engine according to the present embodiment.

FIG. 31 is a flowchart illustrating the process conducted by a transaction log data visualization engine according to the present embodiment.

FIGS. 32A and 32B are views illustrating component information referenced by the processing of a transaction log data visualization engine according to the present embodiment.

FIG. 33 is a view illustrating information which indicates an execution sequence of a plurality of programs in a transaction having a transaction ID of “0001” represented by the processing of the transaction log data visualization engine according to the present embodiment.

FIG. 34 is a view illustrating information (in a grouped state) which indicates the execution sequence of a plurality of programs in all transactions represented by the processing of the transaction log data visualization engine according to the present embodiment.

FIG. 35 is a view illustrating information (in a state where group is unfolded) which indicates the execution sequence of a plurality of programs in all transactions represented by the processing of the transaction log data visualization engine according to the present embodiment.

FIG. 36 is a flowchart illustrating the modified example of a specific processing conducted by the transaction log data visualization engine according to the present embodiment.

FIG. 37 is a view illustrating a general process after an order (Order to Cache).

### DESCRIPTION OF EMBODIMENTS

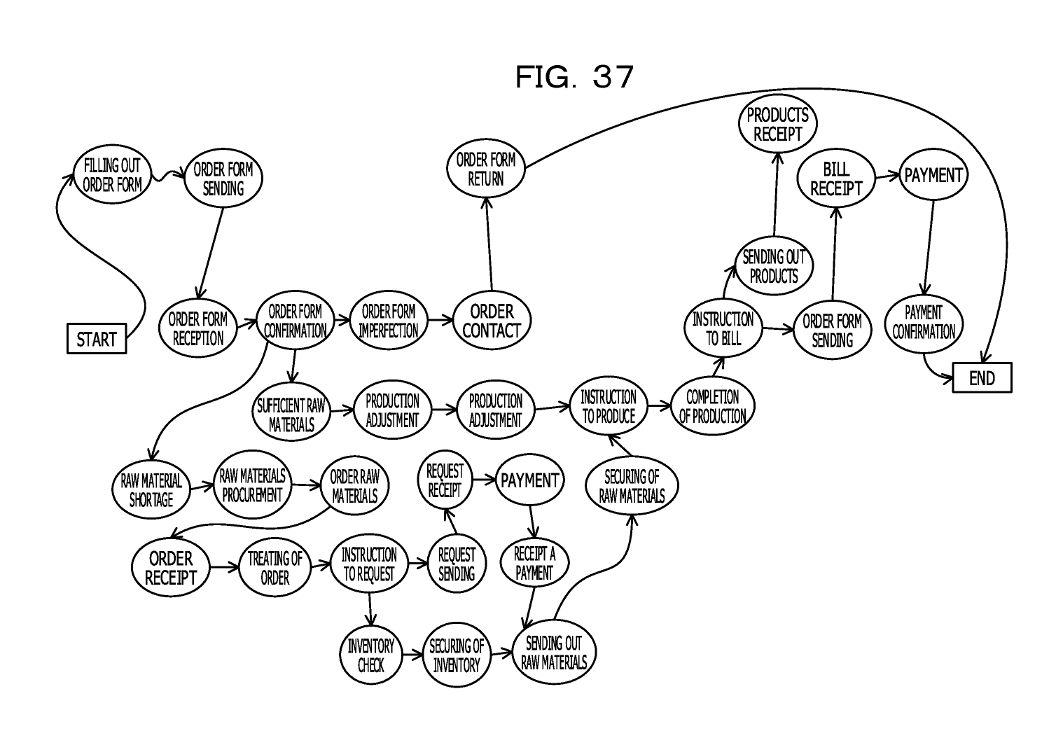

As illustrated in FIG. 37, the number of programs sequentially called out becomes enormous in the business system that implements a general process after an order (Order to Cache) so that the process tends to be complicated in many cases. In this case, if information indicating the execution sequence of a plurality of programs in a transaction is created, the analysis result becomes redundant, so that it may be difficult to specify a piece of information to be noted and obtain a useful analysis result from the viewpoint of business process analysis.

Further, there may be a case where log data collected and stored as described above may include other log data than the log data related to a business output by, for example, a middleware and an infrastructure of an IT system. If information indicating the execution sequence of a plurality of programs in a transaction is generate based on the log data that includes other log data as described above, the generated information may include information unrelated to the original business process to make an analysis result redundant (e.g., unnecessarily lengthy), so that it is difficult to obtain a useful analysis result from the viewpoint of the business process analysis.

According to an aspect, the present disclosure has been made in an effort to provide an analysis program, an analysis method and an analysis apparatus in which the log data related to a business including information regarding the calling relationship between programs in a transaction in which a plurality of programs are executed, is analyzed and the redundancy (e.g., the length) of the analysis result is reduced, so that a more useful analysis result can be provided in order to implement a business process.

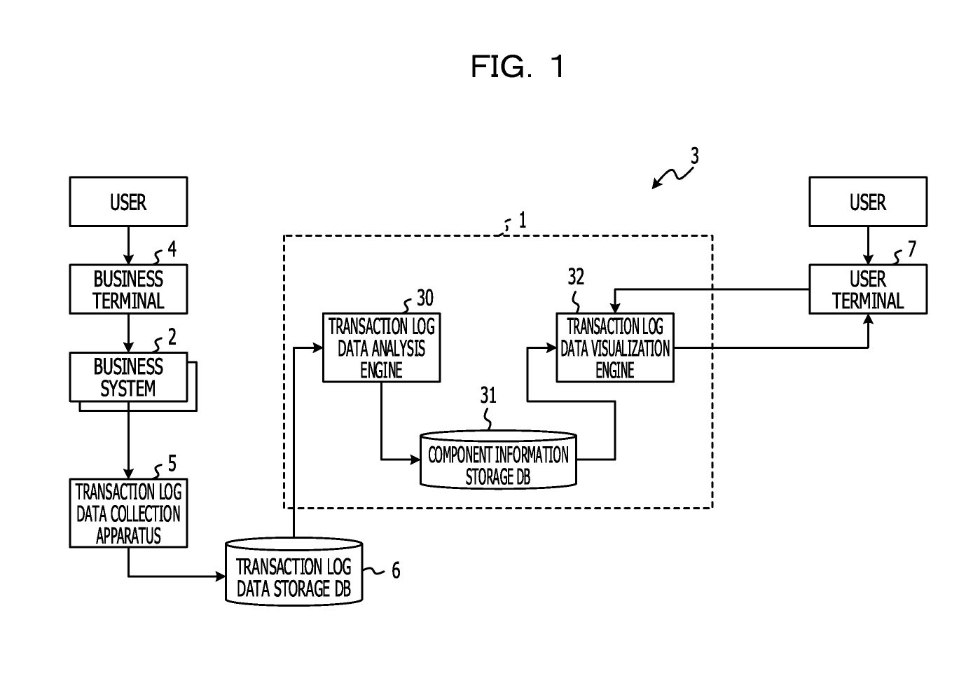

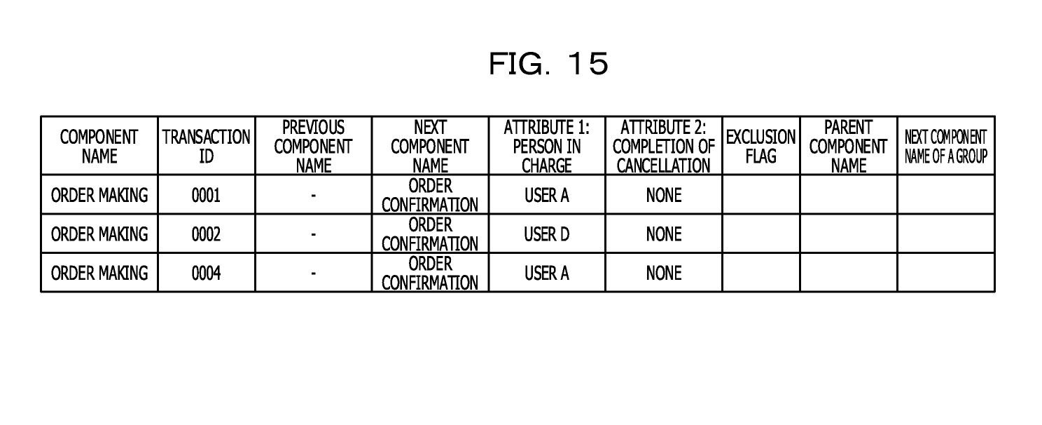

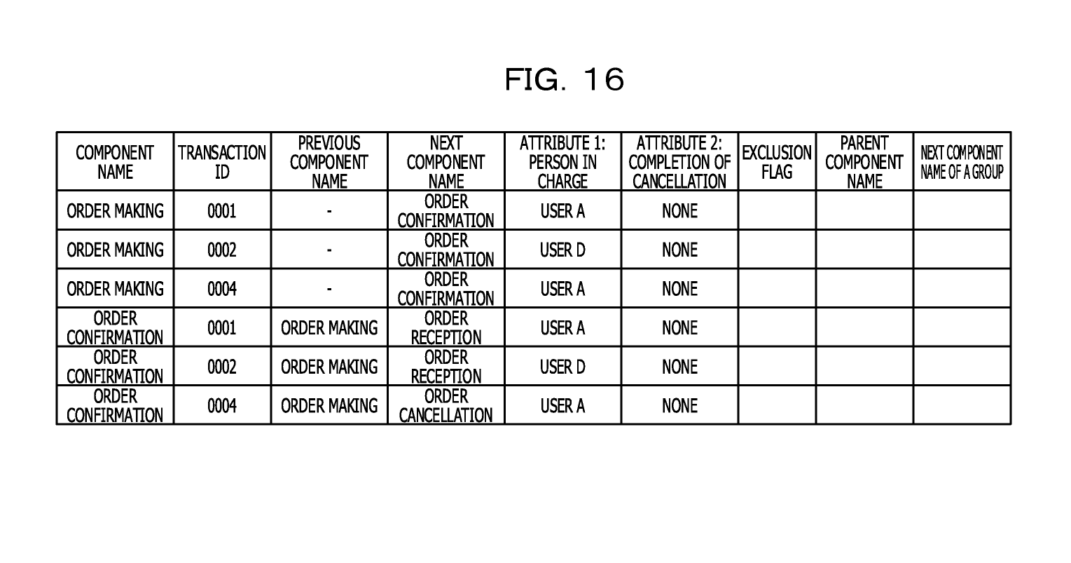

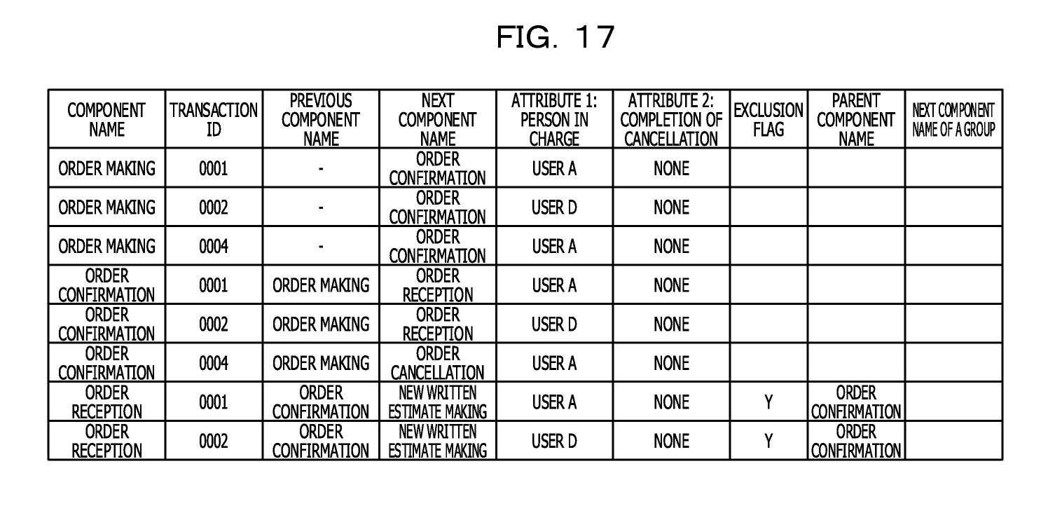

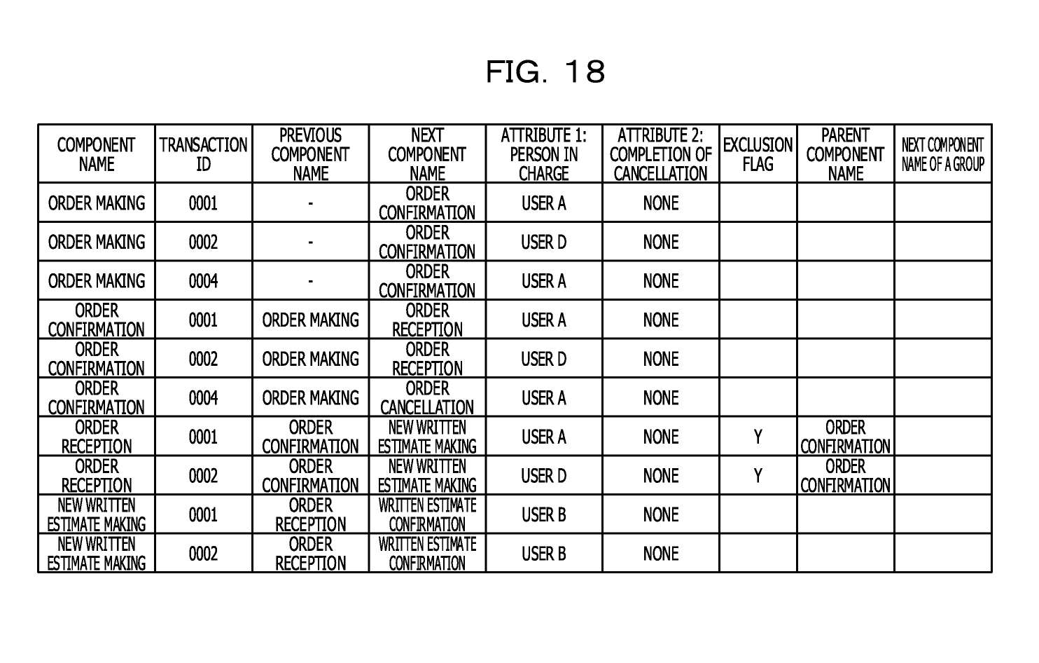

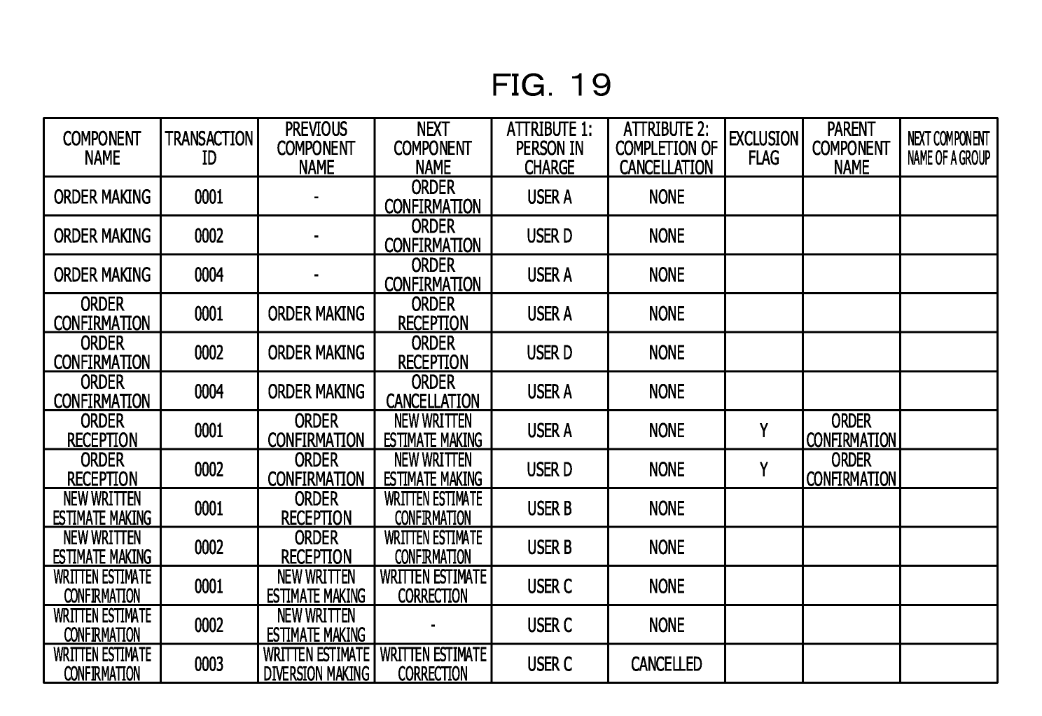

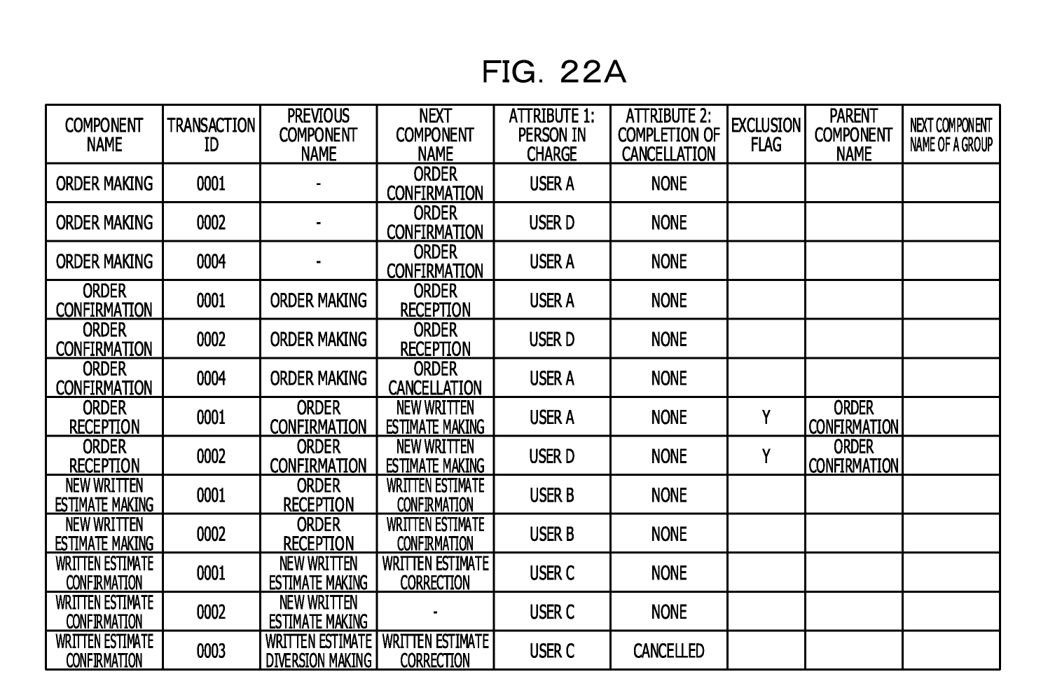

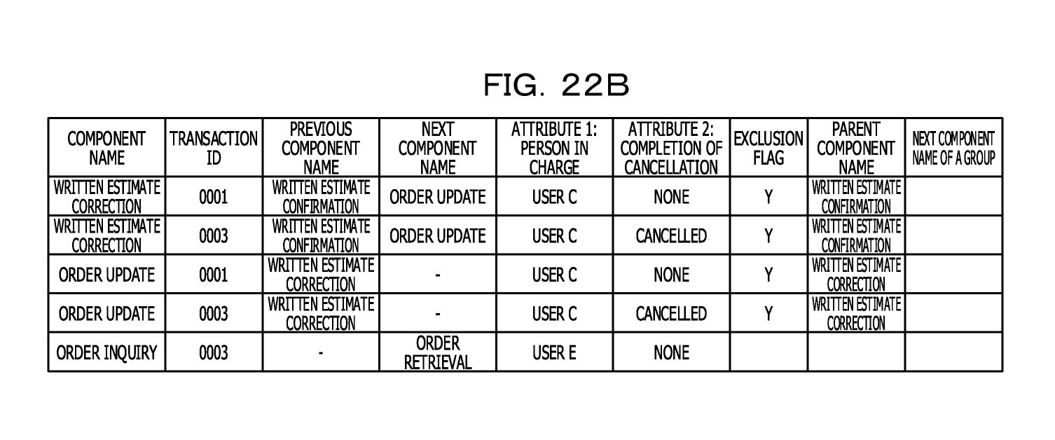

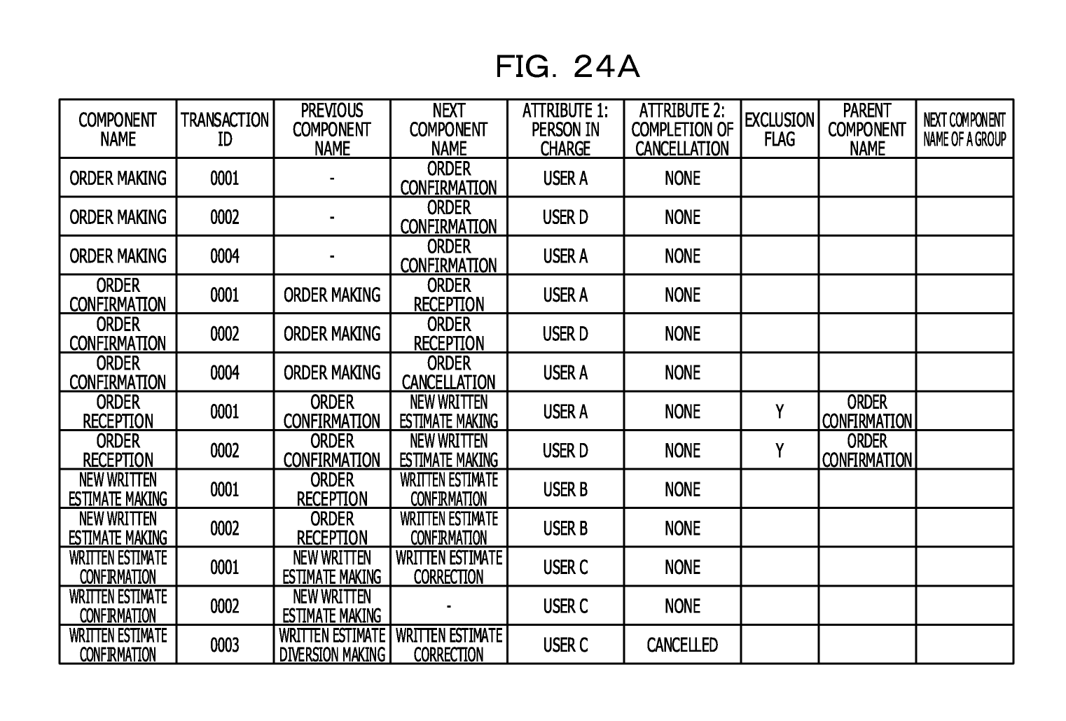

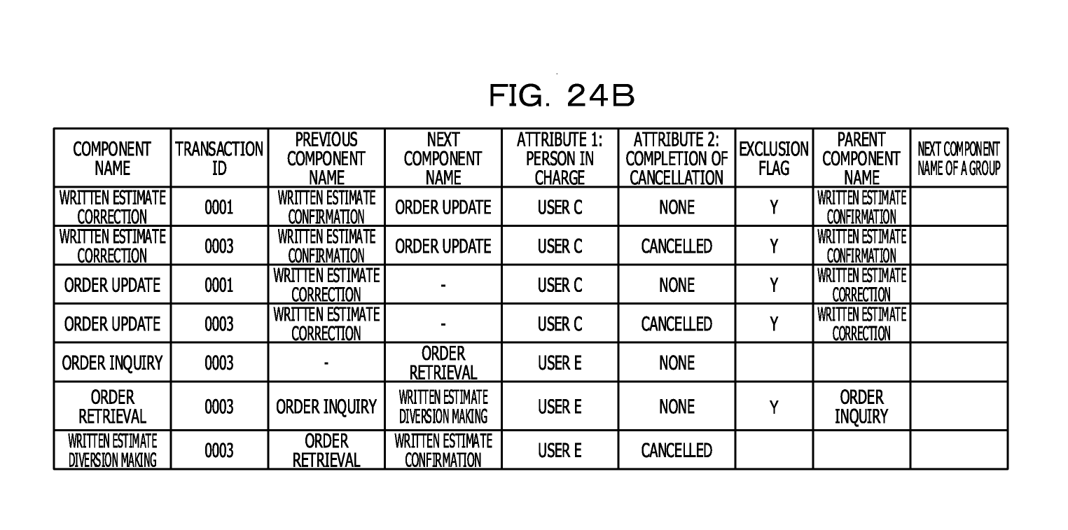

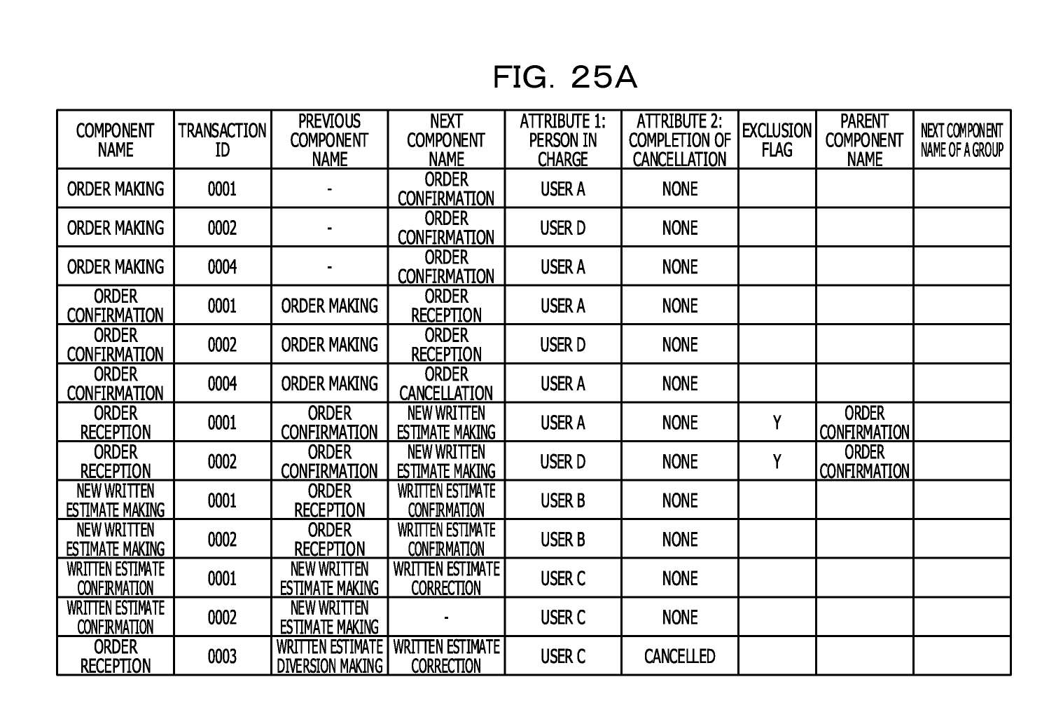

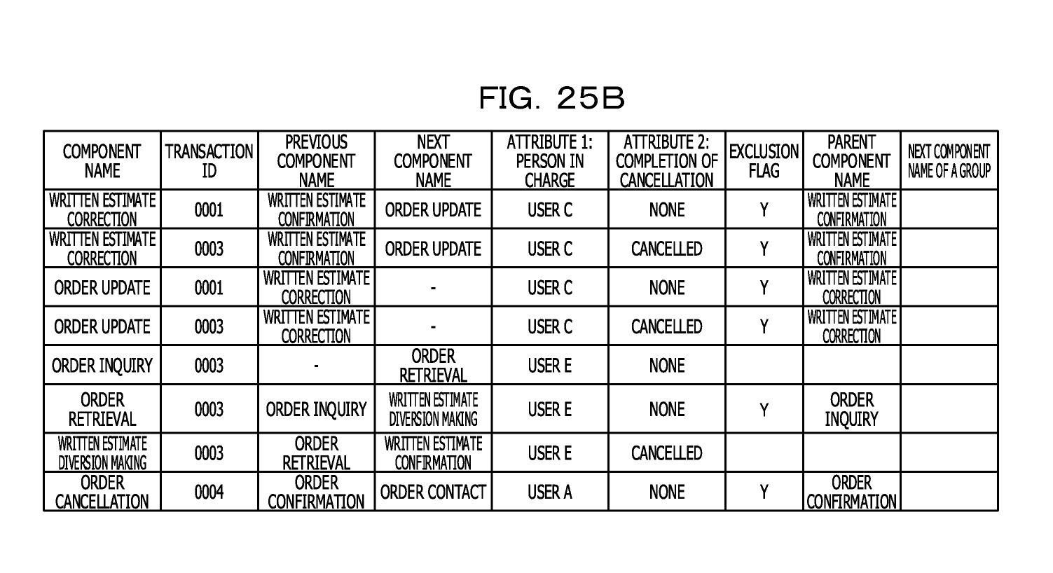

Hereinafter, an analysis program, an analysis method and an analysis apparatus according to the embodiments of the present invention will be described with reference to FIG. 1 to FIG. 36. The analysis apparatus according to the present embodiment is a transaction log data analysis apparatus that analyzes transaction log data related to a business (e.g., a work) including information of calling relationship between programs in a transaction in which a plurality of programs are executed in order to implement a business process (e.g., a work process).

Further, the transaction log data analysis apparatus may also be called a log data analysis apparatus or a business transaction log data analysis apparatus. Further, the transaction and the business transaction log data may also be called a business transaction and a business transaction log data, respectively. For example, as illustrated in FIG. 1, a transaction log data analysis apparatus 1 is coupled to a business system 2 and used to analyze a business process and provide the analyzed result to a user.

For example, an information processing system 3 provided with the transaction log data analysis apparatus 1 includes a business terminal 4, a business system 2, a transaction log data collection apparatus 5, a transaction log data storage database (DB) 6, the transaction log data analysis apparatus 1 and a user terminal 7. In this case, the transaction log data analysis apparatus 1 is coupled to the transaction log data storage DB 6 and the user terminal 7. Also, a user who needs the analysis result for the business process in order to improve the business process may manipulate the user terminal 7 to obtain the analysis result generated by the transaction log data analysis apparatus 1.

Further, a transaction log data related to a business, that is, a transaction log data output by a program related to a business is stored in the transaction log data storage DB 6. That is, it is assumed that the transaction log data stored in the transaction log data storage DB 6 does not include transaction log data other than the transaction log data related to a business, such as, for example, the transaction log data output by a middleware or an infrastructure of the IT system. The transaction log data storage DB 6 is a transaction log data storage unit that stores the transaction log data related to a business including information regarding the calling relationship between programs in a transaction in which a plurality of programs are executed in order to realize the business process. As a result, when the information indicating the execution sequence of a plurality of programs in the transaction is generated, it is possible to reduce the redundancy of the analyzed result.

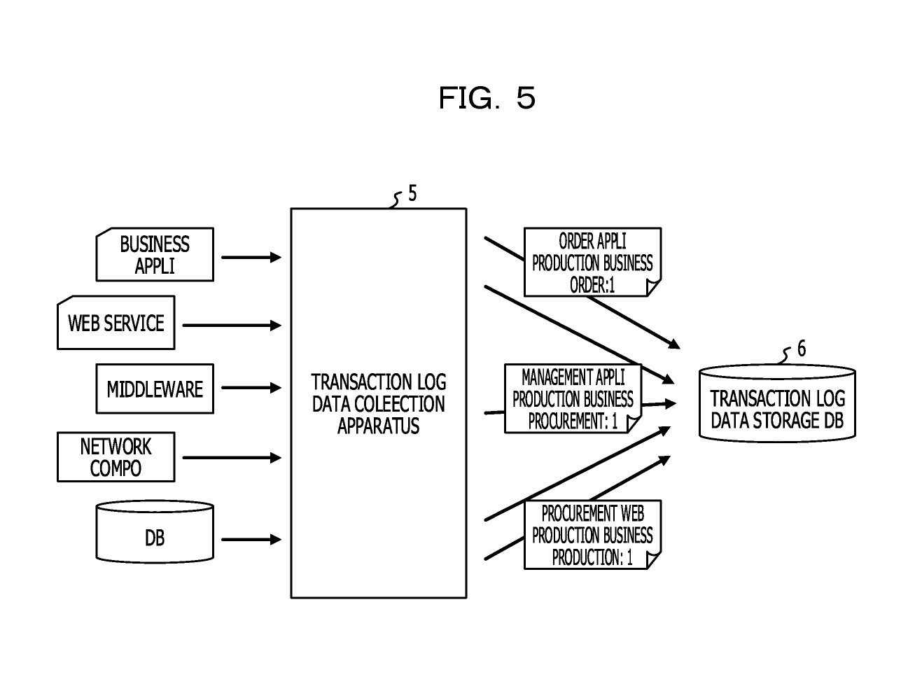

In this case, the transaction log data collection apparatus 5 stores only the transaction log data related to the business in the transaction log data storage DB 6. For example, the transaction log data collection apparatus 5 coupled to the business system 2 collects the transaction log data from the business system 2. Also, the transaction log data collection apparatus 5, as illustrated in FIG. 5, filters the collected transaction log data to store only the transaction log data related to the business in the transaction log data storage DB 6.

The business system 2 is coupled with the business terminal 4 allowing a user (e.g., a business user) of the business system 2 to manipulate the business terminal 4 to use the business system 2. Here, the business system 2 may be an IT system constructed with, for example, a plurality of servers or applications. For example, the business system 2 may be a system formed with a plurality of computers (information processing apparatus) that are communicably coupled via a communication network.

Further, the business system 2 may be configured to include the transaction log data collection apparatus 5. Still further, the business system 2 may be configured to include the transaction log data collection apparatus 5 and the transaction log data storage DB 6. Further, the transaction log data analysis system may be configured to include the transaction log data analysis apparatus 1 and the transaction log data storage DB 6. Still Further, the transaction log data analysis system may be configured to include the transaction log data analysis apparatus 1, the transaction log data storage DB 6 and the transaction log data collection apparatus 5.

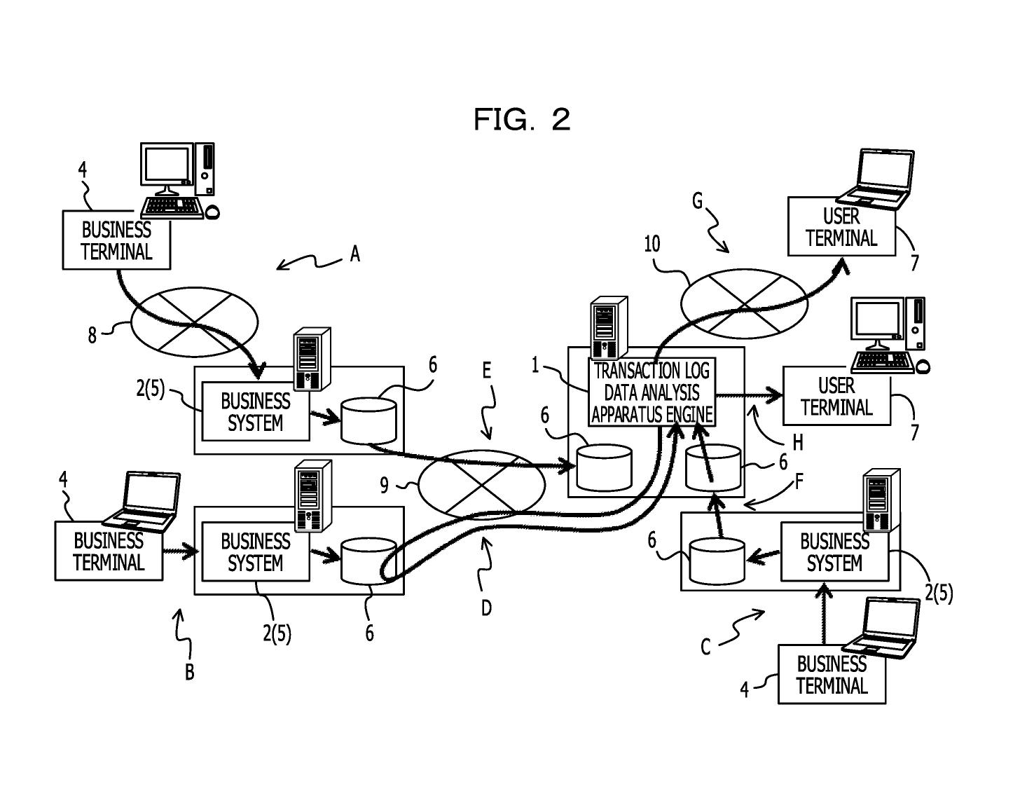

Further, the business terminal 4 and the business system 2 that includes, for example, the transaction log data collection apparatus 5 in this example may be coupled with each other via a network as depicted by reference numeral A in FIG. 2. Alternatively, the business terminal 4 and the business system 2 may be coupled with each other without the network as depicted by reference numerals B, C in FIG. 2. That is, the user of the business system 2 may be allowed to use the business system 2 either via a network 8, or without the network 8. Further, the transaction log data storage DB 6 coupled to the business system 2 may be coupled with the transaction log data analysis apparatus 1 via a network 9 as depicted by reference numeral D in FIG. 2. That is, the transaction log data analysis apparatus 1, the business system 2 and the transaction log data storage DB 6 coupled thereto may be installed at separate places such that the transaction log data analysis apparatus 1 may refer to the transaction log data storage DB 6 via the network 9. Further, as depicted by reference numeral E in FIG. 2, the transaction log data analysis apparatus 1 and the transaction log data storage DB 6 coupled to the business system 2 may be allowed to be installed at separate places such that the transaction log data having been stored in the transaction log data storage DB 6 may be transferred to the transaction log data storage DB 6 coupled to the transaction log data analysis apparatus 1 via the network 9 using, for example, FTP (File Transfer Protocol). Further, as depicted by reference numeral F in FIG. 2, the transaction log data analysis apparatus 1 and the transaction log data storage DB 6 coupled to the business system 2 may be allowed to be installed at the same place such that the transaction log data stored in the transaction log data storage DB 6 coupled to the business system 2 may be allowed to be copied and stored in the transaction log data storage DB 6. Further, the transaction log data analysis apparatus 1, the business system 2 and the transaction log data storage DB 6 coupled thereto may be installed at the same place such that the transaction log data analysis apparatus 1 may refer to the transaction log data storage DB 6. Further, the transaction log data analysis apparatus 1 and the user terminal 7 may be coupled with each other through a network 10 as depicted by reference numeral G in FIG. 2, and may be coupled with each other without going through the network as depicted by reference numeral H in FIG. 2. That is, the user who uses the analyzed result generated by the transaction log data analysis apparatus 1 may be allowed to use the transaction log data analysis apparatus 1 either via a network 10 or without the network.

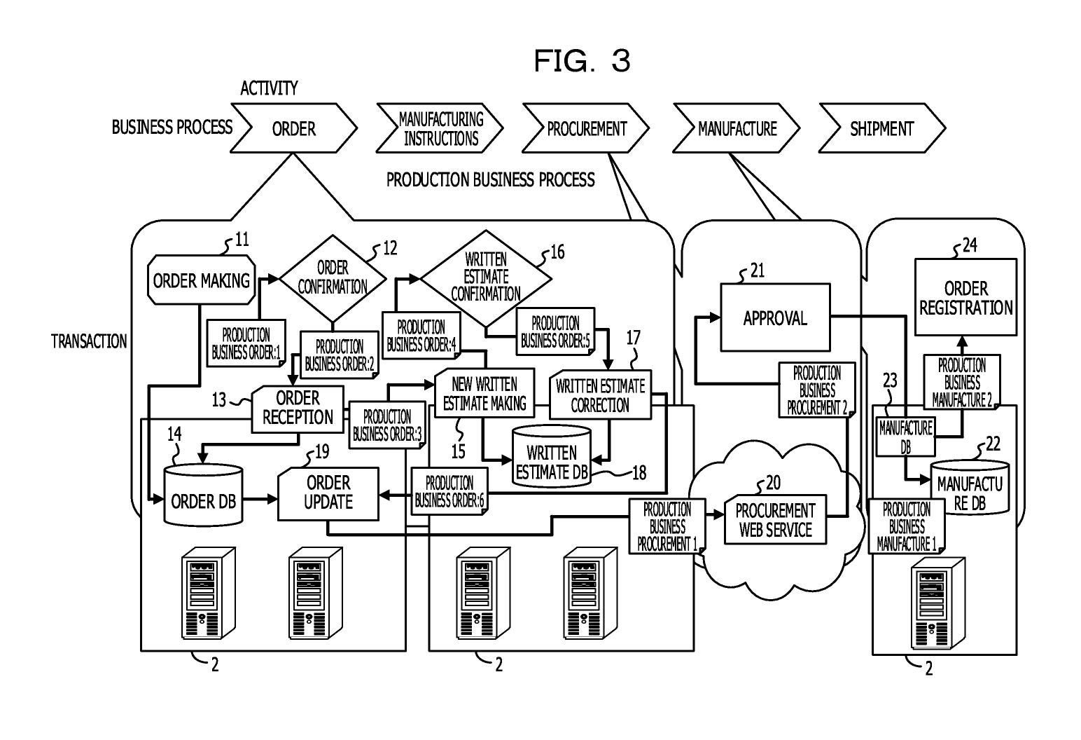

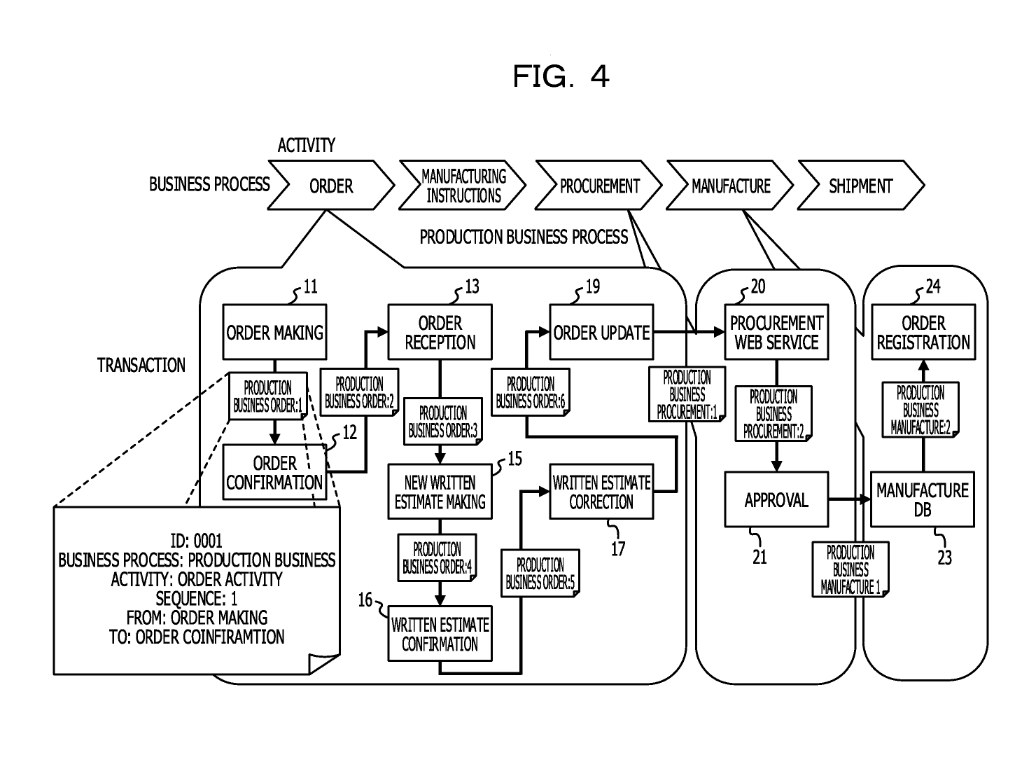

The business process is constituted by a plurality of activities (process). For example, as illustrated in FIGS. 3 and 4, the production business process is constituted by a plurality of activities including, for example, orders, manufacturing instructions, procurements, manufacturing and shipments. Each activity constituting the business process is implemented by a series of processes such as, for example, an order system, a written estimate system and a manufacture system executed on a computer that constitutes the business system 2. The series of processes executed by the computer is called a transaction.

Further, the transaction may be started by the manipulation of a user using, for example, a screen or a terminal. Alternatively, the transaction may be started automatically by the computer using, for example, a batch program executed at a predefined time. Further, the completion of the transaction is notified to a user by, for example, transmitting an e-mail or outputting a report. Alternatively, the completion of the transaction may be associated with the execution of a next program by the computer.

In the transaction, a plurality of programs corresponding to each activity are sequentially called out and executed by the computer constituting the business system 2. That is, information is delivered between a plurality of programs and the series of processes are executed. Further, even in the same business processes, the information is not always delivered between the same programs to execute the series of processes. Also, when the plurality of programs are sequentially called out and executed by the computer, the transaction log data including the information regarding the calling relationship between programs is output. Further, the transaction log data is stored in each computer constituting the business system 2.

Also, the transaction log data output at a time when the plurality of programs are sequentially called out and executed by the computer is collected by the transaction log data collection apparatus 5 coupled to the business system 2, and stored in the transaction log data storage DB 6. Here, the plurality of programs executed in the transaction are called a component software, or simply a component. Further, a function obtained by executing the component software by the computer may be called a component. Further, information delivered between the components is called component information, and information delivered from component A to component B is called component information of the component A. Further, the information of calling relationship between programs corresponds to the information of calling relationship between components (e.g., information corresponding to a component name, a previous component name, or a next component name, which is capable of specifying the sequence of components in a transaction) and is included in the component information. For this reason, the transaction log data includes the component information. That is, the component information is recorded in the transaction log data. Here, the transaction log data includes at least a business process name, an activity name, a transaction identification information (ID), a component name, a previous component name, a next component name, and an attribute information (e.g., a person in charge, a completion of cancellation or the like). The transaction ID and the attribute information among these data are included in the component information. For this reason, the component information includes the component name, the previous component name, the next component name, the transaction ID and the attribute information. Further, the business process name may be any information as long as a business process can be specified by the information. Further, the transaction ID may be any information as long as the transaction can be specified by the information. Further, the component name may be any information as long as a component can be specified by the information. Further, the attribute information may be provided with various items (attribute value), and may include, for example, an authorizer, a product name, and the number of products, in addition to a person in charge, and the completion of cancellation. Further, the component information of a single component in a single business process may have the same attribute in any transaction. For example, an order reception component in a production business process may have the same attribute in any transaction. Further, for example, an order update component in a production business process may have the same attribute in any of transactions. In the meantime, the order reception component and the order update component may not have the same attribute. Further, the order update component in the production business process and the order update component in a sales business process may not have the same attribute.

Here, FIG. 3 is a view illustrating a series of processes performed in a transaction implementing each activity of a business process, by exemplifying a production business process. Further, FIG. 4 is a view illustrating a series of processes executed in a transaction implementing each activity of a business process by removing the middleware (e.g., database) or the infrastructure of the business system 2.

For example, as illustrated in FIG. 3, the business system 2 (e.g., the order system and a written estimate system in this example) includes an order making component 11, an order confirmation component 12, an order reception component 13, an order DB 14, a new written estimate making component 15, a written estimate confirmation component 16, a written estimate correction component 17, a written estimate DB 18, and an order update component 19 in order to realize an order reception activity of the production business process.

Also, the computer first executes a process by the order making component 11 to perform an order making process and stores the result in the order DB 14 in order to implement an order activity. Subsequently, the computer executes a process by the order confirmation component 12 to perform an order confirmation processing. Subsequently, the computer executes a process by the order reception component 13 to perform an order reception process and stores the result in the order DB 14. Subsequently, the computer executes a process by the new written estimate making component 15 to perform a new written estimate making processing and stores the result in the written estimate DB 18. Subsequently, the computer executes a process by the written estimate confirmation component 16 to perform a written estimate confirmation processing. Subsequently, the computer executes a process by the written estimate correction component 17 to perform a written estimate correction processing and stores the result in the written estimate DB 18. Subsequently, the computer executes a process by the order update component 19 to perform an order update processing. By doing this, the order making component 11, the order confirmation component 12, the order reception component 13, the order DB 14, the new written estimate making component 15, the written estimate correction component 17, and an order update component 19 are sequentially called out in order to implement an order activity and a series of processes are executed in the transaction for implementing the order activity.

Further, the business system 2 includes a procurement Web service component 20 and an approval component 21 in order to implement a procurement activity of the production business process. Also, the computer executes a processing by the procurement Web service component 20 first to perform a procurement Web service process in the transaction in order to implement the procurement activity. Subsequently, the computer executes a process by the approval component 21 to perform an approval process. As described above, the procurement Web service component 20 and the approval component 21 are sequentially called out and a series of processes are executed in the transaction in order to implement the order activity for implementing the procurement activity.

Further, the business system 2 (e.g., a manufacture system in this example) includes a manufacture DB 22 and a manufacture DB component 23 in order to execute manufacturing activities of the production business process. Also, the computer first executes a process by the manufacture DB component 23 to store the result of the process by the approval component 21 in the manufacture DB 22 in the transaction in order to implement the manufacture activity. Subsequently, the computer executes a process by the order registration component 24 to perform an order registration process. As described above, the manufacture DB component 23 and the order registration component 24 are sequentially called out and a series of processes are executed in the transaction in order to implement the manufacture activity.

As illustrated in FIG. 4, when a process by the order making component 11 ends and the order confirmation component 12 is called out, information is transmitted from the order making component 11 to the order confirmation component 12 and a transaction log data is output. Also, the transaction log data is stored in a storage device of a computer constituting the business system 2. Here, the transaction log data includes, for example, “0001” indicating a transaction ID which corresponds to a unique identifier for each transaction, a “production business” indicating a business process name, an “order” indicating an activity name, “1” indicating an execution sequence in a transaction which implements the order activity, “order making” indicating a corresponding component name, and “order confirmation” indicating a next component name. Further, the corresponding component name is a source component name, and the next component name is a destination component name.

Similarly, when the process by the order confirmation component 12 ends and the order reception component 13 is called out, information is transmitted from the order confirmation component 12 to the order reception component 13 and a transaction log data is output. Also, the transaction log data is stored in a storage device of a computer constituting the business system 2. Further, when the process by the order reception component 13 ends and the new written estimate making component 15 is called out, information is transmitted from the order reception component 13 to the new written estimate making component 15 and a transaction log data is output. Also, the transaction log data is stored in a storage device of a computer constituting the business system 2.

Further, when the process by the new written estimate making component 15 ends and the written estimate confirmation component 16 is called out, information is transmitted from the new written estimate making component 15 to the written estimate confirmation component 16 and a transaction log data is output. Also, the transaction log data is stored in a storage device of a computer constituting the business system 2.

Further, when the process by the written estimate confirmation component 16 ends and the written estimate correction component 17 is called out, information is transmitted from the written estimate confirmation component 16 to the written estimate correction component 17 and a transaction log data is output. Also, the transaction log data is stored in a storage device of a computer constituting the business system 2.

Further, when the process by the written estimate correction component 17 ends and the order update component 19 is called out, information is transmitted from the written estimate correction component 17 to the order update component 19 and a transaction log data is output. Also, the transaction log data is stored in a storage device of a computer constituting the business system 2. Further, when the process by the order update component 19 ends and the procurement Web service component 20 is called out, information is transmitted from the order update component 19 to the procurement Web service component 20 and a transaction log data is output. Also, the transaction log data is stored in a storage device of a computer constituting the business system 2.

Further, when the process by the procurement Web service component 20 ends and the approval component 21 is called out, information is transmitted from the procurement Web service component 20 to the approval component 21 and a transaction log data is output. Also, the transaction log data is stored in a storage device of a computer constituting the business system 2.

Further, when the process by the approval component 21 ends and the manufacture DB component 23 is called out, information is transmitted from the approval component 21 to the manufacture DB component 23 and a transaction log data is output. Also, the transaction log data is stored in a storage device of a computer constituting the business system 2. Further, when the process by the manufacture DB component 23 ends and the order registration component 24 is called out, information is transmitted from the manufacture DB component 23 to the order registration component 24 and a transaction log data is output. Also, the transaction log data is stored in a storage device of a computer constituting the business system 2.

The transaction log data analysis apparatus 1 according to the present embodiment is adapted to analyze the collected transaction log data and generate information indicating the execution sequence of a plurality of components in a transaction for implementing the business process. That is, the transaction log data analysis apparatus 1 according to the present embodiment is adapted to analyze and visualize the business process executed on the IT system. Further, the transaction log data analysis apparatus 1 visualizes the business process executed by the transaction and thus, is also called a visualization apparatus.

In particular, when generating the information indicating the execution sequence of a plurality of components to visualize a business process, the transaction log data analysis apparatus 1 is adapted to maintain an important component in the business process and remove a component which is related to the component and of which the degree of importance is low in order to reduce the redundancy of the analysis result. That is, when visualizing the business process, the transaction log data analysis apparatus 1 is adapted to remove an unnecessary component depending on the degree of importance in consideration of relevancy between the components. Accordingly, it is possible to reduce the number of target components for visualization.

Further, when visualizing the business process, the transaction log data analysis apparatus 1 is adapted to group a component which is a target component for visualization and a target component for visualization. That is, when visualizing the business process, the transaction log data analysis apparatus 1 is adapted to automatically group the components in a unit which is meaningful in the business process. As a result, it becomes possible to also display the component which is not a target component for visualization as needed while reducing the number of a target component for visualization.

That is, in the present embodiment, the transaction log data analysis apparatus 1 is adapted to analyze the transaction log data automatically collected, automatically determine whether the collected transaction log data falls within any of the following conditions (1), (2), (3), and automatically group components when visualizing a business process, such that the component having a low importance is automatically excluded from the target components for visualization.

(1) In a case where a path is diverged on a transaction path in which a plurality of components are executed but the diverged paths are converged on another path again in order to implement a business process, all or some of the components in a path from a divergence point to a convergence point are grouped as a single business procedure.

The followings are the reasons. The business procedures in a business process are different case by case so that the business procedures may be diverged. However, the business process is divided into several fine business procedures, but in a case where objects achieved by the business procedures are the same, the procedure prior to the procedure that is diverged frequently becomes the same. Therefore, in a case where the diverged procedures are converged again in the future by the same procedure, the procedure during a period from the divergence to the convergence is regarded as a meaningful business procedure and is grouped.

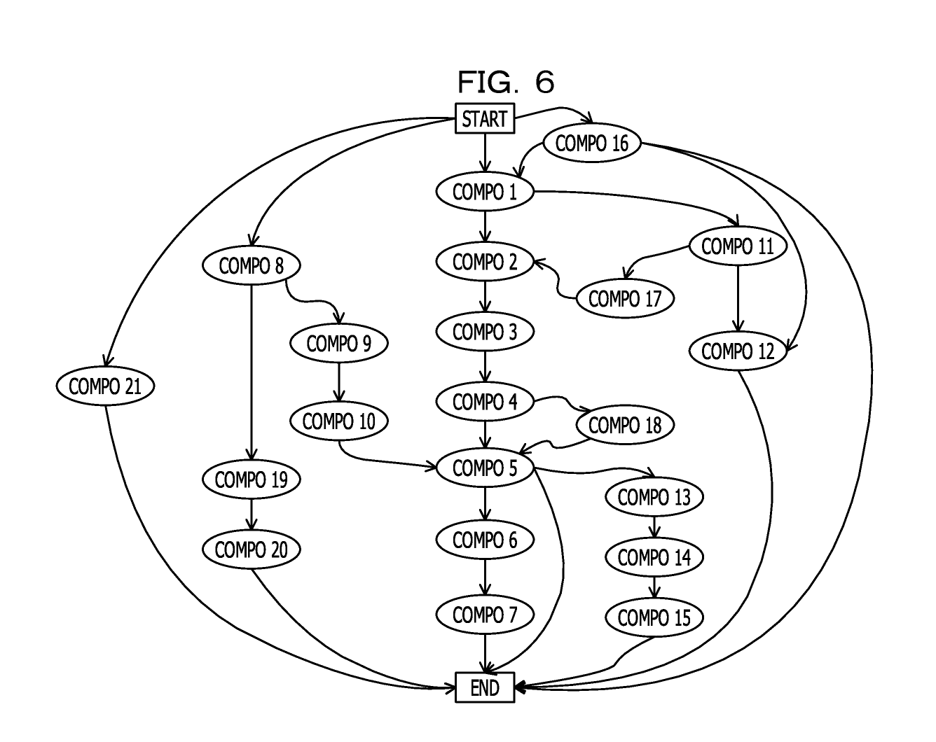

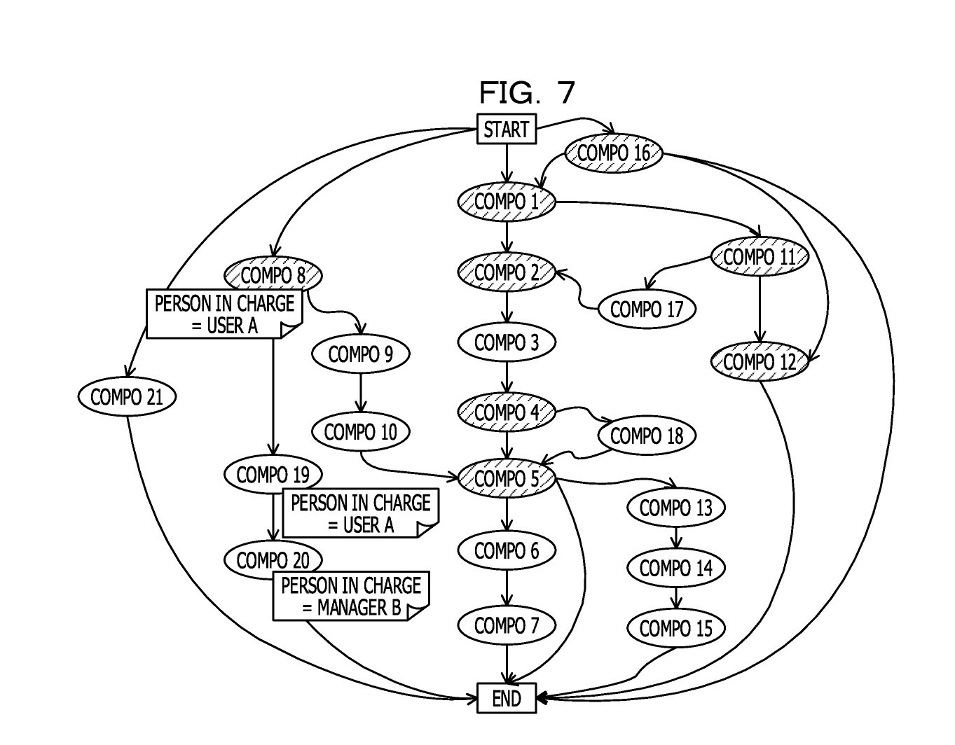

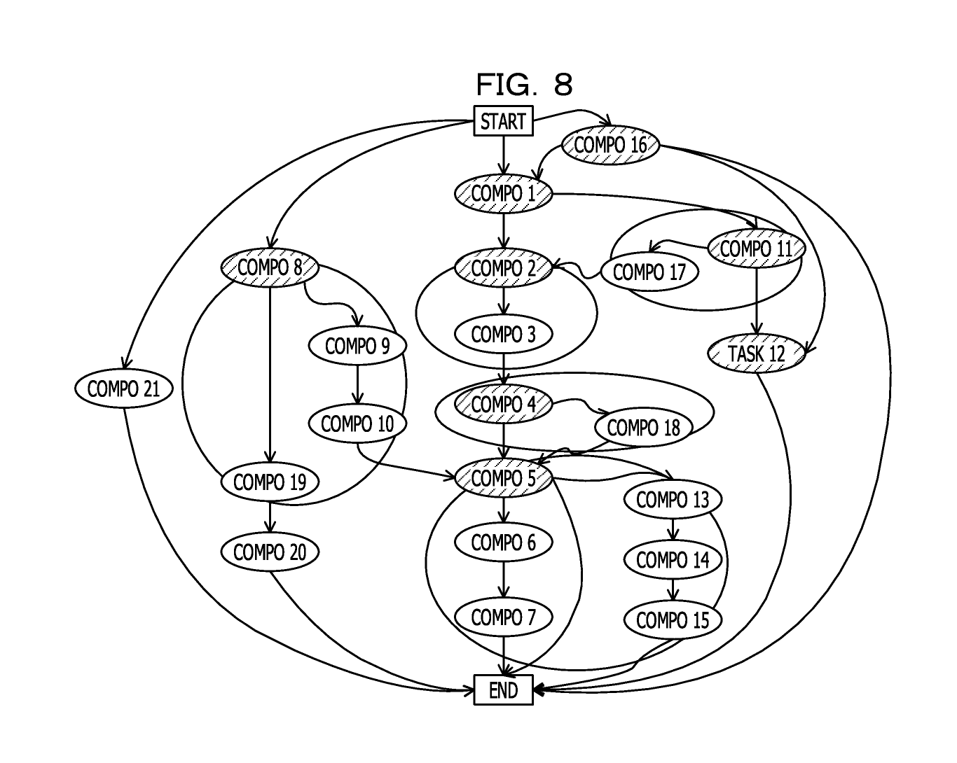

In the grouping, when the business process is visualized, for example, when the business process becomes a state as illustrated in FIG. 6, the component 3, 6, 7, 9, 10, 13, 14, 15, 17, 18, 19, 20 and 21 included in a part where the divergence does not occur and only sequential processing is performed are removed, and the other components 1, 2, 4, 5, 8, 11, 12 and 16 are left, as illustrated in FIG. 7. Also, in the grouping, as illustrated in FIG. 8, the component 3 is grouped into the component 2, the component 18 is grouped into the component 4, the components 6, 7, 13, 14 and 15 are grouped into the component 5, the components 9 and 10 are grouped into the component 8, and the component 17 is grouped into the component 11. Further, the respective components are abbreviated to be denoted by “compo” in FIGS. 6, 7 and 8.

(2) In a case where there is no change in attribute information at previous component and a next component of a certain component in the transaction path, that is, the same attribute information is continuously used, the components are grouped into a single business procedure. In other words, in a case where the attribute information of a component is changed, the component is left.

The followings are the reasons. It is supposed that the attribute information to be referenced and maintained is changed as the procedure of the business proceeds in the business process. This is because that the business intends to achieve some degrees of purpose, and when the purpose is achieved, the attribute information of the business process set before the purpose is achieved, is changed. The fact that there has been no change in the attribute information indicates that the purpose of the business has not been achieved. Accordingly, the procedure until a change in the attribute information is occurred is regarded as a meaningful business procedure and is grouped.

This indicates that when the business process is visualized, for example, when the business process becomes a state as illustrated in FIG. 6, the component 20 is left and the component 19 is grouped into the component 8.

(3) When a component is a unique component in a certain transaction path, the component is left.

This is because that the unique component in a certain transaction path is a meaningful component as a business procedure. This indicates that when the business process is visualized, for example, when the business process becomes a state as illustrated in FIG. 6, the component 21 is left as illustrated in FIG. 8. By doing this, when the business process is visualized, in the information indicating the execution sequence of a plurality of components in the transaction for implementing the business process, for example, as illustrated in FIG. 8, the component 3 is grouped into the component 2 and excluded from the target components for visualization, the component 18 is grouped into the component 4 and excluded from the target components for visualization, the component 17 is grouped into the component 11 and excluded from the target components for visualization, the components 6, 7, 13, 14 and 15 are grouped into the component 5 and excluded from the target components for visualization, and the components 9, 10 and 19 are grouped into the component 8 and excluded from the target components for visualization.

Accordingly, it becomes possible to automatically infer the business process using the transaction log data collected automatically from the business system 2 and perform the visualization of the business process simply and accurately to perform an analysis and a visualization of many business processes at low cost. Also, it becomes possible to readily understand the kind of business processes that have been actually performed in the business system 2. Further, the information indicating the execution sequence of a plurality of components is used to visualize the business process, so that it is possible to make a correspondence of each procedure constituting the business process with each component concurrently with the visualization. Therefore, when a disorder occurs in any component in the business system 2, it is useful for inferring the influential range on a business process. Further, a portion regarded as the same procedure in the business process is grouped to reduce the number of the components and visualize the business process, so that it is possible to provide a more useful analysis result that reduced the redundancy. Further, a component excluded from the target components for visualization (component for non-display) is associated with a component that falls within the target components for visualization (component for display) as a group, so that when a more detailed displaying is needed, it is possible to display the non-display component in a unit of group. Further, a group which displays the non-display component may be selected to concentrate on a noted part in the business process to make it possible to visualize in detail.

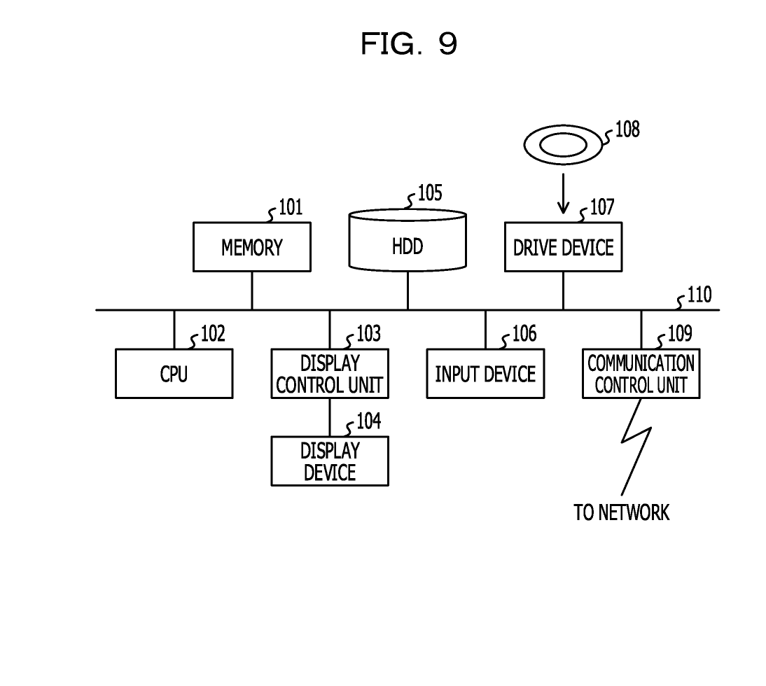

Specifically, the transaction log data analysis apparatus 1 according to the present embodiment is configured as follows. First, the hardware configuration of the transaction log data analysis apparatus 1 will be described with reference to FIG. 9. The transaction log data analysis apparatus 1 may be implemented using a computer, such as, for example, a server, and the hardware configuration of the transaction log data analysis apparatus 1 is provided with, for example, a central processing unit (CPU) 102, a memory 101, a communication control unit 109, an input device 106, a display control unit 103, a display device 104, a storage device 105, a drive device 107 of a portable recording medium 108 as illustrated in FIG. 9, and is configured such that these components are coupled with each other via a bus 110. Further, the hardware configuration of the transaction log data analysis apparatus is not limited to the configuration as described above.

Here, the CPU 102 controls the entirety of the computer, and reads out a program onto a memory 101 and executes the program to carry out the process necessary for the transaction log data analysis apparatus 1. The memory 101 is, for example, a RAM, and stores data or a program temporarily when carrying out, for example, an execution of program or rewriting of data.

The communication control unit 109 (e.g., a communication interface) is used for communicating with other devices via a network, such as for example, a local area network (LAN) or the Internet. The communication control unit 109 may be inserted into the computer from the beginning, or may be a network interface card (NIC) which is attached to the computer later on. The input device 106 is a pointing device, such as for example, a mouse, or a keyboard.

The display device 104 is a display device, such as, for example, a liquid crystal display. The display control unit 103 performs a control for displaying, for example, an analysis result, on the display device 104. Further, the input device 106 or the display device 104 may be an input device or an output device that is provided in a separate computer coupled to the network.

The storage device 105 is, for example, a hard disk drive (HDD), and has various programs and various data stored therein. In the present embodiment, a transaction log data analysis program (analysis program) to be described below is stored in the storage device 105, and further, the component information storage DB 31 to be described below is also stored therein. Further, for example, a read only memory (ROM) may be provided as the memory 101 to store various programs and data.

The drive device 107 is utilized for accessing contents stored in the portable recording medium 108, such as, for example, an optical disc or an opto-magnetic disc. In a computer provided with the hardware configuration described above, the CPU 102 reads out, for example, the transaction log data analysis program stored in the storage device 105 onto the memory 101 to implement the respective functions performed by the transaction log data analysis apparatus 1, that is, a transaction log data analysis engine 30 and a transaction log data visualization engine 32 to be described below.

In the present embodiment, the transaction log data analysis apparatus 1 includes the transaction log data analysis engine 30, the component information storage DB 31 and a transaction log data visualization engine 32, as illustrated in FIG. 1. Further, the transaction log data analysis engine 30 and the transaction log data visualization engine 32 are also referred to as an analysis unit and a creation unit, respectively.

Here, the transaction log data analysis engine 30 has a function that reads out the transaction log data from the transaction log data storage DB 31, analyzes component information included in the transaction log data, that is, determines which component is to be excluded from the target components for visualization, and stores the component information including the analyzed result in the component information storage DB 31.

Here, the transaction log data analysis engine 30 determines which component is to be excluded from the target components for visualization or not based on the following two references (1) and (2). (1) Is a component is a component that does not have a divergence that has only one of a previous component and only one of a next component. (2) Is attribute information of the certain component identical to that of the previous component?

Further, a process by the transaction log data analysis engine 30 may be performed, for example, at a scheduled interval such as, for example, once per a day, or once per a week, at each time when the transaction log data storage DB 6 is updated, at each time when a user visualizes a business process, or when a user explicitly instructs to carry out the processing.

Further, the component information storage DB 31 is utilized for storing component information that reflects the analysis result by the transaction log data analysis engine 30. That is, the component information including a determined result (visualized or not) as to whether a certain component is excluded from the target components for visualization. Here, the analyzed component information includes a component name, a transaction ID, a previous component name, a next component name, attribute information (e.g., a person in charge and the completion of cancellation), an exclusion flag, a parent component name, a next component name of a group. Further, the component information storage DB 31 is also referred to as a component information storage unit.

Further, the transaction log data visualization engine 32 has a function that reads out the component information including the analyzed result by the transaction log data analysis engine 30 from the transaction log data storage DB 31, generates information indicating the execution sequence of a plurality of components in the transaction for implementing the business process using the read out component information, and visualizes the business process.

Here, the transaction log data visualization engine 32 has a function of determining whether a certain component is excluded from the target components for visualization based on the component information read out from the component information storage DB 31, excludes a component determined as not to be visualized from the target components for visualization to generate information indicating the execution sequence of a plurality of components in the transaction, and visualizes the business process.

Further, the process by the transaction log data visualization engine 32 is performed based on the instruction from the user terminal 7. Also, the visualized information visualized according to the process by the transaction log data visualization engine 32 is sent to the user terminal 7 and displayed on a screen of a display device of the user terminal 7. For this reason, the transaction log data analysis apparatus 1 includes the analyzing unit (e.g., a transaction log data analysis engine) 30 which analyzes the log data read out from the transaction log data storage DB 6 described above, and a generating unit 32 (e.g., a transaction log data visualization engine) which excludes a certain program that has one program executed immediately before and one program executed immediately after, based on the analyzed information (component information; program information) by the analyzing unit 30 and generates information indicating the execution sequence of a plurality of components in the transaction. Further, the information analyzed by the analyzing unit 30 includes attribute information, and the generating unit 32 leaves the program executed immediately before and a program of which attribute information is changed among the programs each having one program executed immediately before and one program executed immediately after, thereby generating information indicating the execution sequence. Further, the generating unit 32 leaves a program executed first in the transaction and a program that does not have a program executed immediately before and a program executed immediately after, thereby generating information indicating the execution sequence.

In this case, in the analysis method according to the present embodiment, that is, in the transaction log data analysis method, a computer performs analyzing log data related to a business which includes information of calling relationship between programs in a transaction in which a plurality of programs are executed in order to realize a business process; and generating information which indicates the execution sequence of a plurality of programs in the transaction in such a manner that a program that has one program executed immediately before and one program executed immediately after, based on the analyzed information. Further, the analyzed information includes attribute information, and the computer generates information which indicates the execution sequence to leave a program executed immediately before and a program of which attribute information is changed among the programs each having one program executed immediately before and one program executed immediately after. Further, the computer generates information which indicates the execution sequence to leave a program executed first in the transaction and another program that does not have a program executed immediately before and a program executed immediately after.

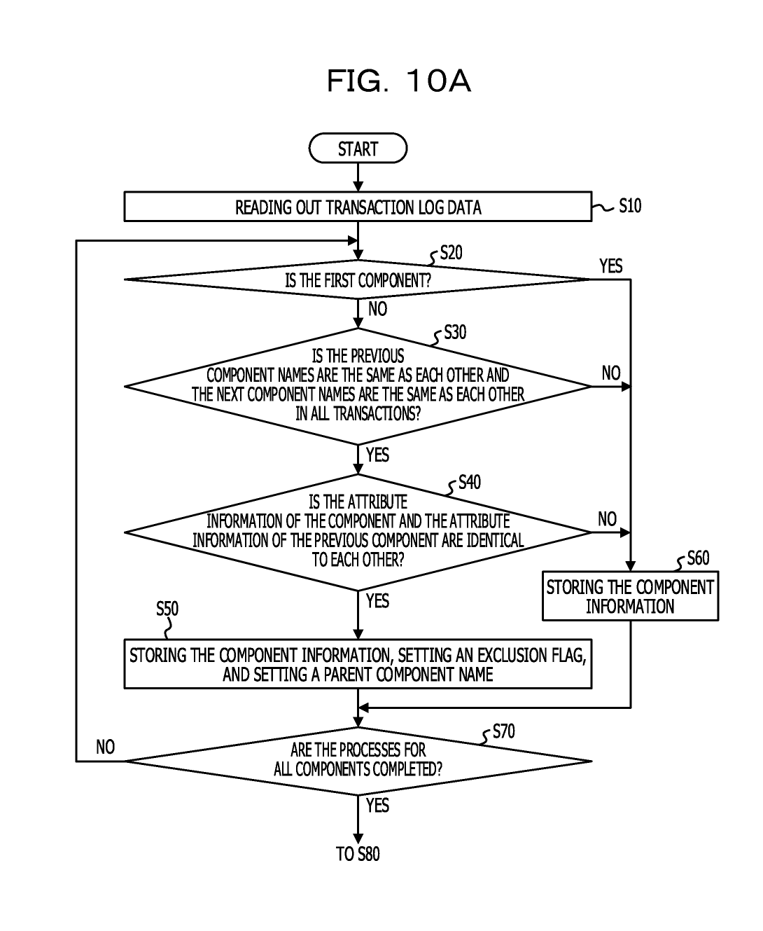

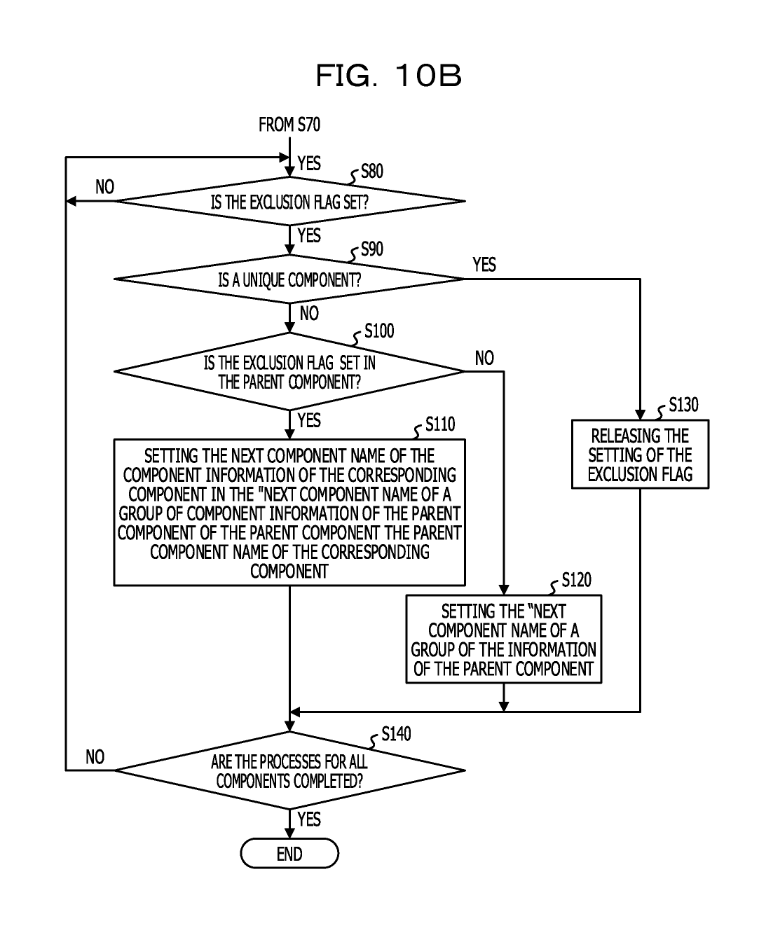

Next, descriptions for a process (e.g., a transaction log data analysis method) executed by the CPU 102 according to a transaction log data analysis program read onto the memory 101 in the transaction log data analysis apparatus 1 will be made more specifically with reference to FIG. 10A to FIG. 36. First, a process by the transaction log data analysis engine 30 provided in the transaction log data analysis apparatus 1 will be described more specifically with reference to FIG. 10A to FIG. 30B.

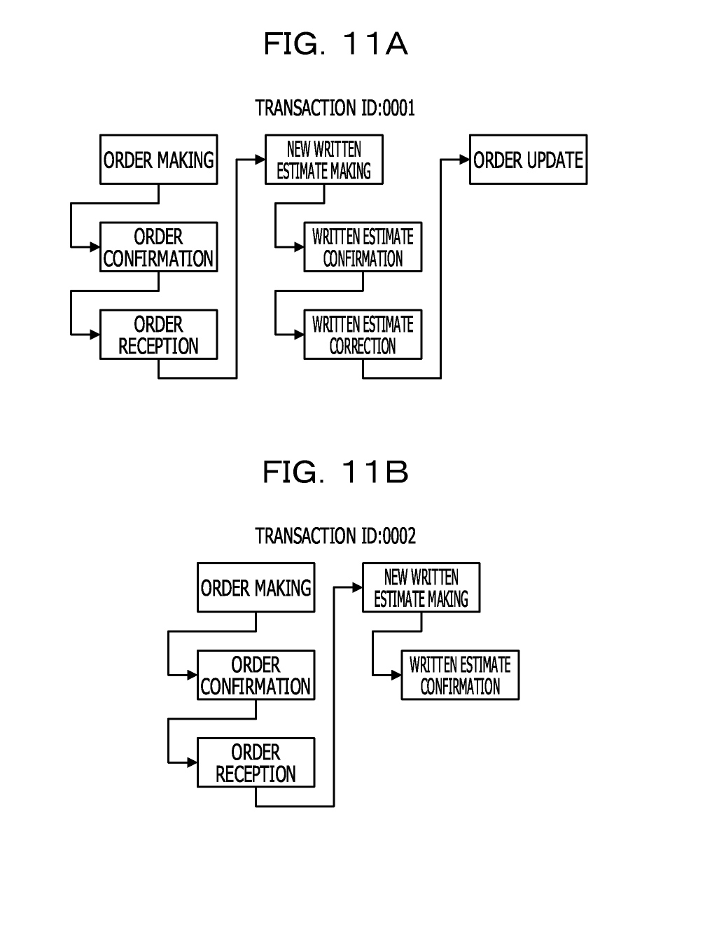

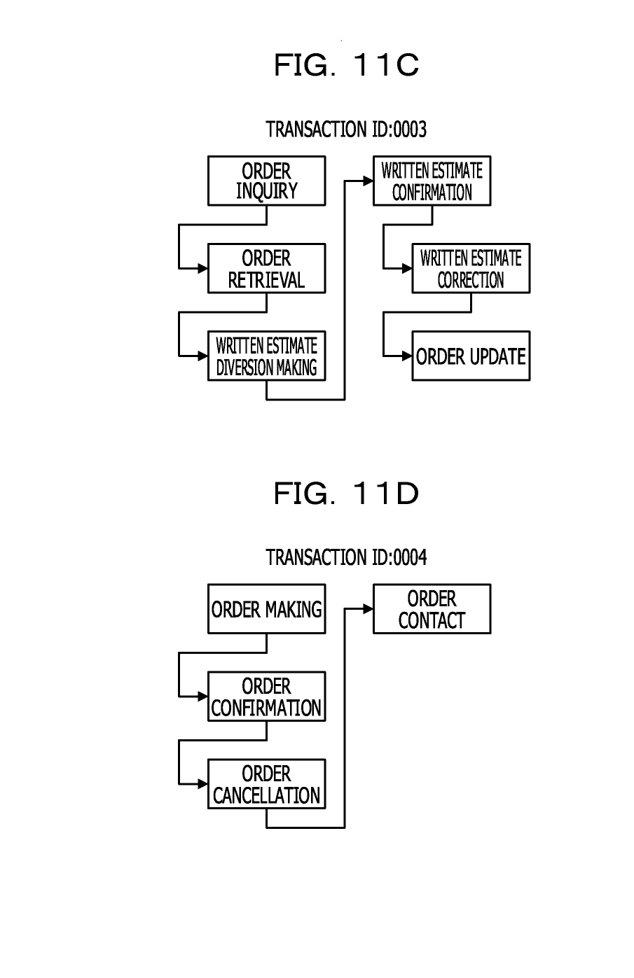

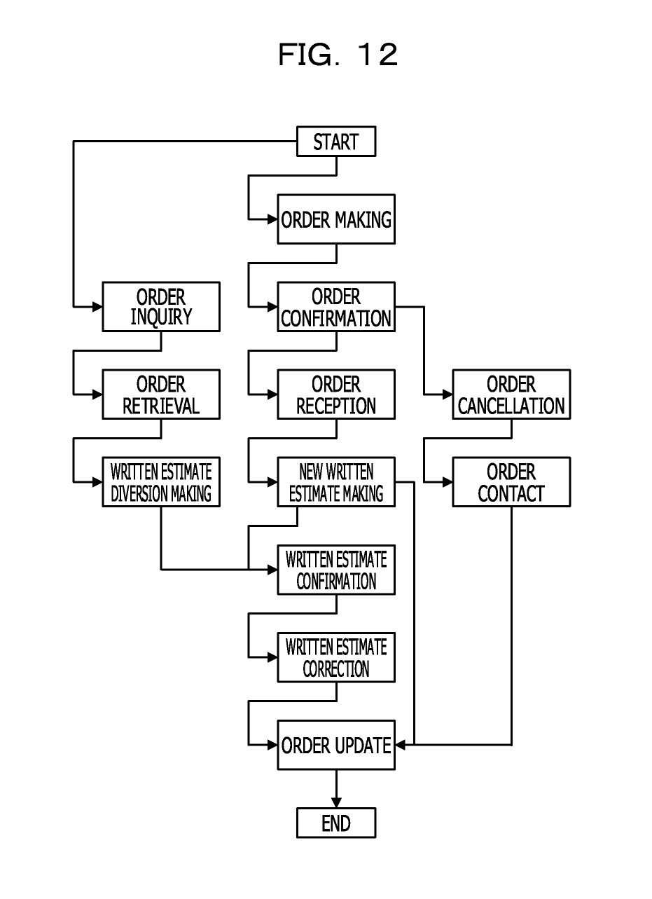

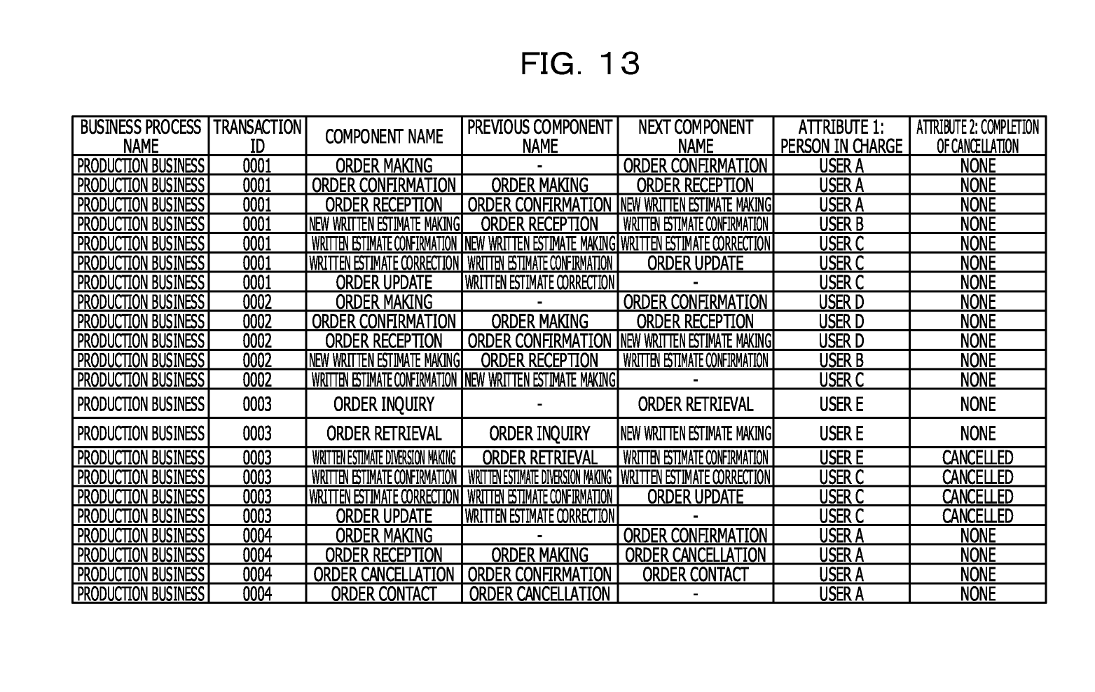

Here, it is assumed that a target business process for analysis is a production business process, and a case where four transactions having transaction IDs of “0001”, “0002”, “0003”, and “0004”, respectively, as transactions for implementing the production business process are included will be described by way of an example. Also, in a case where each of the transactions for implementing the production business process is visualized separately without carrying out the process by the transaction log data analysis apparatus 1 according to the present embodiment as described above, it is assumed that the information indicating the execution sequence of a plurality of components in each transaction corresponds to the views illustrated in FIGS. 11A, 11B, 11C and 11D. Further, in a case where all transactions for implementing the production business process are integrated and visualized without carrying out the process by the transaction log data analysis apparatus 1 according to the present embodiment as described above, it is assumed that the information indicating the execution sequence of a plurality of components in all transactions corresponds to the view illustrated in FIG. 12. Further, it is assumed that the transaction log data as illustrated in FIG. 13 is stored in the transaction log data storage DB 6. Further, the production business process is configured by a plurality of activities as described above. However, the components to be included in an order activity are indicated as the components executed in each transaction, and the components included in activities other than the order activity are omitted in order to simplify the description.

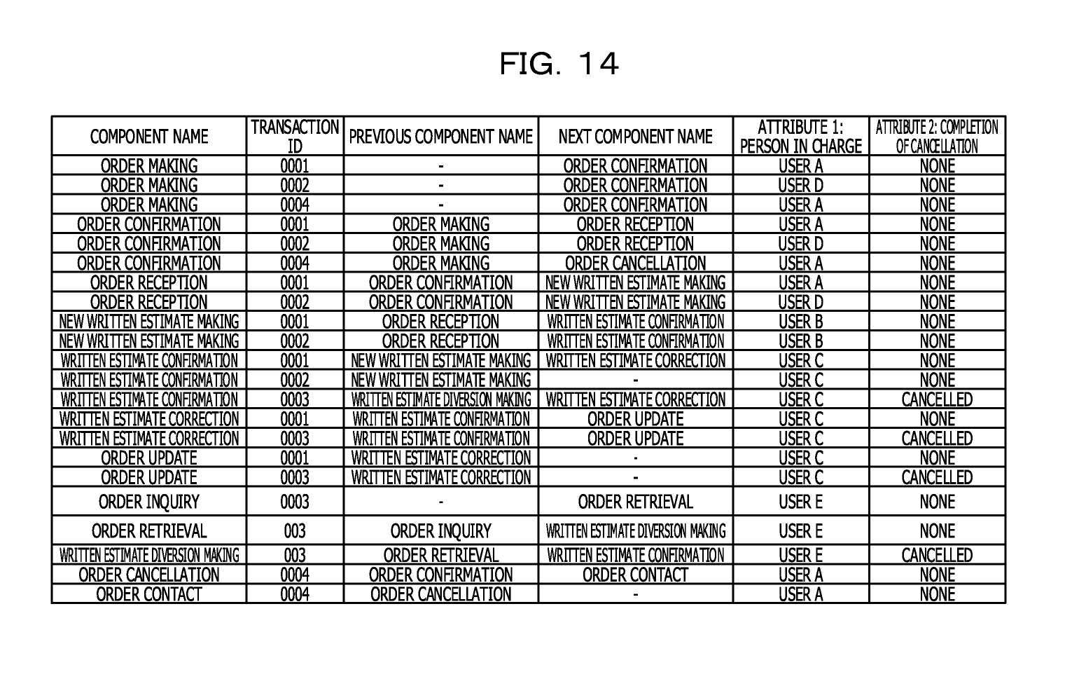

First, as illustrated in FIGS. 10A and 10B, the transaction log data analysis engine 30 reads out the transaction log data from the transaction log data storage DB 6 using a business process name for which a target business process for analysis is specified, and extracts component information as illustrated in FIG. 14 (step S10). Here, the transaction log data analysis engine 30 reads out the transaction log data from the transaction log data storage DB 6 using the business process name of “production business” and as illustrated in FIG. 14, extracts the component information including a component name, a transaction ID, a previous component name, a next component name, and attribute 1 (a person in charge) and attribute 2 (the completion of cancellation) as attribute information.

Subsequently, the transaction log data analysis engine 30 determines whether each component included in the extracted component information corresponds to a first component in any transactions (step S20). Here, it is determined that a component that does not have a “previous component name” of the component information is a first component.

As a result of the determination, when it is determined that the component is the first component, the process proceeds along the YES route, and the transaction log data analysis engine 30 stores the component information of the component in the component information storage DB 31 (step S60). In the meantime, when it is determined that the component is not the first component, the process proceeds along the NO route, and further, the transaction log data analysis engine 30 determines whether the “previous component name” is the same as each other in all transactions and the “next component name” is the same as each other in all transactions for the component (step S30). That is, it is determined whether the component has only one previous component and only one next component, that is, a component without divergence.

As a result of the determination, when it is determined that the “previous component name” is not the same as each other in all transactions and the “next component name” is not the same as each other in all transactions for the component, the process proceeds along the NO route, and the transaction log data analysis engine 30 stores the information of the component in the component information storage DB 31 (step S60). In the meantime, when it is determined that the “previous component name” is the same as each other in all transactions and the “next component name” is the same as each other in all transactions, the process proceeds along the YES route, and further, the transaction log data analysis engine 30 determines whether the attribute information of the component is the same as the attribute information of the previous component (step S40). Here, it is determined whether the respective attribute values of “attribute 1” and “attribute 2” of the component are is the same as the respective attribute values of “attribute 1” and “attribute 2” of the previous component for each transaction, respectively.

As a result of the determination, when it is determined that the attribute information of the component is the same as the previous component in each transaction, the process proceeds along the YES route, the transaction log data analysis engine 30 sets an exclusion flag on the component information of the component while storing the component information of the component in the component information storage DB 31, and further, sets the “previous component name” on a “parent component name” (step S50).

Accordingly, as will be described later, when generating information indicating the execution sequence in the transaction, a component that has one previous component and one next component is removed. Further, as will be described later, when generating information indicating the execution sequence of the transaction, a first component in any transaction, that is, a program executed first in the transaction is left. As described above, the first component in any transaction is not included in a program that has one program executed immediately before and one program executed immediately after.

In the meantime, when it is determined that an attribute information of the component is not the same as the attribute information of the previous component in each transaction, the process proceeds along the NO route and the transaction log data analysis engine 30 stores the component information of the component in the component information storage DB 31 (step S60). The processes for the steps S20, S30, S40, S50, and S60 are performed sequentially for each component included in the extracted component information (see, e.g., FIG. 14). Here, the above described processes are repeated until it is determined that the processes for all components are completed at step S70.

Specifically, the transaction log data analysis engine 30 first determines whether a component having the component name of “order making” (see, e.g., FIG. 14) corresponds to the first component in any of transactions (step S20). As a result of the determination, since the “previous component name” of the component information is not present in any of transactions, it is determined that the component having the component name of “order making” is the first component. Therefore, the process proceeds along the YES route, and the transaction log data analysis engine 30 stores the component information of the component having the component name of “order making” in the component information storage DB 31 (step S60). And then, it is determined at step S70 that not all components have been processed, and the process returns to step S20.

Subsequently, the transaction log data analysis engine 30 determines whether the component having the component name of “order confirmation” (see, e.g., FIG. 14) corresponds to the first component in any of transactions (step S20). As a result of the determination, since the “previous component name” of the component information is present in at least one of the transactions, it is determined that the component having the component name of “order making” is not the first component. Therefore, the process proceeds along the NO route, and further, the transaction log data analysis engine 30 determines whether the “previous component name” is the same as each other in all transactions and the “next component name” is the same as each other in all transactions for the component (step S30). As a result of the determination, since the “next component name” in all the transactions having transaction IDs of “0001” and “0002” is an “order reception” while the “next component name” in the transaction having transaction ID of “0004” is an “order cancellation” which is different from the “order reception”, and thus, it is determined that the “previous component names” are not the same as each other in all the transactions and the “next component names” are not the same as each other in all the transactions for the component. Therefore, the process proceeds along the NO route, and the transaction log data analysis engine 30 stores component information of the component having the component name of “order confirmation” in the component information storage DB 31 (step S60). And then, it is determined at step S70 that not all components have been processed, and the process returns to step S20.

Subsequently, the transaction log data analysis engine 30 determines whether a component having the component name of “order reception” (see, e.g., FIG. 14) corresponds to the first component in any transactions (step S20). As a result of the determination, since the “previous component name” of the component information is present in at least one of the transactions, it is determined that the component having the component name of “order reception” is not the first component. Therefore, the process proceeds along the NO route, and further, the transaction log data analysis engine 30 determines whether the “previous component name” is the same as each other in all the transactions and the “next component name” is the same as each other in all the transactions for the component having the component name of “order reception” (step S30). As a result of the determination, in the transaction IDs of “0001” and “0002”, the “previous component name” is the same as the “order confirmation” and the “next component name” is the same as the “new written estimate making.” And thus, it is determined that the “previous component name” is the same as each other in all the transactions and the “next component name” is the same as each other in all the transactions for the component. Therefore, the process proceeds along the YES route, and further, the transaction log data analysis engine 30 determines whether the attribute information of the component having the component name of “order reception” is the same as the attribute information of the previous component having the component name of “order confirmation” in the transaction IDs “0001” and “0002” (step S40). Here, in the transaction ID of “0001”, it is determined whether the respective attribute values of “attribute 1” and “attribute 2” of the component having the component name of “order reception” are the same as the respective attribute values of “attribute 1” and “attribute 2” of the previous component having the component name of “order confirmation”. Further, in the transaction ID “0002”, it is determined that the respective attribute values of “attribute 1” and “attribute 2” of the component having the component name of “order reception” are the same as the respective attribute values of “attribute 1” and “attribute 2” of the previous component having the component name of “order confirmation”. As a result of the determination, in the component names of “order reception” and “order confirmation” in the transaction ID “0001”, the attribute values of “attribute 1” are the same as “user A” and the attribute values of “attribute 2” are the same as “none”, and thus, it is determined that the attribute information of the component having the component name of “order reception” is the same as the attribute information of the previous component having the component name of “order confirmation” in the transaction ID “0001”. Further, in the component names “order reception” and “order confirmation” in the transaction ID “0002”, the attribute values of “attribute 1” are the same as “user D” and the attribute values of “attribute 2” are the same as “none”, and thus, it is determined that the attribute information of the component having the component name of “order reception” is the same as the attribute information of the previous component having the component name of “order confirmation” in the transaction ID “0002”. Therefore, the process proceeds along the YES route, the transaction log data analysis engine 30 sets “Y”, as an exclusion flag, in the component information of the component having the component name of “order reception” while storing the component information of the component having the component name of “order reception” in the component information storage DB 31, and further, sets the “order confirmation” which corresponds to the “previous component name” in a “parent component name” (step S50). Further, it is determined that not all components have been processed at step S70, and the process returns to step S20.

Subsequently, the transaction log data analysis engine 30 determines whether a component having the component name is of “new written estimate making” (see, e.g., FIG. 14) corresponds to the first component in any of transactions (step S20). As a result of the determination, the “previous component name” of the component information is present in any of transactions, so that it is determined that the component having the component name of “new written estimate making” is not the first component. Therefore, the process proceeds along the NO route, and further, the transaction log data analysis engine 30 determines whether the “previous component name” is the same as each other in all transactions and the “next component name” is the same as each other in all transactions for the component having the component name of the “new written estimate making” (step S30). As a result of the determination, in the transaction IDs “0001” and “0002”, the “previous component name” is the same as the “order reception” and the “next component name” is the same as the “written estimate confirmation”. And thus, it is determined the “previous component name” is the same as each other in all transactions and the “next component name” is the same as each other in all transactions for the component. Therefore, the process proceeds along the YES route, and further, the transaction log data analysis engine 30 determines whether attribute information of the component having the component name of the “new written estimate making” is the same as attribute information of the previous component having the component name of the “order reception” in the transaction IDs “0001” and “0002” (step S40). Here, it is determined whether the respective attribute values of “attribute 1” and “attribute 2” of the component having the component name of the “new written estimate making” the same as the respective attribute values of “attribute 1” and “attribute 2” of the previous component having the component name of the “order reception” in the transaction ID “0001”, respectively. Further, it is determined whether the respective attribute values of “attribute 1” and “attribute 2” of the component having the component name of the “new written estimate making” the same as the respective attribute values of “attribute 1” and “attribute 2” of the previous component having the component name of the “order reception” in the transaction ID “0002”, respectively. As a result, the respective attribute values of “attribute 1” are “user A” and “user A” and the attribute values differs from each other in the component names “new written estimate making” and “order reception” in the transaction ID “0001” and thus, it is determined that the attribute information of the component having the component name of the “new written estimate making” is not the same as attribute information of the previous component having the component name of the “order reception” in the transaction ID “0001”. Further, the respective attribute values of “attribute 1” are “user B” and “user D” and the attribute values differs from each other in the component names “new written estimate making” and “order reception” in the transaction ID “0002” and thus, it is determined that the attribute information of the component having the component name of the “new written estimate making” is not the same as the attribute information of the previous component having the component name is the “order reception” in the transaction ID “0002”. Therefore, the process proceeds along the NO route, and the transaction log data analysis engine 30 stores component information of the component having the component name of the “new written estimate making” in the component information storage DB 31 (step S60), and it is determined that not all components have been processed at step S70, and the process returns to step S20.

Subsequently, the transaction log data analysis engine 30 determines whether a component having the component name of a “written estimate confirmation” (see, e.g., FIG. 14) corresponds to the first component in any of transactions (step S20). As a result of the determination, the “previous component name” of the component information is present in any of transactions, so that it is determined that the component having the component name of the “written estimate confirmation” is not the first component. Therefore, the process proceeds along the NO route, and further, the transaction log data analysis engine 30 determines whether the “previous component name” is the same as each other in all transactions and the “next component name” is the same as each other in all transactions for the component having the component name of the “written estimate confirmation” (step S30). As a result of the determination, the “next component name” in the transaction IDs “0001” and “0003” is a “written estimate correction” while the “next component name” in the transaction ID “0002” is a “none” and the next component names differ from each other, and thus, it is determined that the “previous component name” is not the same as each other in all transactions and the “next component name” is not the same as each other in all transactions for the component. Therefore, the process proceeds along the NO route, and the transaction log data analysis engine 30 stores component information of the component having the component name of the “written estimate confirmation” in the component information storage DB 31 (step S60), and it is determined that not all components have been processed at step S70, and the process returns to step S20.

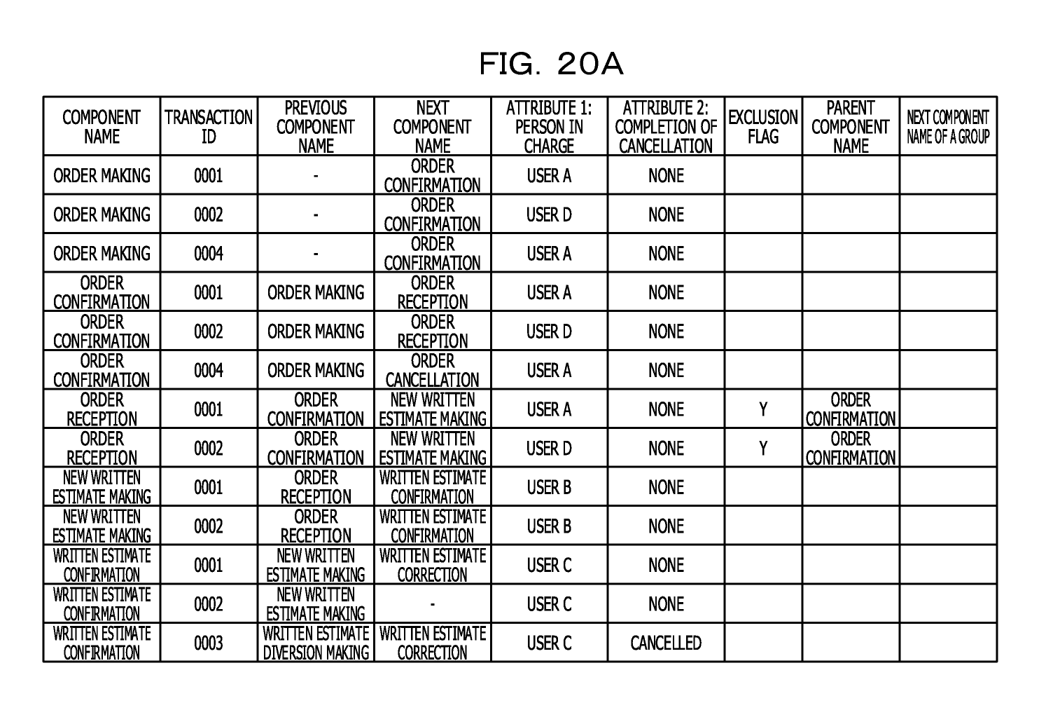

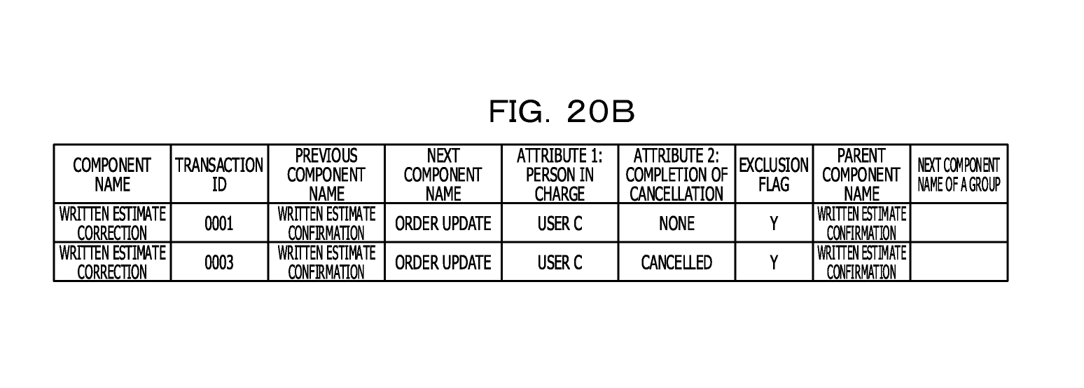

Subsequently, the transaction log data analysis engine 30 determines whether a component having the component name of a “written estimate correction” (see, e.g., FIG. 14) corresponds to the first component in any of transactions (step S20). As a result of the determination, the “previous component name” of the component information is present in any of transactions, so that it is determined that the component having the component name of “written estimate confirmation” is not the first component. Therefore, the process proceeds along the NO route, and further, the transaction log data analysis engine 30 determines whether the “previous component name” is the same as each other in all transactions and the “next component name” is the same as each other in all transactions for the component having the component name of the “written estimate correction” (step S30). As a result of the determination, in the transaction IDs “0001” and “0003”, the “previous component name” is the same as the “written estimate confirmation” and the “next component name” the same as the “order update”. And thus, it is determined that the “previous component name” is not the same as each other in all transactions and the “next component name” in all transactions are the same for the component. Therefore, the process proceeds along the YES route, and further, the transaction log data analysis engine 30 determines whether attribute information of the component having the component name of the “written estimate correction” is the same as attribute information of the previous component having the component name of the “written estimate confirmation” in the transaction IDs “0001” and “0003” (step S40). Here, it is determined whether the respective attribute values of “attribute 1” and “attribute 2” of the component of which component is the “written estimate correction” are the same as the respective attribute values of “attribute 1” and “attribute 2” of the previous component of which component is the “written estimate confirmation” in the transaction ID “0001”, respectively. Further, it is determined whether the respective attribute values of “attribute 1” and “attribute 2” of the component of which component is the “written estimate correction” are the same as the respective attribute values of “attribute 1” and “attribute 2” of the previous component of which component is the “written estimate confirmation” in the transaction ID “0003”, respectively. As a result of the determination, both the attribute values of “attribute 1” are the same as “user C” and both the attribute values of “attribute 2” are the same as “none” in the component names “written estimate correction” and “written estimate confirmation” in the transaction ID “0001” and thus, it is determined that the attribute information of the component of which component is the “written estimate correction” are the same as the attribute information of the previous component of which component is the “written estimate confirmation” in the transaction ID “0001”. Further, both the attribute values of “attribute 1” are the same as “user C” and both the attribute values of “attribute 2” are the same as “end” in the component names “written estimate correction” and “written estimate confirmation” in the transaction ID “0003” and thus, it is determined that the attribute information of the component of which component is the “written estimate correction” are the same as the attribute information of the previous component of which component is the “written estimate confirmation” in the transaction ID “0003”. Therefore, the process proceeds along the YES route, the transaction log data analysis engine 30 sets “Y”, as an exclusion flag, in the component information of the component having the component name of “written estimate correction” while storing the component information of the component having the component name of “written estimate correction” in the component information storage DB 31, and further, sets the “written estimate confirmation” which corresponds to the “previous component name” in a “parent component name”, as illustrated in FIGS. 20A and 20B (step S50), and, it is determined that not all components have been processed at step S70, and the process returns to step S20.

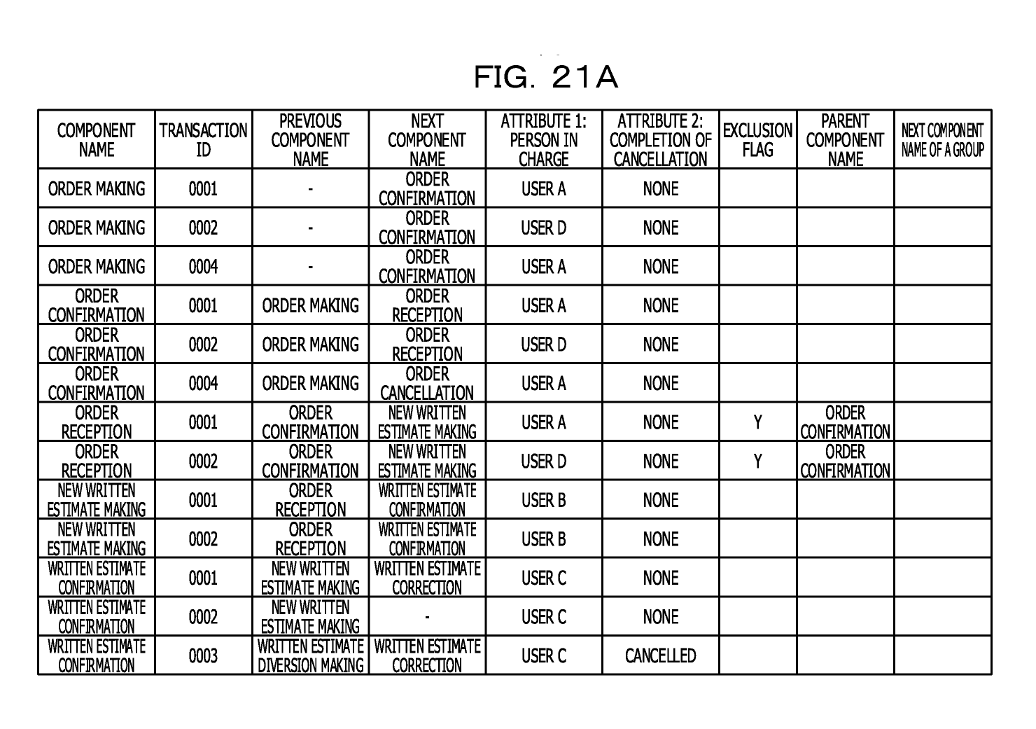

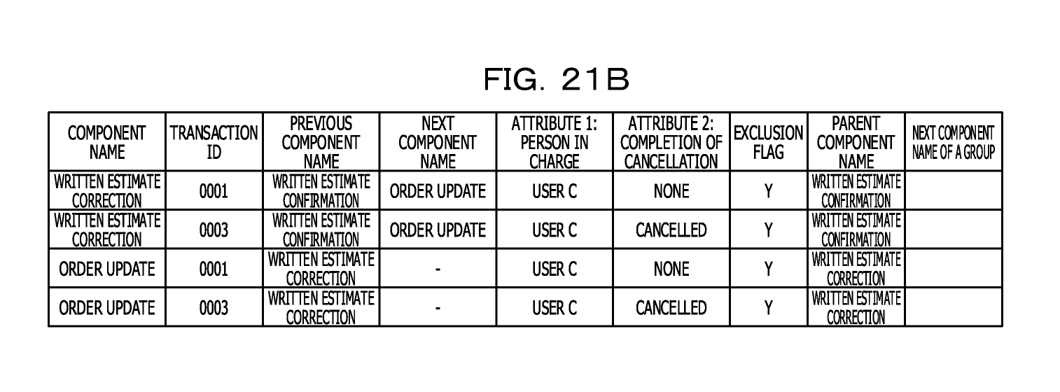

Subsequently, the transaction log data analysis engine 30 determines whether a component having the component name of an “order update” (see, e.g., FIG. 14) corresponds to the first component in any of transactions (step S20). As determination result, the “previous component name” of the component information is present in any of transactions, so that it is determined that the component having the component name of “order update” is not the first component. Therefore, the process proceeds along the NO route, and further, the transaction log data analysis engine 30 determines whether the “previous component name” in all transactions is the same as each other in all transactions and the “next component name” is the same as each other in all transactions for the component having the component name of the “order update” (step S30). As a result of the determination, in the transaction IDs “0001” and “0003”, the “previous component name” is the same the “written estimate correction” and the “next component name” is the same a “none”. And thus, it is determined that the “previous component name” is the same as each other in all transactions and the “next component name” is the same as each other in all transactions. Therefore, the process proceeds along the YES route, and further, the transaction log data analysis engine 30 determines whether attribute information of the component having the component name of the “order update” is the same as attribute information of the previous component having the component name of the “written estimate correction” in the transaction IDs “0001” and “0003” (step S40). Here, it is determined whether the respective attribute values of “attribute 1” and “attribute 2” of the component of which component is the “order update” are the same as the respective attribute values of “attribute 1” and “attribute 2” of the previous component of which component is the “written estimate correction” in the transaction ID “0001”, respectively. Further, it is determined whether the respective attribute values of “attribute 1” and “attribute 2” of the component of which component is the “order update” are the same as the respective attribute values of “attribute 1” and “attribute 2” of the previous component of which component is the “written estimate correction” in the transaction ID “0003”, respectively. As a result of the determination, both the attribute values of “attribute 1” are the same as “user C” and both the attribute values of “attribute 2” are the same as “none” in the component names “order update” and “written estimate correction” in the transaction ID “0001” and thus, it is determined that the attribute information of the component of which component is the “order update” are the same as the attribute information of the previous component of which component is the “written estimate correction” in the transaction ID “0001”. Further, both the attribute values of “attribute 1” are the same as “user C” and both the attribute values of “attribute 2” are the same as “end” in the component names “order update” and “written estimate correction” in the transaction ID “0003” and thus, it is determined that the attribute information of the component of which component is the “order update” are the same as the attribute information of the previous component of which component is the “written estimate correction” in the transaction ID “0003”. Therefore, the process proceeds along the YES route, the transaction log data analysis engine 30 sets “Y”, as an exclusion flag, on the component information of the component having the component name of the “order update” while storing the component information of the component having the component name of the “order update” in the component information storage DB 31, and further, sets the “written estimate correction” which corresponds to the “previous component name” in a “parent component name” as illustrated in FIGS. 21A and 21B (step S50), and, it is determined that not all components have been processed at step S70, and the process returns to step S20.

Subsequently, the transaction log data analysis engine 30 determines whether a component having the component name of an “order inquiry” (see, e.g., FIG. 14) corresponds to the first component in any of transactions (step S20). As a result, the “previous component name” of the component information is not present in any of transactions, so that it is determined that the component having the component name of the “order inquiry” is the first component. Therefore, the process proceeds along the YES route, the transaction log data analysis engine 30 stores component information of the component having the component name of an “order inquiry” in the component information storage DB 31 (step S60), and it is determined that not all components have been processed, and the process returns to step S20.

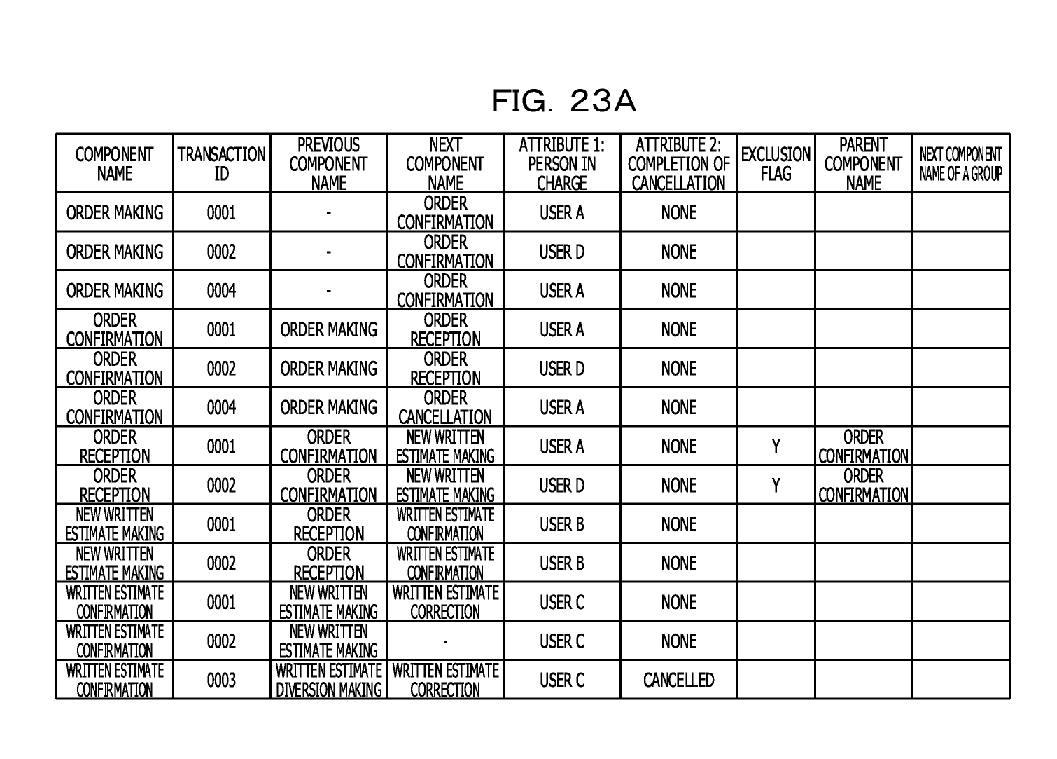

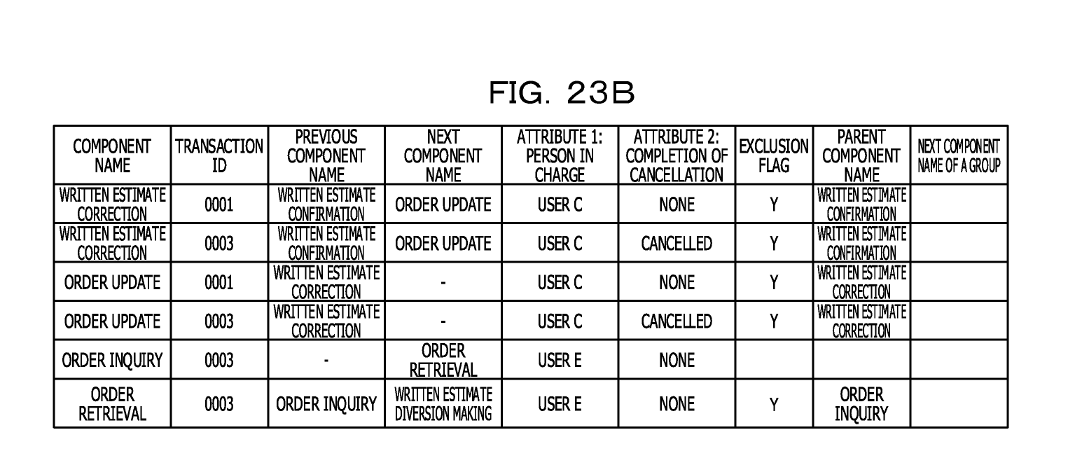

Subsequently, the transaction log data analysis engine 30 determines whether a component having the component name of a “written estimate correction” (see, e.g., FIG. 14) corresponds to the first component in any of transactions (step S20). As a result, the “previous component name” of the component information is present in any of transactions, so that it is determined that the component having the component name of “order retrieval” is not the first component. Therefore, the process proceeds along the NO route, and further, the transaction log data analysis engine 30 determines whether the “previous component name” is the same as each other in all transactions and the “next component name” is the same as each other in all transactions for the component having the component name of the “order retrieval” (step S30). As a result of the determination, there is only a transaction of which transaction ID is “0003”, and the “previous component name” is only the “order inquiry” and the “next component name” is only the “written estimate diversion making”, and thus, it is determined that the “previous component name” is the same as each other in all transactions and the “next component name” is the same as each other in all transactions. Therefore, the process proceeds along the YES route, and further, the transaction log data analysis engine 30 determines whether attribute information of the component having the component name of the “order retrieval” is the same as attribute information of the previous component having the component name of the “order inquiry” in the transaction ID “0003” (step S40). Here, it is determined whether the respective attribute values of “attribute 1” and “attribute 2” of the component of which component is the “order retrieval” are the same as the respective attribute values of “attribute 1” and “attribute 2” of the previous component of which component is the “order inquiry” in the transaction ID “0003”, respectively. As a result of the determination, both the attribute values of “attribute 1” are the same as “user E” and both the attribute values of “attribute 2” are the same as “none” in the component names “order retrieval” and “order inquiry” in the transaction ID “0003” and thus, it is determined that the attribute information of the component of which component is the “order retrieval” are the same as the attribute information of the previous component of which component is the “order inquiry” in the transaction ID “0003”. Therefore, the process proceeds along the YES route, the transaction log data analysis engine 30 sets “Y”, as an exclusion flag, in the component information of the component having the component name of “written estimate correction” while storing the component information of the component having the component name of “order retrieval” in the component information storage DB 31, and further, sets the “order inquiry” which corresponds to the “previous component name” in a “parent component name” as illustrated in FIGS. 23A and 23B (step S50), and, it is determined that not all components have been processed at step S70, and the process returns to step S20.

Subsequently, the transaction log data analysis engine 30 determines whether a component having the component name of a “written estimate diversion making” (see, e.g., FIG. 14) corresponds to the first component in any of transactions (step S20). As a result of the determination, the “previous component name” of the component information is present in any of transactions, so that it is determined that the component having the component name of “written estimate diversion making” is not the first component. Therefore, the process proceeds along the NO route, and further, the transaction log data analysis engine 30 determines whether the “previous component name” is the same as each other in all transactions and the “next component name” is the same as each other in all transactions for the component having the component name of the “written estimate diversion making” (step S30). As a result of the determination, there is only a transaction of which transaction ID is “0003”, and the “previous component name” is only the “order retrieval” and the “next component name” is only the “written estimate confirmation”, and thus, it is determined that the “previous component name” is the same as each other in all transactions and the “next component name” is the same as each other in all transactions. Therefore, the process proceeds along the YES route, and further, the transaction log data analysis engine 30 determines whether attribute information of the component having the component name of the “written estimate diversion making” is the same as attribute information of the previous component having the component name of the “order retrieval” in the transaction ID “0003” (step S40). Here, it is determined whether the respective attribute values of “attribute 1” and “attribute 2” of the component of which component is the “written estimate diversion making” are the same as the respective attribute values of “attribute 1” and “attribute 2” of the previous component of which component is the “order retrieval” in the transaction ID “0003”, respectively. As a result of the determination, both the attribute values of “attribute 1” are the same as “user E” but the attribute values of “attribute 2” are “end” and “none”, respectively, and thus, the attribute values differ from each other in the component names “written estimate diversion making” and “order retrieval” in the transaction ID “0003” and thus, it is determined that the attribute information of the component of which component is the “written estimate diversion making” are different from the attribute information of the previous component of which component is the “order retrieval” in the transaction ID “0003”. Therefore, the process proceeds along the NO route, and the transaction log data analysis engine 30 stores component information of the component having the component name of the “written estimate diversion making” in the component information storage DB 31 as illustrated in FIGS. 20A and 20B (step S60), and it is determined that not all components have been processed at step S70, and the process returns to step S20.

Subsequently, the transaction log data analysis engine 30 determines whether a component having the component name of an “order cancellation” (see, e.g., FIG. 14) corresponds to the first component in any of transactions (step S20). As a result of the determination, the “previous component name” of the component information is present in any of transactions, so that it is determined that the component having the component name of the “order cancellation” is not the first component. Therefore, the process proceeds along the NO route, and further, the transaction log data analysis engine 30 determines whether the “previous component name” is the same as each other in all transactions and the “next component name” is the same as each other in all transactions for the component having the component name of the “order cancellation” (step S30). As a result of the determination, there is only a transaction of which transaction ID is “0004”, and the “previous component name” is only the “order confirmation” and the “next component name” is only the “order contact”, and thus, it is determined that the “previous component name” is the same as each other in all transactions and the “next component name” is not the same as each other in all transactions. Therefore, the process proceeds along the YES route, and further, the transaction log data analysis engine 30 determines whether attribute information of the component having the component name of the “order cancellation” is the same as attribute information of the previous component having the component name of the “order confirmation” in the transaction ID “0004” (step S40). Here, it is determined whether the respective attribute values of “attribute 1” and “attribute 2” of the component of which component is the “order cancellation” are the same as the respective attribute values of “attribute 1” and “attribute 2” of the previous component of which component is the “order confirmation” in the transaction ID “0004”, respectively. As a result of the determination, both the attribute values of “attribute 1” are the same as “user A” and both the attribute values of “attribute 2” are the same as “none” in the component names “order cancellation” and “order confirmation” in the transaction ID “0004” and thus, it is determined that the attribute information of the component of which component name is the “order cancellation” are the same as the attribute information of the previous component of which component name is the “order confirmation” in the transaction ID “0004”. Therefore, the process proceeds along the YES route, the transaction log data analysis engine 30 sets “Y”, as an exclusion flag, in the component information of the component having the component name of the “order cancellation” while storing the component information of the component having the component name of the “order cancellation” in the component information storage DB 31, and further, sets the “order confirmation” which corresponds to the “previous component name” in a “parent component name” as illustrated in FIGS. 23A and 23B (step S50), and, it is determined that not all components have been processed at step S70, and the process returns to step S20.

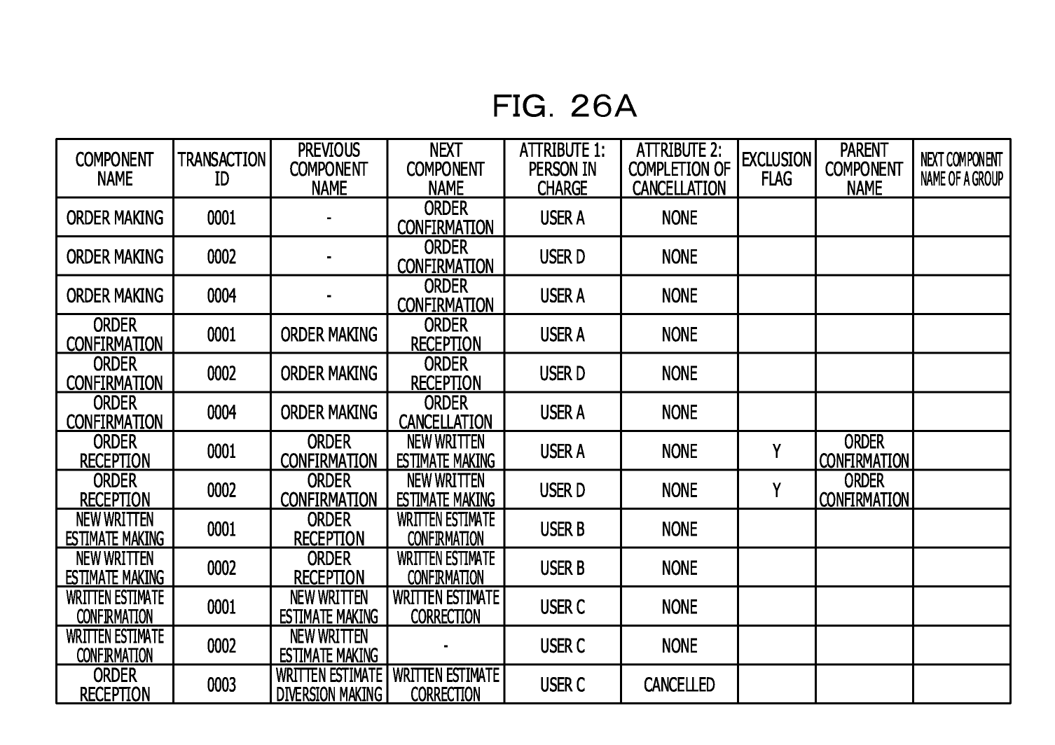

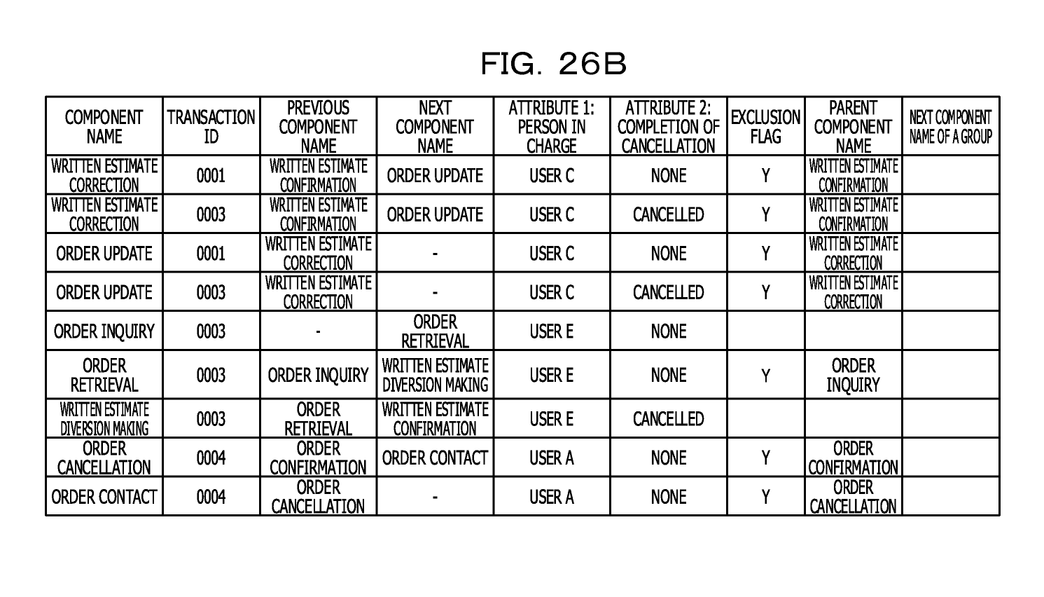

Subsequently, the transaction log data analysis engine 30 determines whether a component having the component name of an “order contact” (see, e.g., FIG. 14) corresponds to the first component in any of transactions (step S20). As a result of the determination, the “previous component name” of the component information is present in any of transactions, so that it is determined that the component having the component name of the “order contact” is not the first component. Therefore, the process proceeds along the NO route, and further, the transaction log data analysis engine 30 determines whether the “previous component name” is the same as each other in all transactions and the “next component name” is the same as each other in all transactions for the component having the component name of the “order contact” (step S30). As a result of the determination, there is only a transaction of which transaction ID is “0004”, and the “previous component name” is only the “order cancellation” and the “next component name” is only the “none”, and thus, it is determined that the “previous component name” is the same as each other in all transactions and the “next component name” is the same as each other in all transactions. Therefore, the process proceeds along the YES route, and further, the transaction log data analysis engine 30 determines whether attribute information of the component having the component name of the “order contact” is the same as attribute information of the previous component having the component name of the “order cancellation” in the transaction ID “0004” (step S40). Here, it is determined whether the respective attribute values of “attribute 1” and “attribute 2” of the component of which component is the “order contact” are the same as the respective attribute values of “attribute 1” and “attribute 2” of the previous component of which component is the “order cancellation” in the transaction ID “0004”, respectively. As a result of the determination, both the attribute values of “attribute 1” are the same as “user A” and both the attribute values of “attribute 2” are the same as “none” in the component names “order contact” and “order cancellation” in the transaction ID “0004” and thus, it is determined that the attribute information of the component of which component name is the “order contact” are the same as the attribute information of the previous component of which component name is the “order cancellation” in the transaction ID “0004”. Therefore, the process proceeds along the YES route, the transaction log data analysis engine 30 sets “Y”, as an exclusion flag, in the component information of the component having the component name of the “order contact” while storing the component information of the component having the component name of the “order contact” in the component information storage DB 31, and further, sets the “order cancellation” which corresponds to the “previous component name” in a “parent component name” as illustrated in FIGS. 26A and 26B (step S50), and, it is determined that not all components have been processed at step S70, and the process returns to step S20.

As described above, the processes of steps S20, S30, S40, S50 and S60 are performed for each component included in the extracted component information (see, e.g., FIG. 14). Also, when it is determined that the process has been performed for all of the components at step S70, the process proceeds to step S80, and the transaction log data analysis engine 30 determines whether the exclusion flag is set in the component information of each component included in the component information storage DB 31. Here, it is determined whether the exclusion flag is set sequentially for the component information of all components. That is, the determination of whether the exclusion flag is set sequentially for component information of all components is repeatedly performed. Also, when it is determined that the exclusion flag is not set in component information of any one of component, the process proceeds along the NO route. Again, it is determined whether the exclusion flag is set in component information of the next component. In the meantime, when it is determined that the exclusion flag is set in component information of any one of component, the process proceeds along the YES route. Further, the transaction log data analysis engine 30 determines whether the component in which the exclusion flag is set in the component information is a unique component in any of transactions (step S90). Here, when a “previous component name” and a “next component name” are not present in the component information of the component in which the exclusion flag is set, it is determined that the component is the unique component in any of the transactions.

As a result of the determination, when it is determined that the component in which the exclusion flag is set in the component information is the unique component in any of transactions, the transaction log data analysis engine 30 releases the setting of the exclusion flag in the component information of the corresponding component (step S130). Accordingly, as will be described later, when generating information indicating the execution sequence in a transaction, a unique component in any of the transactions, that is, a program that does not have a program executed immediately before and a program executed immediately after, is left. As described above, the unique component in any of the transactions is not included in the program that has one program executed immediately before and one program executed immediately after.

In the meantime, when it is determined that the component in which the exclusion flag is set in the component information is not the unique component in any of the transactions, the process proceeds along the NO route, and the transaction log data analysis engine 30 determines whether the exclusion flag is set in the component information of a parent component of the corresponding component (step S100).

As a result of the determination, when it is determined that the exclusion flag is set not in the component information of the parent component of the corresponding component, the process proceeds along the NO route, and the transaction log data analysis engine 30 sets a “next component name” of component information of the corresponding component in the “next component name of a group” of the component information of the parent component of the corresponding component (step S120).

In the meantime, when it is determined that the exclusion flag is set in the component information of the parent component of the corresponding component, the process proceeds along the YES route. Also, the “parent component name” of the component information of the parent component of the corresponding component is set in (set to overwrite) the “parent component name” of component information of the corresponding component while setting the “next component name” of the component information of the corresponding component in the “next component name of a group” of component information of a parent component of the parent component of the corresponding component (step S110). Further, when a component name is already set in the “next component name of a group” of component information of a parent component of the parent component of the corresponding component, the “next component name of a group” is overwritten with the “next component name” of the component information of the corresponding component.

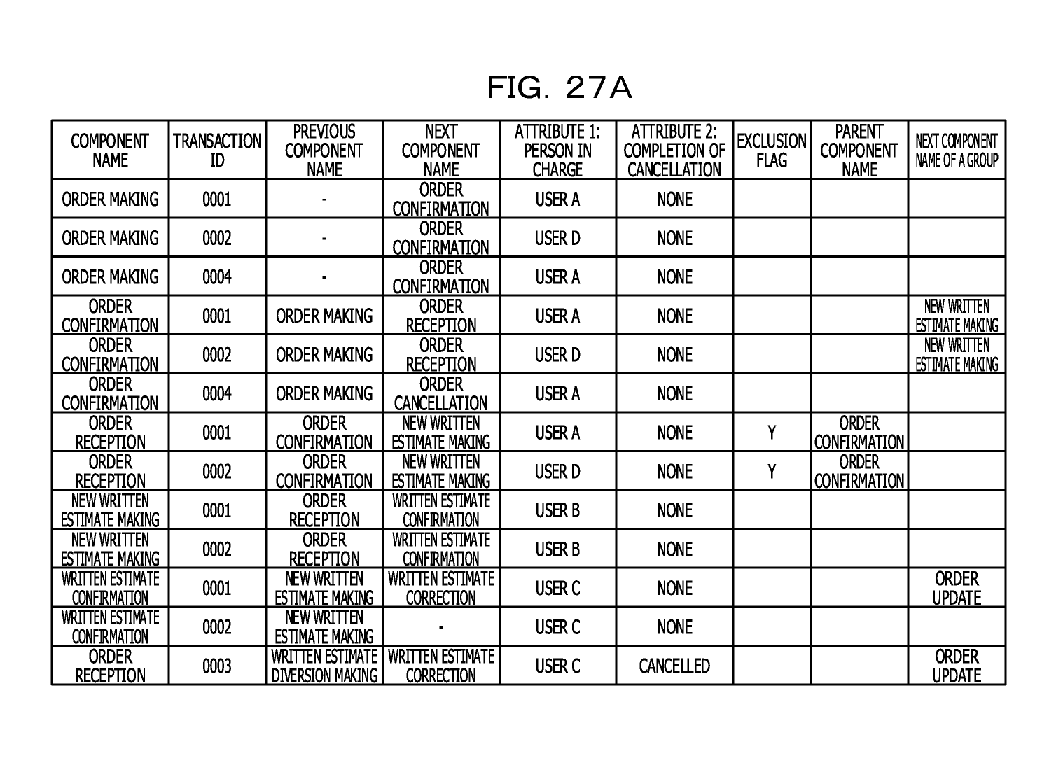

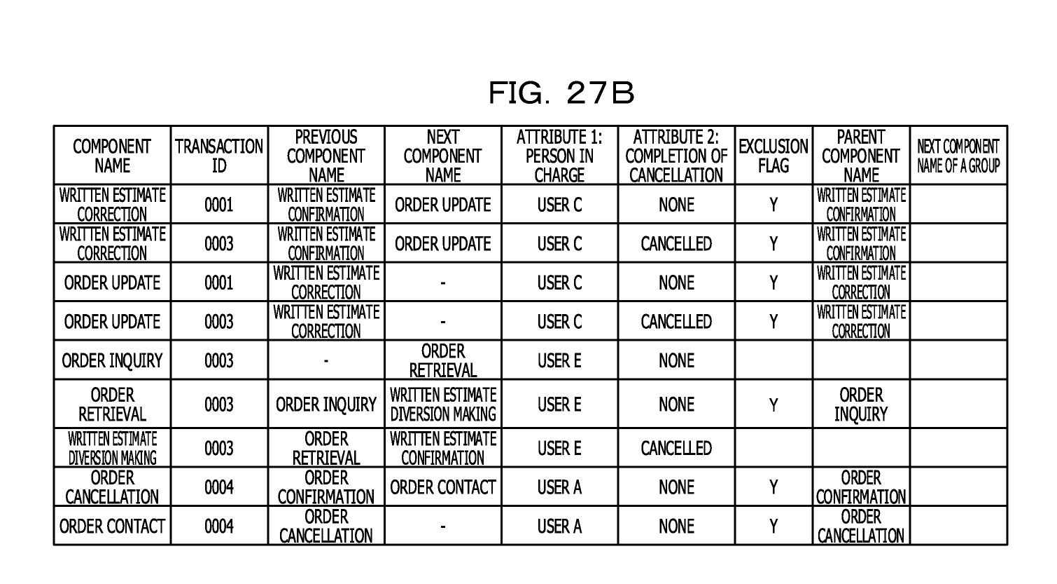

The processes of steps S80, S90, S100, S110, S120 and S130 are sequentially performed for each component stored in the component information storage DB 31. Here, the processes as described above are repeatedly performed until it is determined at step S140 that the processes are performed for all components. Specifically, the transaction log data analysis engine 30 first determines whether the exclusion flag is set sequentially for the component information of each component stored in the component information storage DB 31 (step S80). As a result of the determination, after it is determined first that the exclusion flag is not set in both of the component information of the “order making” component and the “order confirmation” component, it is determined whether the exclusion flag is set in the component information of the component having the component name of “order reception” (step S80). When it is determined that the exclusion flag is set, the process proceeds along the YES route. Further, the transaction log data analysis engine 30 determines whether the component having the component name of “order reception” is a unique component in any of the transactions (step S90). Here, the “previous component name” and the “next component name” are present in the component information of the component having the component name of “order reception”, and thus, it is determined that the component is not a unique component in any of the transactions. In this case, the process proceeds along the NO route, and further, the transaction log data analysis engine 30 determines whether “Y” is set as an exclusion flag in the component information of the component having the component name of “order confirmation” that is the parent component having the component name of “order reception” which is the corresponding component (step S100). Here, it is determined that “Y” is not set as an exclusion flag in the component information of the component having the component name of “order confirmation” that is the parent component. In this case, the process proceeds along the NO route, as illustrated in FIGS. 27A and 27B, a “new written estimate making” that is the “next component name” of the component information of the component having the component name of “order reception” that is the corresponding component is set in the “next component name of a group” of the component information of the component having the component name of “order confirmation” that is the parent component of the component having the component name of “order reception” which is the corresponding component (step S120). When it is determined at step S140 that not all components have been processed, the process returns to step S80.

Subsequently, after it is determined that the exclusion flag is not set in both of the component information of the “new written estimate making” component and the “written estimate confirmation” component, it is determined whether the exclusion flag is set in the component information of the component having the component name of “written estimate correction” (step S80). When it is determined that the exclusion flag is set, the process proceeds along the YES route. Further, the transaction log data analysis engine 30 determines whether the component having the component name of “written estimate correction” is a unique component in any of the transactions (step S90). Here, the “previous component name” and the “next component name” are present in the component information of the component having the component name of “written estimate correction”, and thus, it is determined that the component is not a unique component in any of the transactions. In this case, the process proceeds along the NO route, and further, the transaction log data analysis engine 30 determines whether “Y” is set as an exclusion flag in the component information of the component having the component name of “written estimate confirmation” that is the parent component of the component having the component name of “written estimate correction” which is the corresponding component (step S100). Here, it is determined that “Y” is not set as an exclusion flag in the component information of the component having the component name of “written estimate confirmation” that is the parent component. In this case, the process proceeds along the NO route, and as illustrated in FIGS. 27A and 27B, the “order update” that is the “next component name” of the component information of the component having the component name of “written estimate correction” that is the corresponding component is set in the “next component name of a group” of the component information of the component having the component name of “written estimate confirmation” that is the parent component of the component having the component name of “written estimate correction” which is the corresponding component (step S120). When it is determined at step S140 that not all components have been processed, the process returns to step S80.

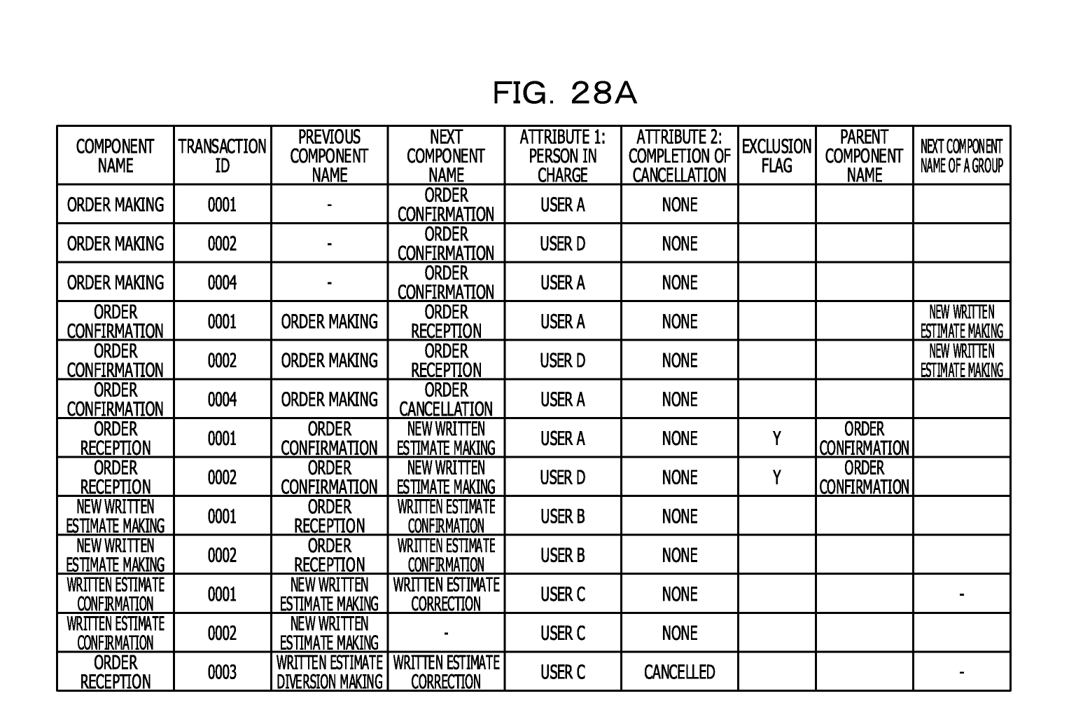

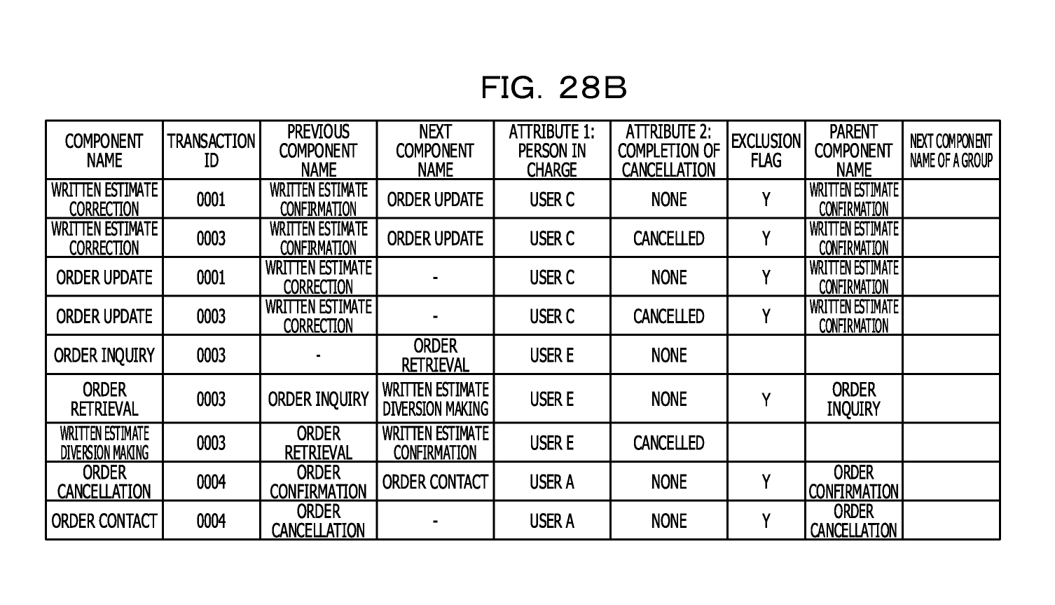

Subsequently, it is determined whether the exclusion flag is set in the component information of the component having the component name of “order update” (step S80). When it is determined that the exclusion flag is set, the process proceeds along the YES route. Further, the transaction log data analysis engine 30 determines whether the component having the component name of “order update” is a unique component in any of the transactions (step S90). Here, the “previous component name” and the “next component name” are present in the component information of the component having the component name of “order update”, and thus, it is determined that component is not a unique component in any of the transactions. In this case, the process proceeds along the NO route, and further, the transaction log data analysis engine 30 determines whether “Y” is set as an exclusion flag in the component information of the component having the component name of “written estimate correction” that is the parent component of a component having the component name of “order update” which is the corresponding component (step S100). Here, it is determined that “Y” is set as an exclusion flag in the component information of the component having the component name of “written estimate correction” that is the parent component. In this case, the process proceeds along the YES route, and as illustrated in FIGS. 27A, 27B, 28A and 28B, the “written estimate confirmation” which is the “parent component name” of the component information of the “written estimate correction” which is the parent component of the component having the component name of “order update” which is the corresponding component is set to overwrite the “parent component name” (here, corresponds to “written estimate correction”) of the component information of the component having the component name of “order update” which is the corresponding component while setting “none” which is the “next component name” of the component information of the component having the component name of “order update” which is the corresponding component to overwrite the “next component name of a group” (here, corresponds to “order update”) of the component information of the component having the component name of “written estimate confirmation” which is the parent component of the component having the component name of “written estimate correction” of the “order update” which is the corresponding component. When it is determined at step S140 that not all components have been processed, the process returns to step S80.

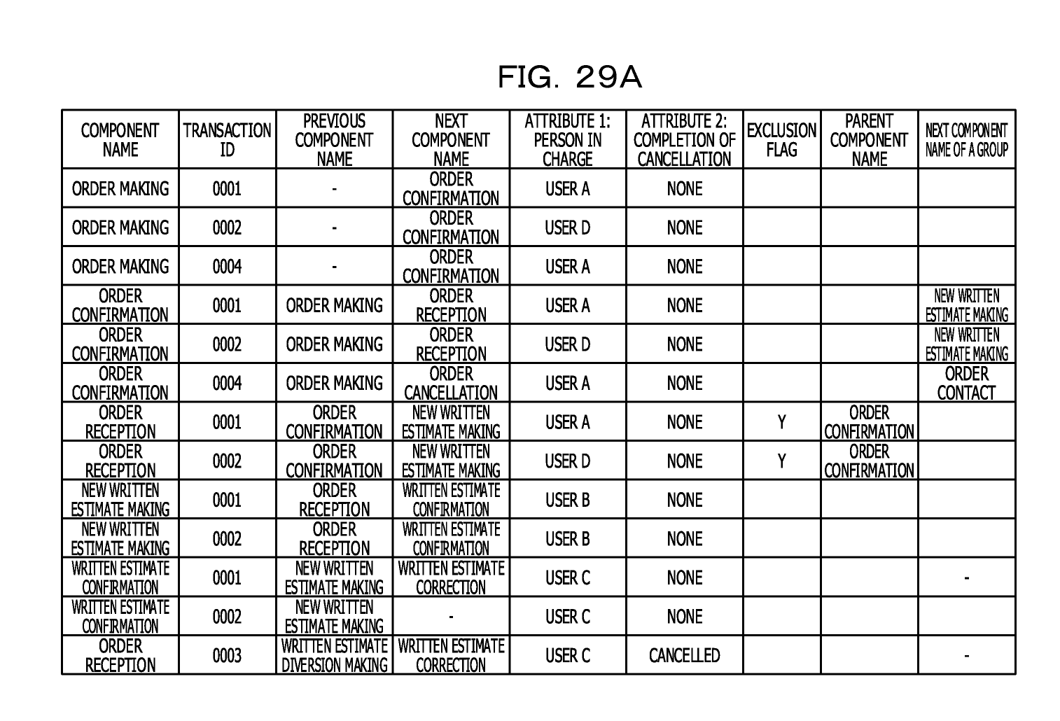

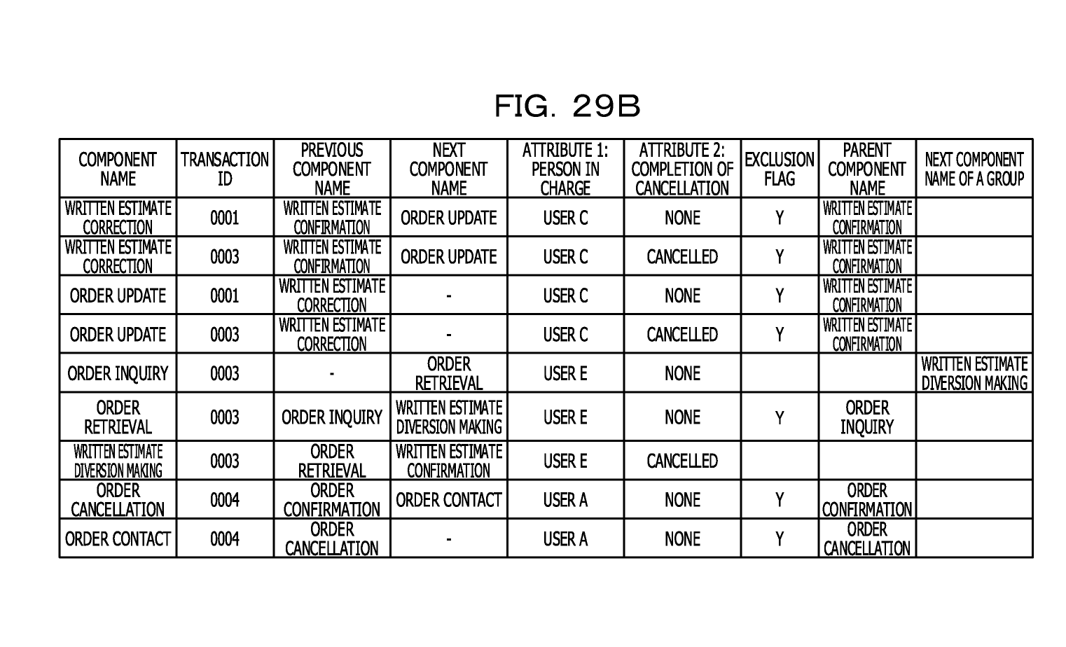

Subsequently, after it is determined that the exclusion flag is not set in both of the component information of “order inquiry”, it is determined whether the exclusion flag is set in the component information of the component having the component name of the “order retrieval” (step S80). When it is determined that the exclusion flag is set, the process proceeds along the YES route. Further, the transaction log data analysis engine 30 determines whether the component having the component name of the “order retrieval” is a unique component in any of the transactions (step S90). Here, the “previous component name” and the “next component name” are present in the component information of the component having the component name of the “order retrieval”, and thus, it is determined that the component is not a unique component in any of the transactions. In this case, the process proceeds along the NO route, and further, the transaction log data analysis engine 30 determines whether “Y” is set as an exclusion flag in the component information of the component having the component name of the “order inquiry” that is the parent component of a component having the component name of the “order retrieval” which is the corresponding component (step S100). Here, it is determined that “Y” is not set as an exclusion flag in the component information of the component having the component name of the “written estimate confirmation” that is the parent component. In this case, the process proceeds along the NO route, as illustrated in FIGS. 29A and 29B, the “written estimate diversion making” that is the “next component name” of the component information of the component having the component name of the “order retrieval” that is the corresponding component is set in the “next component name of a group” of the component information of the component having the component name of the “order inquiry” that is the parent component of a component having the component name of the “order retrieval” which is the corresponding component (step S120). When it is determined that not all components have been processed at step S140, returns to step S80.

Subsequently, after it is determined that the exclusion flag is not set in both of the component information of “written estimate diversion making”, it is determined whether the exclusion flag is set in the component information of the component having the component name of the “order cancellation” (step S80). When it is determined that the exclusion flag is set, the process proceeds along the YES route. Further, the transaction log data analysis engine 30 determines whether the component having the component name of the “order cancellation” is a unique component in any of the transactions (step S90). Here, the “previous component name” and the “next component name” are present in the component information of the component having the component name of the “order cancellation”, and thus, it is determined that the component is not a unique component in any of the transactions. In this case, the process proceeds along the NO route, and further, the transaction log data analysis engine 30 determines whether “Y” is set as an exclusion flag in the component information of the component having the component name of the “order confirmation” that is the parent component of a component having the component name of the “order cancellation” which is the corresponding component (step S100). Here, it is determined that “Y” is not set as an exclusion flag in the component information of the component having the component name of the “order confirmation” that is the parent component. In this case, the process proceeds along the NO route, as illustrated in FIGS. 29A and 29B, an “order contact” that is the “next component name” of the component information of the component having the component name of the “order cancellation” that is the corresponding component is set in the “next component name of a group” of the component information of the component having the component name of the “order confirmation” that is the parent component of a component having the component name of the “order cancellation” which is the corresponding component (step S120). When it is determined that not all components have been processed at step S140, the process returns to step S80.

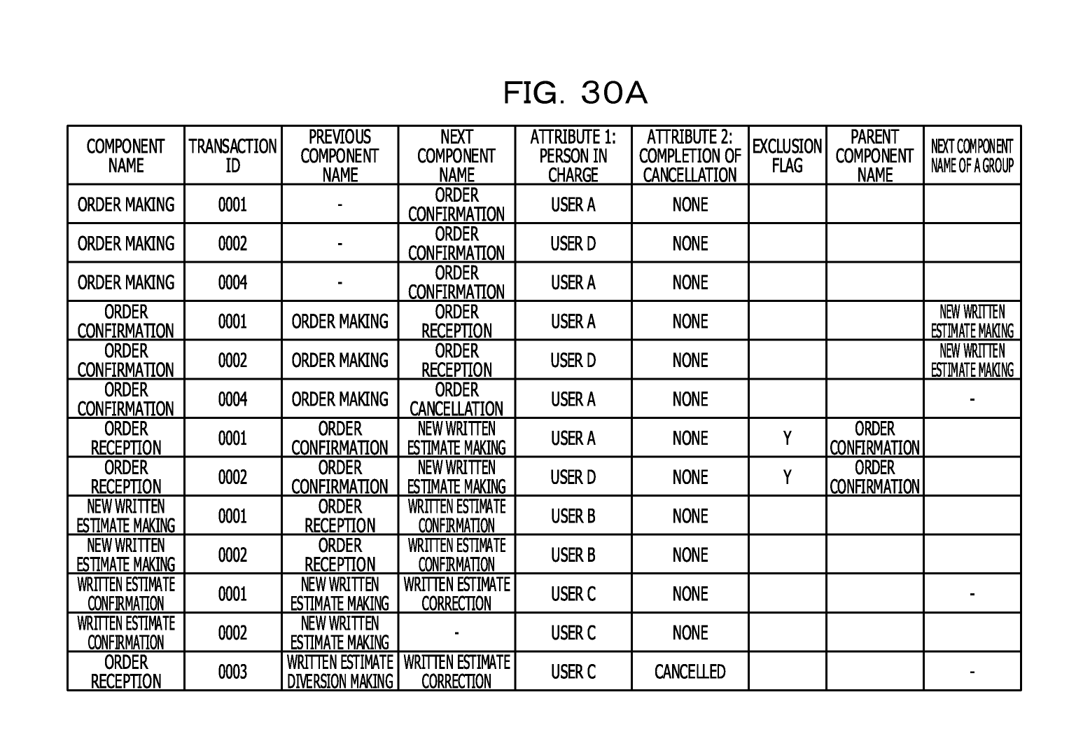

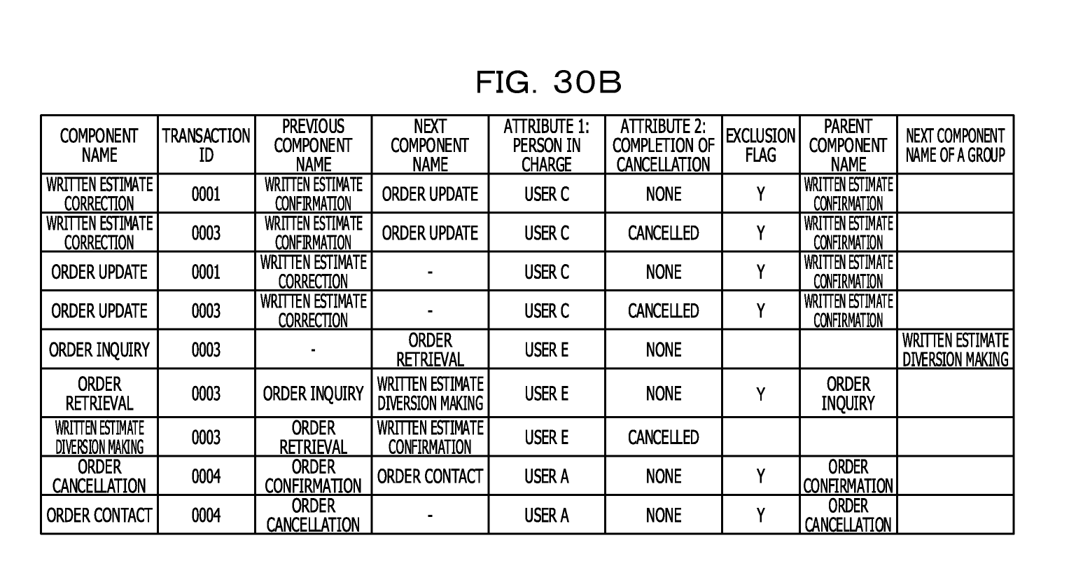

Subsequently, it is determined whether the exclusion flag is set in the component information of the component having the component name of the “order contact” (step S80). When it is determined that the exclusion flag is set, the process proceeds along the YES route. Further, the transaction log data analysis engine 30 determines whether the component having the component name of the “order contact” is a unique component in any of the transactions (step S90). Here, the “previous component name” and the “next component name” are present in the component information of the component having the component name of the “order contact”, and thus, it is determined that component is not a unique component in any of the transactions. In this case, the process proceeds along the NO route, and further, the transaction log data analysis engine 30 determines whether “Y” is set as an exclusion flag present in the component information of the component having the component name of the “order cancellation” that is the parent component of a component having the component name of the “order contact” which is the corresponding component (step S100). Here, it is determined that “Y” is set as an exclusion flag in the component information of the component having the component name of the “order cancellation” which is the parent component. In this case, the process proceeds along the YES route, as illustrated in FIGS. 29A, 29B, 30A and 30B, the “order confirmation” which is the “parent component name” of the component information of a component having the component name of the “order cancellation” which is the parent component of the component having the component name of “order contact” that is the corresponding component is set to overwrite the “parent component name” (here, corresponds to “order cancellation”) of the component information of the component having the component name of “order contact” which is the corresponding component while setting the “none” which is the “next component name” of the component information of the component having the component name of “order contact” which is the corresponding component to overwrite “next component name of a group” (here, corresponds to “order contact”) of the component information of the parent component of the component having the component name of the “order confirmation” which is the parent component of the component having the component name of the “order cancellation” which is the parent component of the component having the component name of the “order contact” which is the corresponding component (step S110). When it is determined that all components have been undergone, the process ends.

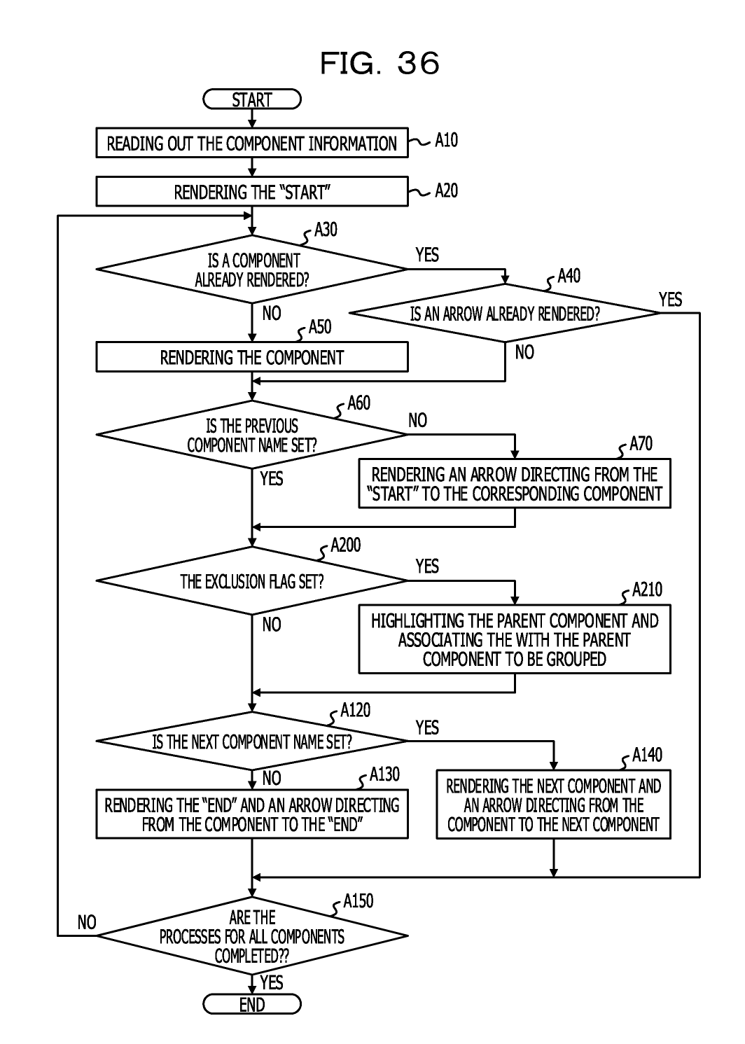

Further, the processes performed by the transaction log data analysis engine 30 as described above, that is, the processes illustrated in the flowchart of FIGS. 10A and 10B may be appropriately changed. For example, step S40 may be deleted. Further, for example, steps from S80 to S140 may be deleted. Further, for example, step S40, and steps from S80 to S140 may be deleted. Further, when deleting step S80, and steps S100, S110 and S120, the component information to be stored in the component information storage DB 31 may not include the “next component name of a group”. In this case, a process by a transaction log data visualization engine may be performed to carry out the process as illustrated in the flowchart of FIG. 36. Further, for example, the sequence of steps S20, S30, and S40 may be changed. Further, for example, steps S90 and S130 may be deleted, the same step as step S90 may be inserted before steps S50 and step S60, and when it is determined that the component is a unique component, the process may proceed to step S60, and otherwise, the process may proceed to step S50. That is, step S90 may be inserted before step S50 and step S60 in order to use for determination of whether the exclusion flag is set or not, instead of using step S90 for determination of whether setting of the exclusion flag is released or not. Further, for example, step S70 may be deleted, and the NO route resulted from a determination at step S140 may be returned to step S20. That is, in the process performed by the transaction log data analysis engine 30 as described above, the processes from step S20 to step S70 and the processes from step S80 to step S140 are separated, but these processes may be performed in a series of processes without being separated.

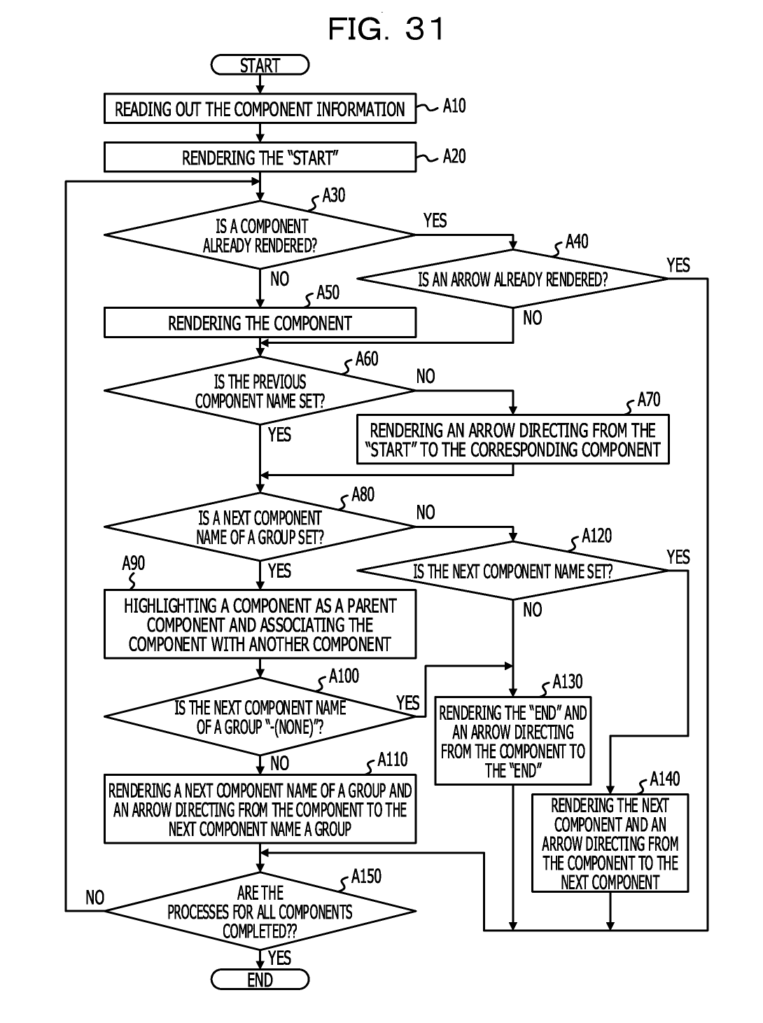

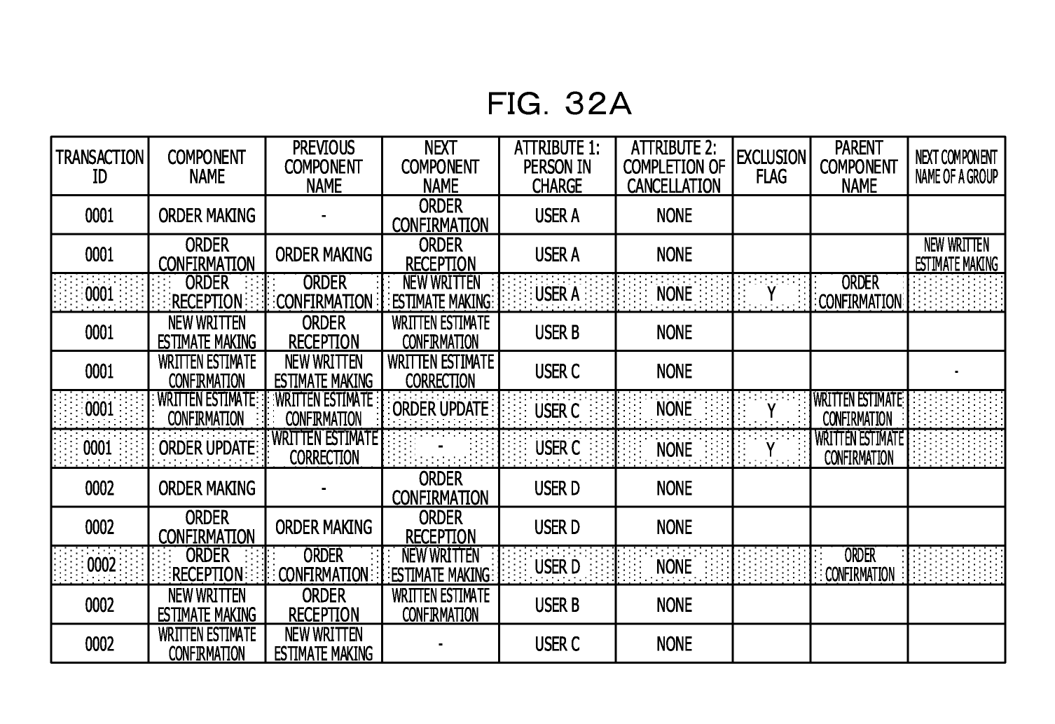

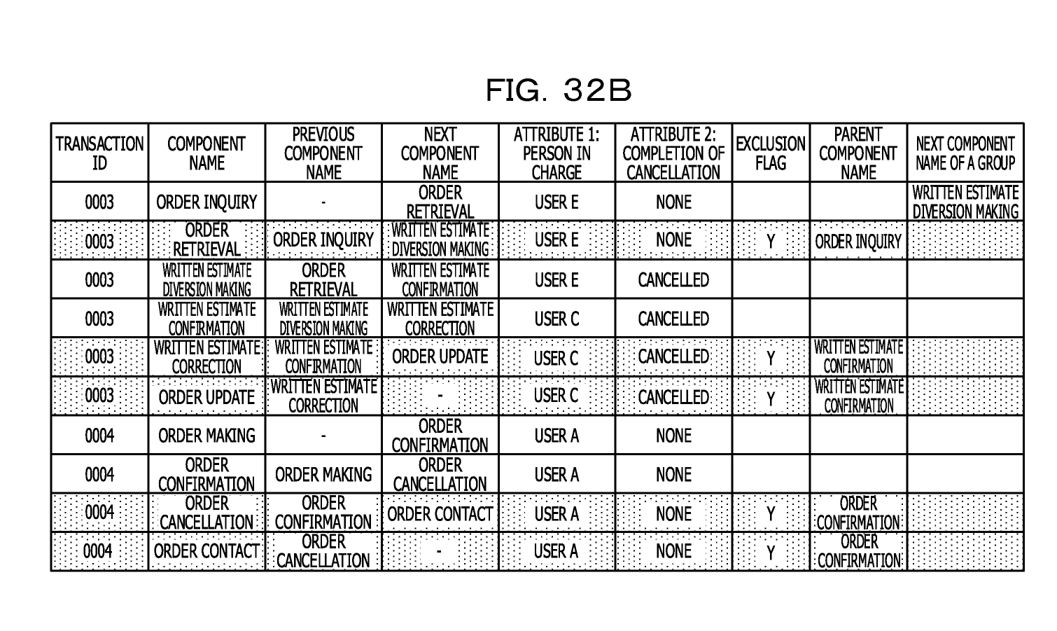

Subsequently, the processes performed by the transaction log data visualization engine 32 provided in the transaction log data analysis apparatus 1 will be described with reference to FIG. 31 to FIG. 36 in more detail. Here, a process for a case where there is an instruction which requests information in which a production business is visualized from the user terminal 7 is described by way of an example. Further, it is assumed that the component information including a process result by the transaction log data analysis engine 30 as described above is stored in the component information storage DB 31 as illustrated in FIG. 32. Further, the production business process is configured by a plurality of activities as described above, but a component included in an order activity is indicated as the component executed in each transaction and components included in the other activities are omitted in order to simplify the description.

First, in a case where there is an instruction which requests information in which a production business is visualized from the user terminal 7, the transaction log data visualization engine 32 reads out the component information from the component information storage DB 31 using a business process name which can specify a business process for a target business process for visualization. Subsequently, the transaction log data visualization engine 32 defines a component for which an exclusion flag is not set in the component information of the component as a target component for display (a target component for visualization), defines a component for which an exclusion flag is set in the component information of the component as a non-target component for display (a non-target component for visualization), associates the component with a parent component of the target component for display to be grouped, and generates information (execution sequence information) which indicates the execution sequence of a plurality of components in a transaction for implementing the business process. Also, the transaction log data visualization engine 32 sends the execution sequence information to the user terminal 7 from which the instruction which requests information in which a production business is visualized is sent, and displays the execution sequence information on the display device of the user terminal 7.

In the present embodiment, as illustrated in FIG. 31, the transaction log data visualization engine 32 first reads out the component information which includes a process result by the transaction log data analysis engine 30 as described above from the component information storage DB 31 using a business process name “production business” (step A10). Further, the reading out of the component information may be performed for each transaction. In this case, each component information of the transaction IDs “0001”, “0002”, “0003”, and “0004” may be sequentially read out.

Subsequently, the transaction log data visualization engine 32 renders “start” (step A20). Subsequently, the transaction log data visualization engine 32 determines whether the corresponding component is already rendered (step A30). As a result of the determination, when it is determined that the corresponding component is already rendered, the process proceeds along the YES route. Further, the transaction log data visualization engine 32 determines whether an arrow is already rendered (step A40). Here, when the component information of the component which is already rendered is the same as a “previous component name” and a “next component name” of the component information of the corresponding component, the transaction log data visualization engine 32 determines that the arrow is already rendered, and when the component information is not the same as the “previous component name” and the “next component name”, it is determined that the arrow is not already rendered. As a result of the determination, when the transaction log data visualization engine 32 determines that the arrow is rendered, the process proceeds along the YES route. Also, when it is determined at step A150 that not all components have been processed, the process returns to step A30. In the meantime, when it is determined that the arrow is not rendered, the process proceeds along the NO route, that is, proceeds to step A60.

In the meantime, when it is determined at step A30 that the corresponding component is not rendered, the process proceeds along the NO route and renders the corresponding component (step A50). Further, the transaction log data visualization engine 32 determines whether the “previous component name” of the component information of the corresponding component is set (step A60). As a result of the determination, when it is determined that the “previous component name” of the component information of the corresponding component is not set, the process proceeds along the NO route and renders an arrow directing from “start” to the corresponding component (step A70), and the process proceeds to step A80. In the meantime, when it is determined that the “previous component name” of the component information of the corresponding component is set, the process proceeds to step A80 directly.

Subsequently, the transaction log data visualization engine 32 determines at step A80 whether “next component name of a group” of the component information of the corresponding component is set or not. As a result of the determination, when it is determined that the “next component name of a group” of the component information of the corresponding component is not set, the process proceeds along the NO route. Further, the transaction log data visualization engine 32 determines whether “next component name” of the component information of the corresponding component is set or not (step A120). As a result of the determination, when it is determined that “next component name” of the component information of the corresponding component is set, the process proceeds along the YES route, and the transaction log data visualization engine 32 renders a next component, and an arrow directing from the corresponding component to the next component (step A140). When it is determined at step A150 that not all components have been processed, the process returns to step A30. In the meantime, when it is determined that “next component name” of the component information of the corresponding component is not set, the process proceeds along the NO route, and the transaction log data visualization engine 32 renders an “end” and an arrow directing from the corresponding component to the “end” (step A130). When it is determined at step A150 that not all components have been processed, the process returns to step A30. When it is determined at step A150 that the process is performed for all components, the process ends.

However, when it is determined at step A80 that the “next component name of a group” of the component information of the corresponding component is set, the process proceeds along the YES route. Further, the transaction log data visualization engine 32 associates the corresponding component, as a parent component, with a component which is grouped, while displaying the corresponding component to be highlighted as a parent component (step A90). Here, as will be described below, when the parent component is selected by manipulating the user terminal 7, the transaction log data visualization engine 32 associates a parent component and a component which is grouped to unfold and display the component of which selected parent component is set as a “parent component name” and which is grouped and set as a component for non-display. Further, the component which is grouped and set as a component for non-display may be rendered at this step or may be rendered at a step at which the parent component is selected.

Subsequently, the transaction log data visualization engine 32 determines whether the “next component name of a group” of component information of the corresponding component “-(none)” or not (step A100). As a result of the determination, when it is determined that the “next component name of a group” of component information of the corresponding component is the “-(none)”, the process proceeds along the YES route, and an arrow directing from the corresponding component to the “end” is rendered (step A130). When it is determined at step A150 that not all components have been processed, the process returns to step A30. When it is determined at step A150 that the process is performed for all components, the process ends.

However, when it is determined that the “next component name of a group” of component information of the corresponding component is not the “-(none)” at step A100, the process proceeds along the NO route, and the transaction log data visualization engine 32 renders a next component of a group, and an arrow directing from the corresponding component to the next component of a group (step A110). When it is determined that not all components have been processed at step A150, the process returns to step A30.

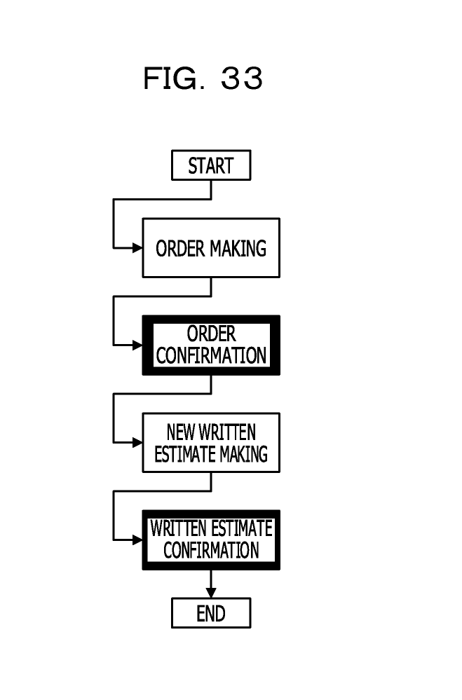

Specifically, the transaction log data visualization engine 32 first reads out component information (see, e.g., FIGS. 32A and 32B) which includes the process result by the transaction log data analysis engine 30 as described above from the component information storage DB 31 using a business process name “production business” (step A10). Subsequently, the transaction log data visualization engine 32 renders the “start” (step A20; see, e.g., FIG. 33).

Subsequently, the transaction log data visualization engine 32 determines whether a component, which is included in the transaction ID “0001” having the component name of “order making” among component information (see, e.g., FIGS. 32A and 32B) read out from the component information storage DB 31 is already rendered (step A30). As a result of the determination, when it is determined that the component having the component name of “order making” is not rendered, the process proceeds along the NO route, and the component having the component name of “order making” is rendered (step A50; see, e.g., FIG. 33), and the process proceeds to step A60. Subsequently, when it is determined at step A60 that the “previous component name” of the component information of a component having the component name of “order making” that is the corresponding component is not set, the process proceeds along the NO route and renders an arrow directing from “start” to the corresponding component having the component name of “order making” (step A70; see, e.g., FIG. 33), and the process proceeds to step A80. Subsequently, when it is determined at step A80 that the “next component name of a group” of the component information of a component having the component name of the “order making” that is the corresponding component is not set, the process proceeds along the NO route, that is, proceeds to step A120. Also, when it is determined at step A120 that an “order confirmation” is set as the “next component name of a group” of the component information of a component having the component name of “order making” that is the corresponding component is set, the process proceeds along the YES route, that is, proceeds to step A140. Also, at step A140, the transaction log data visualization engine 32 renders a component having the component name of “order confirmation” set as the “next component name” and an arrow (see, e.g., FIG. 33) directing from the corresponding component having the component name of “order making” to the next component having the component name of “order confirmation”. When it is determined at step A150 that not all components have been processed, the process returns to step A30.

Subsequently, the transaction log data visualization engine 32 determines whether a component having the component name of “order confirmation” set as a “next component name” of the component information of the component, which is included in the transaction ID “0001” having the component name of “order making”, is rendered or not (step A30). As a result of the determination, when it is determined that the component having the component name of “order making” is already rendered, the process proceeds along the YES route, and when it is determined at step A40 that the arrow is not rendered, the process proceeds along the NO route, that is, proceeds to step A60. Subsequently, when the transaction log data visualization engine 32 determines at step A60 that the “previous component name” of the component information of a component having the component name of the “order confirmation” that is the corresponding component is set, the process proceeds along the YES route, that is, proceeds to step A80. Subsequently, when the transaction log data visualization engine 32 determines at step A80 that a “new written estimate making” is set as the “next component name of a group” of the component information of a component having the component name of “order confirmation” that is the corresponding component is set, the process proceeds along the YES route, that is, proceeds to step A90. Also, at step A90, the transaction log data visualization engine 32 associates the component having the component name of “order confirmation” that is the corresponding component, as a parent component, with a component (here, a component having the component name of “order reception”) which is grouped as a parent component while displaying a component having the component name of “order confirmation” to be highlighted as a parent component (step A90). Here, as will be described below, when a component having the component name of “order confirmation” that is the parent component is selected by manipulating the user terminal 7, the transaction log data visualization engine 32 associates a parent component having the component name of “order confirmation” and a component having the component name of “order reception” which is grouped to unfold and display the component of which selected parent component is set as a “parent component name” and having the component name of “order reception” and which is grouped and set as a component for non-display. Subsequently, when the transaction log data visualization engine 32 determines at step A100 that the “next component name of a group” of the component information of a component having the component name of “order confirmation” that is the corresponding component is not “-(none)”, the process proceeds along the NO route, that is, proceeds to step A110. Also, at step A110, the transaction log data visualization engine 32 renders a component having the component name of “new written estimate making” set as the “next component name a group” and an arrow (see, e.g., FIG. 33) directing from the corresponding component having the component name of “order confirmation” to the next component of a group having the component name of “new written estimate making”. When it is determined at step A150 that not all components have been processed, the process returns to step A30.

Subsequently, the transaction log data visualization engine 32 determines whether a component having the component name of the “new written estimate making” set as a “next component name” of component information of the component, which is included in the transaction ID “0001”, of which component name is the “order confirmation” is already rendered or not (step A30). As a determination result, when it is determined that the component having the component name of the “new written estimate making” is already rendered, the process proceeds along the YES route, and when it is determined that the arrow is not rendered, and the process proceeds along the NO route, that is, proceeds to step A60. Subsequently, when the transaction log data visualization engine 32 determines at step A60 that the “previous component name” of the component information of a component having the component name of the “new written estimate making” that is the corresponding component is set, the process proceeds along the YES route, that is, proceeds to step A80. Subsequently, when the transaction log data visualization engine 32 determines at step A80 that the “next component name of a group” of the component information of a component having the component name of the “new written estimate making” that is the corresponding component is not set, the process proceeds along the NO route, that is, proceeds to step A120. Also, when the transaction log data visualization engine 32 determines at step A120 that the “written estimate confirmation” is set as the “next component name of a group” of the component information of a component having the component name of the “new written estimate making” that is the corresponding component is set, the process proceeds along the YES route, that is, proceeds to step A140. Also, at step A140, transaction log data visualization engine 32 renders a component having the component name of the “written estimate confirmation” set as the “next component name” and an arrow (see, e.g., FIG. 33) directing from the corresponding component having the component name of the “new written estimate making” to the next component having the component name of the “written estimate confirmation”. When it is determined that not all components have been processed at step A150, the process returns to step A30.

Subsequently, the transaction log data visualization engine 32 determines whether a component having the component name of the “written estimate confirmation” set as a “next component name” of component information of the component, which is included in the transaction ID “0001”, of which component name is the “new written estimate making” is rendered or not (step A30). As a determination result, when it is determined that the component having the component name of the “written estimate confirmation” is already rendered, the process proceeds along the YES route, and when it is determined that the arrow is not rendered, and the process proceeds along the NO route, that is, proceeds to step A60. Subsequently, when the transaction log data visualization engine 32 determines at step A60 that the “previous component name” of the component information of a component having the component name of the “written estimate confirmation” that is the corresponding component is set, the process proceeds along the YES route, that is, proceeds to step A80. Subsequently, when the transaction log data visualization engine 32 determines at step A80 that “-(none)” is set as the “next component name of a group” of component information of a component having the component name of the “written estimate confirmation” that is the corresponding components, the process proceeds along the YES route, that is, proceeds to step A90. Also, at step A90, the transaction log data visualization engine 32 associates the component having the component name of the “written estimate confirmation” that is the corresponding component, as a parent component, with a component (here, a component having the component name of the “written estimate correction”, “order update”) which is grouped while displaying a component having the component name of the “written estimate confirmation” to be highlighted as a parent component (step A90). Here, as will be described below, when a component having the component name of the “written estimate confirmation” that is the parent component is selected by manipulating the user terminal 7, the transaction log data visualization engine 32 associates a parent component having the component name of the “written estimate confirmation” and the components of which component names are the “written estimate correction” and the “order update” which are grouped to unfold and display the component of which selected parent component is set as a “parent component name” and having the component names of the “written estimate correction” and “order update” and which are grouped and set as a component for non-display, in the component information stored in the component information storage DB 31 (see, e.g., FIGS. 32A and 32B). Subsequently, when the transaction log data visualization engine 32 determines at step A100 that the “next component name of a group” of the component information of a component having the component name of the “written estimate confirmation” that is the corresponding component is “-(none)”, the process proceeds along the YES route, that is, proceeds to step A130. Also, at step A130, the transaction log data visualization engine 32 renders the “end”, and an arrow (see, e.g., FIG. 33) directing from the corresponding component having the component name of the “written estimate confirmation” to the “end”. When it is determined that not all components have been processed at step A150, the process returns to step A30. In this step, information as illustrated in FIG. 33 is created as information indicating execution sequence of each component in the transaction of transaction ID is “0001”.

Subsequently, the transaction log data visualization engine 32 determines whether a component, of which component name is the “order making”, included in transaction of transaction ID is “0002” among component information read out from the component information storage DB 31 is already rendered or not (step A30). As a determination result, when it is determined that the component having the component name of the “order making” is already rendered, the process proceeds along the YES route, and when it is determined that the arrow is rendered at step A40, and the process proceeds along the YES route. When it is determined that not all components have been processed at step A150, the process returns to step A30.

Subsequently, the transaction log data visualization engine 32 determines whether a component having the component name of the “order confirmation” set as a “next component name” of component information of the component, which is included in the transaction ID “0002”, of which component name is the “order making” is rendered or not (step A30). As a determination result, when it is determined that the component having the component name of the “order confirmation” is already rendered, the process proceeds along the YES route, and when it is determined that the arrow is rendered at step A40, and the process proceeds along the YES route. When it is determined that not all components have been processed at step A150, the process returns to step A30.

Subsequently, the transaction log data visualization engine 32 determines whether a component, of which component name is the “new written estimate making” set as “next component name of a group” of component information of a component, of which component is “order confirmation”, included in transaction of transaction ID is “0002” is already rendered or not (step A30). As a determination result, when it is determined that the component having the component name of the “new written estimate making” is already rendered, the process proceeds along the YES route, and when it is determined that the arrow is rendered at step A40, and the process proceeds along the YES route. When it is determined that not all components have been processed at step A150, the process returns to step A30.

Subsequently, the transaction log data visualization engine 32 determines whether a component, of which component name is the “written estimate confirmation” set as “next component name of a group” of component information of a component, of which component is “new written estimate making”, included in transaction of transaction ID is “0002” is already rendered or not (step A30). As a determination result, when it is determined that the component having the component name of the “written estimate confirmation” is already rendered, the process proceeds along the YES route, and when it is determined that the arrow is rendered at step A40, and the process proceeds along the YES route. When it is determined that not all components have been processed at step A150, the process returns to step A30.

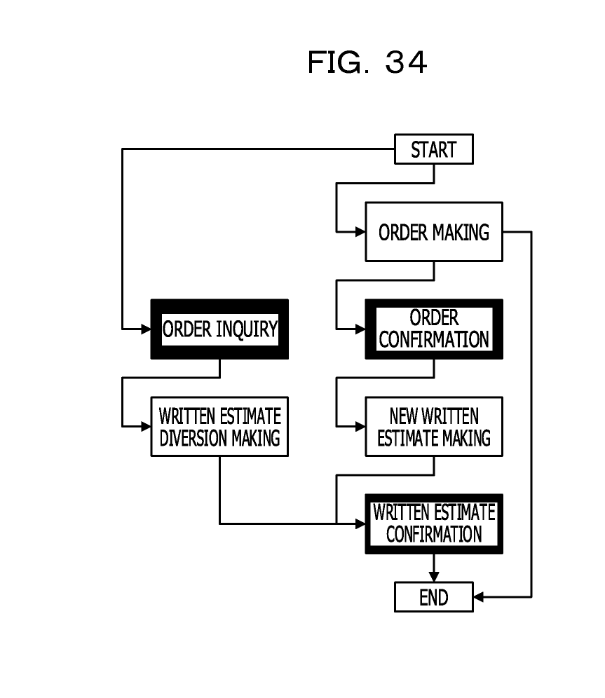

Subsequently, the transaction log data visualization engine 32 determines whether a component, of which component name is the “order inquiry”, included in transaction of transaction ID is “0003” among component information read out from the component information storage DB 31 is already rendered or not (step A30). As a result of the determination, when it is determined that the component having the component name of the “order inquiry” is not rendered, the process proceeds along the NO route, and the component having the component name of the “order inquiry” is rendered (step A50; see, e.g., FIG. 34), and the process proceeds to step A60. Subsequently, when the transaction log data visualization engine 32 determines at step A60 that the “previous component name” of the component information of a component having the component name of the “order inquiry” that is the corresponding component is not set, the process proceeds along the NO route and renders an arrow directing from “start” to the corresponding component having the component name of the “order inquiry” (step A70; see, e.g., FIG. 34), and the process proceeds to step A80. Subsequently, when the transaction log data visualization engine 32 determines at step A80 that a “written estimate diversion making” is set as the “next component name of a group” of the component information of a component having the component name of the “order inquiry” that is the corresponding component is set, the process proceeds along the YES route, that is, proceeds to step A90. Also, at step A90, the transaction log data visualization engine 32 associates the component having the component name of the “order inquiry” that is the corresponding component, as a parent component, with a component (here, a component having the component name of the “order retrieval”) which is grouped while displaying a component having the component name of the “order inquiry” to be highlighted as a parent component (step A90). Here, as will be described below, when a component of which component name the “order inquiry” that is the parent component is selected by manipulating the user terminal 7, the transaction log data visualization engine 32 associates a parent component having the component name of the “order inquiry” and a component having the component name of the “order retrieval” and which is grouped to unfold and display the component of which selected parent component is set as a “parent component name” and having the component name of the “order retrieval” and which is grouped and set as a component for non-display, in the component information (see, e.g., FIGS. 32A and 32B) stored in the component information storage DB 31. Subsequently, when the transaction log data visualization engine 32 determines at step A100 that the “next component name of a group” of the component information of a component having the component name of the “order inquiry” that is the corresponding component is not the “-(none)”, the process proceeds along the NO route, that is, proceeds to step A110. Also, at step A110, the transaction log data visualization engine 32 renders a component having the component name of the “written estimate diversion making” set as the “next component name a group” and an arrow (see, e.g., FIG. 34) directing from the corresponding component having the component name of the “order inquiry” to the next component of a group of which component name is the “written estimate diversion making”. When it is determined that not all components have been processed at step A150, the process returns to step A30.

Subsequently, the transaction log data visualization engine 32 determines whether the component, of which component name is the “written estimate diversion making” set as the “next component name of a group” of component information of the component having the component name of the “order inquiry”, included in transaction of transaction ID is “0003” is already rendered or not (step A30). As a determination result, when it is determined that the component having the component name of the “written estimate diversion making” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60 that the “previous component name” of the component information of a component having the component name of the “written estimate diversion making” that is the corresponding component is set, the process proceeds along the YES route, that is, proceeds to step A80. Subsequently, when the transaction log data visualization engine 32 determines at step A80 that the “next component name of a group” of the component information of a component having the component name of the “written estimate diversion making” that is the corresponding component is not set, the process proceeds along the NO route, that is, proceeds to step A120. Also, when it is determined at step A120 that an “written estimate confirmation” is set as the “next component name of a group” of the component information of a component having the component name of the “written estimate diversion making” that is the corresponding component is set, the process proceeds along the YES route, that is, proceeds to step A140. Also, at step A140, the transaction log data visualization engine 32 renders an arrow (see, e.g., FIG. 34) directing from the corresponding component having the component name of the “written estimate diversion making” to the next component having the component name of the “written estimate confirmation”. When it is determined that not all components have been processed at step A150, the process returns to step A30.

Subsequently, the transaction log data visualization engine 32 determines whether of the component having the component name of the “written estimate confirmation” set as the “next component name of a group” of component information of a component having the component name of the “written estimate diversion making”, included in transaction of transaction ID is “0003” is already rendered or not (step A30). As a determination result, when it is determined that the component having the component name of the “written estimate confirmation” is already rendered, the process proceeds along the YES route, and when it is determined that the arrow is rendered at step A40, the process proceeds along the YES route. When it is determined that not all components have been processed at step A150, the process returns to step A30.

Subsequently, the transaction log data visualization engine 32 determines whether a component, of which component name is the “order making”, included in transaction of transaction ID is “0004” among component information read out from the component information storage DB 31 is already rendered or not (step A30). As a determination result, when it is determined that the component having the component name of the “order making” is already rendered, the process proceeds along the YES route, and when it is determined that the arrow is rendered at step A40, the process proceeds along the YES route. When it is determined that not all components have been processed at step A150, the process returns to step A30.

Subsequently, the transaction log data visualization engine 32 determines whether a component having the component name of the “order confirmation” set as a “next component name” of component information of the component, which is included in the transaction ID “0004”, of which component name is the “order making” is rendered or not (step A30). As a determination result, when it is determined that the component having the component name of the “order confirmation” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60, that the “previous component name” of the component information of a component having the component name of the “order confirmation” that is the corresponding component is set, the process proceeds along the YES route, that is, proceeds to step A80. Subsequently, when the transaction log data visualization engine 32 determines at step A80 that “-(none)” is set as the “next component name of a group” of component information of a component having the component name of the “order confirmation” that is the corresponding components, the process proceeds along the YES route, that is, proceeds to step A90. Also, at step A90, the transaction log data visualization engine 32 associates the corresponding component having the component name of the “order confirmation”, as a parent component, with components (here, components of which component names are the “order cancellation” and the “order contact”) which are grouped while displaying a component having the component name of the “order confirmation” to be highlighted as a parent component (step A90). Here, as will be described below, when a parent component having the component name of the “written estimate confirmation” is selected by manipulating the user terminal 7, the transaction log data visualization engine 32 associates a parent component having the component name of the “written estimate confirmation” and the components of which component names are the “order cancellation” and the “order contact” which are grouped to unfold and display the components of which selected parent component is set as a “parent component name” and having the component names of the “order cancellation” and “order contact” and which are grouped and set as a component for non-display, in the component information stored in the component information storage DB 31 (see, e.g., FIGS. 32A and 32B). Subsequently, when the transaction log data visualization engine 32 determines at step A100 that the “next component name of a group” of the component information of a component having the component name of the “order confirmation” that is the corresponding component is the “-(none)”, the process proceeds along the YES route, that is, proceeds to step A130. Also, at step A130, the transaction log data visualization engine 32 renders an arrow (see, e.g., FIG. 34) directing from the corresponding component having the component name of the “order confirmation” to the “end”. Accordingly, information as illustrated in FIG. 34 are created as information indicating an execution sequence of a plurality of components in all transactions of which transaction IDs are “0001”, “0002”, “0003”, “0004”, that is, the transactions for realizing a production business process. The information of execution sequence created as described above is sent to the user terminal 7 and is displayed on a screen of the display device of the user terminal 7.

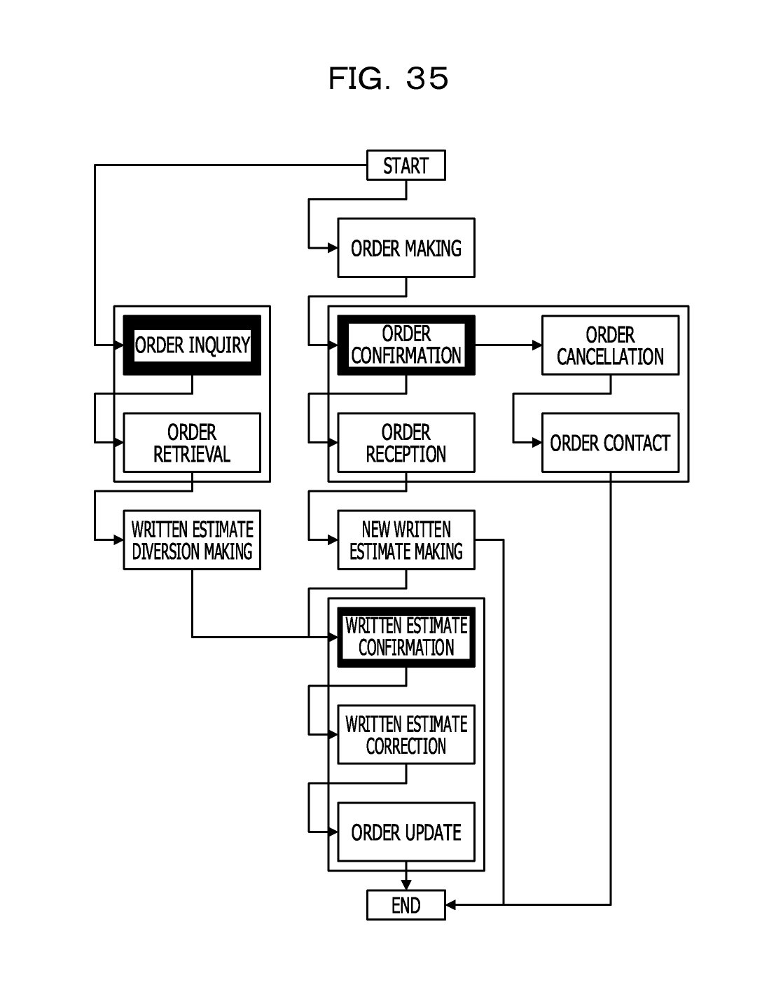

In the meantime, when a parent component is selected by manipulating the user terminal 7, that is, when there is an instruction to display a component which is set as a component for non-display, that is, a component which is the grouped with being associated with the parent component, as illustrated in FIG. 35, the transaction log data visualization engine 32 displays the execution sequence information which unfolds and displays the component which is grouped and set as a component for non-display from the parent component on the screen of the display device of the user terminal 7.

Here, when a parent component having the component name of the “order confirmation” is selected by manipulating the user terminal 7, the transaction log data visualization engine 32 unfolds and displays components of which component names are the “order reception”, the “order cancellation” and the “order contact” and which are grouped with being associated with the parent component having the component name of the “order confirmation”.

Further, when a parent component having the component name of the “written estimate confirmation” is selected by manipulating the user terminal 7, the transaction log data visualization engine 32 unfolds and displays components of which component names are the “written estimate correction” and the “order update” and which are grouped with being associated with the parent component having the component name of the “written estimate confirmation”.

Further, when a parent component having the component name of the “order inquiry” is selected by manipulating the user terminal 7, the transaction log data visualization engine 32 unfolds and displays components of which component names are the “order retrieval” and the “order update” and which are grouped with being associated with the parent component having the component name of the “order inquiry”. Further, the processing by the transaction log data visualization engine 32, that is, the process as illustrated in the flowchart of FIG. 31 may be appropriately changed. For example, step A90 in the processing by the transaction log data visualization engine 32 may be deleted. That is, a processing in which the parent component is highlighted to be displayed and the component which is grouped with being associated with the parent component may not be performed.

Further, in the present embodiment, as described above, the transaction log data analysis engine 30 sets the “next component name of a group” in the component information and performs visualization using the “next component name of a group” so that a determination of whether the visualization is performed for all components may not be performed, but the present embodiment is not limited thereto. For example, the determination of whether the visualization is performed for all components may be performed by transaction log data visualization engine 32 without setting the “next component name of a group” in the component information by the transaction log data analysis engine 30.

In this case, steps A200 and A210 instead of steps A80, A90, A100, and A110 in the flowchart of FIG. 31 as described above may be added to a processing by the transaction log data visualization engine 32, as illustrated in FIG. 36. That is, a processing which will be described below may be performed. Firstly, as illustrated in FIG. 36, the process of steps from A10 to A70 are performed as similar to the process in the flowchart of FIG. 31, and adds step A200 instead of step A80 in the flowchart of FIG. 31. Accordingly, the transaction log data visualization engine 32 determines whether an exclusion flag is set in the component information of the corresponding component. As a result of the determination, when it is determined that the exclusion flag is set in the component information of the corresponding component, the process proceeds along the YES route, that is, proceeds to step A210. Also, at step A210, the transaction log data visualization engine 32 associates the corresponding component with the parent component to be grouped and set as a component for non-display while displaying a component which is set as the “parent component name” of the component information of a corresponding component to be highlighted as a parent component and the process proceeds to step A120. Here, as will be described below, when the parent component is selected by manipulating the user terminal 7, the transaction log data visualization engine 32 associates the parent component and a component which is grouped and is not displayed to unfold and display the selected parent component set as a “parent component name” and the component which is grouped and is not displayed, in the component information (see, e.g., FIGS. 32A and 32B) stored in the component information storage DB 31. In the meantime, when it is determined that the exclusion flag is not set in the component information of the corresponding component, the process proceeds along the NO route, that is, proceeds to step A210. Also, steps A120, A130, A140 and A150 are performed as similarly in processing of the flowchart of FIG. 31 as described above.

Specifically, as illustrated in FIG. 36, the transaction log data visualization engine 32 first reads out the component information (see, e.g., FIGS. 32A and 32B) which includes a process result by the transaction log data analysis engine 30 as described above from the component information storage DB 31 using a business process name “production business” (step A10). Subsequently, the transaction log data visualization engine 32 renders “start” (step A20; see, e.g., FIG. 33).

Subsequently, the transaction log data visualization engine 32 determines whether a component, which is included in the transaction ID “0001” having the component name of “order making” among the component information (see, e.g., FIGS. 32A and 32B) read out from the component information storage DB 31 is already rendered (step A30). As a result of the determination, when it is determined that the component having the component name of “order making” is not rendered, the process proceeds along the NO route, and the component having the component name of “order making” is rendered (step A50; see, e.g., FIG. 33), and the process proceeds to step A60. Subsequently, when the transaction log data visualization engine 32 determines at step A60 that the “previous component name” of the component information of a component having the component name of “order making” that is the corresponding component is not set, the process proceeds along the NO route and renders an arrow directing from “start” to the corresponding component having the component name of “order making” (step A70; see, e.g., FIG. 33), and the process proceeds to step A200. Subsequently, when the transaction log data visualization engine 32 determines at step A200 that “Y” is not set as an exclusion flag in the component information of a component having the component name of “order making” that is the corresponding component, the process proceeds along the NO route, that is, proceeds to step A120. Also, when the transaction log data visualization engine 32 determines at step A120 that an “order confirmation” is set as the “next component name of a group” of the component information of a component having the component name of “order making” that is the corresponding component is set, the process proceeds along the YES route, that is, proceeds to step A140. Also, at step A140, transaction log data visualization engine 32 renders a component having the component name of “order confirmation” set as the “next component name” and an arrow (see, e.g., FIG. 33) directing from the corresponding component having the component name of the “order making” to the next component having the component name of “order confirmation”. When it is determined at step A150 that not all components have been processed, the process returns to step A30.

Subsequently, the transaction log data visualization engine 32 determines whether a component having the component name of “order confirmation” set as the “next component name” of the component information of a component, which is included in the transaction ID “0001” having the component name of “order making” is already rendered or not (step A30). As a result of the determination, when it is determined that the component having the component name of “order confirmation” is already rendered, the process proceeds along the YES route, and when it is determined at step A40 that the arrow is not rendered, the process proceeds along the NO route, that is, proceeds to step A60. Subsequently, when the transaction log data visualization engine 32 determines at step A60 that the “previous component name” of component information of a component having the component name of “order confirmation” that is the corresponding component is set, the process proceeds along the YES route, that is, proceeds to step A200. Subsequently, when the transaction log data visualization engine 32 determines at step A200 that “Y” is not set as an exclusion flag in the component information of a component having the component name of “order confirmation” that is the corresponding component, the process proceeds along the NO route, that is, proceeds to step A120. Also, when the transaction log data visualization engine 3 determines at step A120 that an “order reception” is set as the “next component name” of the component information of a component having the component name of “order confirmation” that is the corresponding component is set, the process proceeds along the YES route, that is, proceeds to step A140. Also, at step A140, transaction log data visualization engine 32 renders a component having the component name of “order reception” set as the “next component name” and an arrow (see, e.g., FIG. 35) directing from the corresponding component having the component name of “order confirmation” to the next component having the component name of “order reception”. When it is determined at step A150 that not all components have been processed, the process returns to step A30.

Subsequently, the transaction log data visualization engine 32 determines whether the component having the component name of “order reception” set as the “next component name” of component information of a component, which is included in the transaction ID “0001” having the component name of “order confirmation” is already rendered (step A30). As a result of the determination, when it is determined that the component having the component name of “order reception” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60 that the “previous component name” of component information of a component having the component name of “order reception” that is the corresponding component is set, the process proceeds along the YES route, that is, proceeds to step A200. Subsequently, when the transaction log data visualization engine 32 determines at step A200 that “Y” is set as an exclusion flag in component information of a component having the component name of “order reception” that is the corresponding component, the process proceeds along the YES route, that is, proceeds to step A210. Also, at step A210, the transaction log data visualization engine 32 associates the corresponding component having the component name of “order reception” with the parent component having the component name of “order confirmation” to be grouped and set as a component for non-display while displaying the component having the component name of “order confirmation” set as the “parent component name” of component information of the corresponding component having the component name of “order reception” to be highlighted as a parent component. Here, as will be described below, when the parent component is selected by manipulating the user terminal 7, the transaction log data visualization engine 32 associates the parent component having the component name of “order confirmation” and a component having the component name of “order reception” to unfold and display the component of which selected parent component which is set as a “parent component name” having the component name of “order reception” which is grouped and set as a component for non-display, in the component information (see, e.g., FIGS. 32A and 32B) stored in the component information storage DB 31. For example, the component having the component name of “order reception” may be pulled back into another memory area and associated with the parent component having the component name of “order confirmation”. Subsequently, when the transaction log data visualization engine 32 determines at step A120 that the “new written estimate making” is set as the “next component name” of a component having the component name of “order reception” that is the corresponding component, the process proceeds along the YES route, that is, proceeds to step A140. Also, at step A140, the transaction log data visualization engine 32 renders the component having the component name of “new written estimate making” set as the “next component name”, and an arrow directing from a component having the component name of “order reception” to the component having the component name of the “new written estimate making” that is the next component (see, e.g., FIG. 35). When it is determined at step A150 that not all components have been processed, the process returns to step A30.

Subsequently, the transaction log data visualization engine 32 determines whether a component having the component name of the “new written estimate making” set as the “next component name” of component information of a component, which is included in the transaction ID “0001”, of which component name is the “order reception” is already rendered (step A30). As a result of the determination, when it is determined that the component having the component name of the “new written estimate making” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60 that the “previous component name” of component information of a component having the component name of the “new written estimate making” that is the corresponding component is set, the process proceeds along the YES route, that is, proceeds to step A200. Subsequently, when the transaction log data visualization engine 32 determines at step A200 that “Y” is not set as an exclusion flag in the component information of a component of component name is the “new written estimate making” that is the corresponding component, the process proceeds along the NO route, that is, proceeds to step A120. Also, when the transaction log data visualization engine 3 determines at step A120 that a “written estimate confirmation” is set as the “next component name” of the component information of a component having the component name of the “new written estimate making” that is the corresponding component is set, the process proceeds along the YES route, that is, proceeds to step A140. Also, at step A140, the transaction log data visualization engine 32 renders a component having the component name of the “written estimate confirmation” set as the “next component name” and an arrow (see, e.g., FIG. 35) directing from the corresponding component having the component name of the “new written estimate making” to the next component having the component name of the “written estimate confirmation”. When it is determined that not all components have been processed at step A150, the process returns to step A30.

Subsequently, the transaction log data visualization engine 32 determines whether a component having the component name of the “written estimate confirmation” set as the “next component name” of component information of a component, which is included in the transaction ID “0001”, of which component name is the “new written estimate making” is already rendered (step A30). As a result of the determination, when it is determined that the component having the component name of the “written estimate confirmation” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60 that the “previous component name” of component information of a component having the component name of the “written estimate confirmation” that is the corresponding component is set, the process proceeds along the YES route, that is, proceeds to step A200. Subsequently, when the transaction log data visualization engine 3 determines at step A200 that “Y” is not set as an exclusion flag in the component information of a component of component name is the “written estimate confirmation” that is the corresponding component, the process proceeds along the NO route, that is, proceeds to step A120. Also, when the transaction log data visualization engine 32 determines at step A120 that a “written estimate correction” is set as the “next component name” of the component information of a component having the component name of the “written estimate confirmation” that is the corresponding component is set, the process proceeds along the YES route, that is, proceeds to step A140. Also, at step A140, the transaction log data visualization engine 32 renders a component having the component name of the “written estimate correction” set as the “next component name” and an arrow (see, e.g., FIG. 35) directing from the corresponding component having the component name of the “written estimate confirmation” to the next component having the component name of the “written estimate correction”. When it is determined that not all components have been processed at step A150, the process returns to step A30.

Subsequently, the transaction log data visualization engine 32 determines whether a component having the component name of the “written estimate correction” set as the “next component name” of component information of a component, which is included in the transaction ID “0001”, of which component name is the “written estimate confirmation” is already rendered or not (step A30). As a result of the determination, when it is determined that the component having the component name of the “order reception” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60 that the “previous component name” of component information of a component having the component name of the “written estimate correction” that is the corresponding component is set, the process proceeds along the YES route, that is, proceeds to step A200. Subsequently, when the transaction log data visualization engine 32 determines at step A200 that “Y” is set as an exclusion flag in component information of a component of component name is the “written estimate correction” that is the corresponding component, the process proceeds along the YES route, that is, proceeds to step A210. Also, at step A210, the transaction log data visualization engine 32 associates the corresponding component having the component name of the “written estimate correction” with the parent component having the component name of the “written estimate confirmation” to be grouped and set as a component for non-display while displaying the component having the component name of the “written estimate confirmation” set as the “parent component name” of component information of the corresponding component having the component name of the “written estimate correction” to be highlighted as a parent component. Here, as will be described below, when the parent component is selected by manipulating the user terminal 7, the transaction log data visualization engine 32 associates a component having the component name of the “written estimate correction” which is grouped with a parent component having the component name of the “written estimate confirmation” to unfold and display the component of which selected parent component is set as a “parent component name” and having the component name of “written estimate correction” which is grouped and set as a component for non-display, in the component information (see, e.g., FIGS. 32A and 32B) stored in the component information storage DB 31. For example, the component having the component name of the “written estimate correction” which is rendered may be pulled back into another memory area and associated with the parent component having the component name of the “written estimate confirmation”. Subsequently, when the transaction log data visualization engine 32 determines at step A120 that the “order update” is set as the “next component name” of a component having the component name of the “written estimate correction” that is the corresponding component, the process proceeds along the YES route, that is, proceeds to step A140. Also, at step A140, the transaction log data visualization engine 32 renders the component having the component name of the “order update” set as the “next component name”, and an arrow directing from a component having the component name of the “written estimate correction” to the component having the component name of the “order update” that is the next component (see, e.g., FIG. 35). When it is determined that not all components have been processed at step A150, the process returns to step A30.

Subsequently, the transaction log data visualization engine 32 determines whether a component having the component name of the “order update” set as the “next component name” of component information of a component, which is included in the transaction ID “0001”, of which component name is the “written estimate correction” is already rendered (step A30). As a result of the determination, when it is determined that the component having the component name of the “order update” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60 that the “previous component name” of component information of a component having the component name of the “order update” that is the corresponding component is set, the process proceeds along the YES route, that is, proceeds to step A200. Subsequently, when the transaction log data visualization engine 32 determines at step A200 that “Y” is set as an exclusion flag in component information of a component of component name is the “order update” that is the corresponding component, the process proceeds along the YES route, that is, proceeds to step A210. Also, at step A210, the transaction log data visualization engine 32 associates the corresponding component having the component name of the “order update” with the parent component having the component name of the “written estimate confirmation” to be grouped and set as a component for non-display. Here, as will be described below, when the parent component is selected by manipulating the user terminal 7, the transaction log data visualization engine 32 associates a component having the component name of the “written estimate correction” which is grouped with a parent component having the component name of the “written estimate confirmation” to unfold and display the component of which selected parent component is set as a “parent component name” and having the component name of “order update” which is grouped and set as a component for non-display, in the component information (see, e.g., FIGS. 32A and 32B) stored in the component information storage DB 31. For example, the component having the component name of the “order update” which is rendered may be pulled back into another memory area and associated with the parent component having the component name of the “written estimate confirmation”. Subsequently, when the transaction log data visualization engine 32 determines at step A120 that the “next component name” of component information of a component having the component name of the “order update” that is the corresponding component is not set, the process proceeds along the NO route, that is, proceeds to step A130. Also, at step A130, the transaction log data visualization engine 32 renders the “end”, and an arrow directing from a component having the component name of the “order update” to the “end” (see, e.g., FIG. 35). When it is determined that not all components have been processed at step A150, the process returns to step A30.

Subsequently, the transaction log data visualization engine 32 determines whether a component, of which component name is the “order making”, included in transaction of transaction ID is “0002” among component information read out from the component information storage DB 31 (see, e.g., FIGS. 32A and 32B) is already rendered or not (step A30). As a determination result, when it is determined that the component having the component name of the “order making” is already rendered, the process proceeds along the YES route, and when it is determined that the arrow is rendered at step A40, and the process proceeds along the YES route. When it is determined that not all components have been processed at step A150, the process returns to step A30.

Subsequently, the transaction log data visualization engine 32 determines a component having the component name of the “order confirmation” set as the “next component name” of component information of a component, which is included in the transaction of which transaction ID is “0002”, of which component name is the “order making” is already rendered or not (step A30). As a determination result, when it is determined that the component having the component name of the “order confirmation” is already rendered, the process proceeds along the YES route, and when it is determined that the arrow is rendered at step A40, and the process proceeds along the YES route. When it is determined that not all components have been processed at step A150, the process returns to step A30.

Subsequently, the transaction log data visualization engine 32 determines whether a component having the component name of the “order reception” set as the “next component name” of component information of a component, which is included in the transaction of which transaction ID is “0002”, of which component name is the “order confirmation” is already rendered or not (step A30). As a determination result, when it is determined that the component having the component name of the “order reception” is already rendered, the process proceeds along the YES route, and when it is determined that the arrow is rendered at step A40, and the process proceeds along the YES route. When it is determined that not all components have been processed at step A150, the process returns to step A30.

Subsequently, the transaction log data visualization engine 32 determines whether a component having the component name of the “new written estimate making” set as the “next component name” of component information of a component, which is included in the transaction of which transaction ID is “0002”, of which component name is the “order reception” is already rendered or not (step A30). As a determination result, when it is determined that the component having the component name of the “new written estimate making” is already rendered, the process proceeds along the YES route, and when it is determined that the arrow is rendered at step A40, and the process proceeds along the YES route. When it is determined that not all components have been undergone at step A150, the process returns to step A30.

Subsequently, the transaction log data visualization engine 32 determines whether a component having the component name of the “written estimate confirmation” set as the “next component name” of component information of a component, which is included in the transaction of which transaction ID is “0002”, of which component name is the “new written estimate making” is already rendered or not (step A30). As a determination result, when it is determined that the component having the component name of the “written estimate confirmation” is already rendered, the process proceeds along the YES route, and when it is determined that the arrow is rendered at step A40, and the process proceeds along the YES route. When it is determined that not all components have been processed at step A150, the process returns to step A30.

Subsequently, the transaction log data visualization engine 32 determines whether a component, which is included in the transaction ID “0003”, of which component name is the “order inquiry” among component information (see, e.g., FIGS. 32A and 32B) read out from the component information storage DB 31 is already rendered or not (step A30). As a result of the determination, when it is determined that the component having the component name of the “order inquiry” is not rendered, the process proceeds along the NO route, and the component having the component name of the “order inquiry” is rendered (step A50; see, e.g., FIG. 33), and the process proceeds to step A60. Subsequently, when the transaction log data visualization engine 32 determines at step A60 that the “previous component name” of the component information of a component having the component name of the “order inquiry” that is the corresponding component is not set, the process proceeds along the NO route and renders an arrow directing from “start” to the corresponding component having the component name of the “order inquiry” (step A70; see, e.g., FIG. 35), and the process proceeds to step A200. Subsequently, when the transaction log data visualization engine 32 determines at step A200 that “Y” is not set as an exclusion flag in the component information of a component of component name is the “order inquiry” that is the corresponding component, the process proceeds along the NO route, that is, proceeds to step A120. Also, when the transaction log data visualization engine 3 determines at step A120 that the “order retrieval” is set as the “next component name” of the component information of a component having the component name of the “order inquiry” that is the corresponding component is set, the process proceeds along the YES route, that is, proceeds to step A140. Also, at step A140, the transaction log data visualization engine 32 renders a component having the component name of the “order retrieval” set as the “next component name” and an arrow (see, e.g., FIG. 35) directing from the corresponding component having the component name of the “order inquiry” to the next component having the component name of the “order retrieval”. When it is determined that not all components have been processed at step A150, the process returns to step A30.

Subsequently, the transaction log data visualization engine 32 determines whether a component having the component name of the “order retrieval” set as the “next component name” of component information of a component, which is included in the transaction of which transaction ID is “0001”, of which component name is the “order inquiry” is already rendered or not (step A30). As a result of the determination, when it is determined that the component having the component name of the “order retrieval” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60 that the “previous component name” of component information of a component having the component name of the “order retrieval” that is the corresponding component is set, the process proceeds along the YES route, that is, proceeds to step A200. Subsequently, when the transaction log data visualization engine 32 determines at step A200 that “Y” is set as an exclusion flag the component information of a component of component name is the “order retrieval” that is the corresponding component, the process proceeds along the YES route, that is, proceeds to step A210. Also, at step A210, the transaction log data visualization engine 32 associates the corresponding component having the component name of the “order retrieval” with the parent component having the component name of the “order inquiry” to be grouped and set as a component for non-display. Here, as will be described below, when the parent component is selected by manipulating the user terminal 7, the transaction log data visualization engine 32 associates a component having the component name of the “order retrieval” which is grouped with a parent component having the component name of the “order inquiry” to unfold and display the component of which selected parent component is set as a “parent component name” and having the component name of “order retrieval” which is grouped and set as a component for non-display, in the component information (see, e.g., FIGS. 32A and 32B) stored in the component information storage DB 31. For example, the component having the component name of the “order retrieval” which is rendered may be pulled back into another memory area and associated with the parent component having the component name of the “order inquiry”. Subsequently, when the transaction log data visualization engine 32 determines at step A120 that the “written estimate diversion making” is set as the “next component name” of component information of a component having the component name of the “order retrieval” that is the corresponding component, the process proceeds along the YES route, that is, proceeds to step A140. Also, at step A140, the transaction log data visualization engine 32 renders the component having the component name of the “written estimate diversion making” set as the “next component name”, and an arrow directing from a corresponding component having the component name of the “order retrieval” to the next component having the component name of the “written estimate diversion making” (see, e.g., FIG. 35). When it is determined that not all components have been processed at step A150, the process returns to step A30

Subsequently, the transaction log data visualization engine 32 determines whether a component having the component name of the “written estimate diversion making” set as the “next component name” of component information of a component, which is included in the transaction of which transaction ID is “0003”, of which component name is the “order retrieval” is already rendered or not (step A30). As a result of the determination, when it is determined that the component having the component name of the “written estimate diversion making” is rendered, the process proceeds along the YES route, and the arrow is not rendered at step A40, and the process proceeds along the NO route, that is, proceeds to step A60. Subsequently, when the transaction log data visualization engine 32 determines at step A60 that the “previous component name” of the component information of a component having the component name of the “written estimate diversion making” that is the corresponding component is set, the process proceeds along the YES route, that is, proceeds to step A200. Subsequently, when the transaction log data visualization engine 32 determines at step A200 that “Y” is not set as an exclusion flag in the component information of a component of component name is the “written estimate diversion making” that is the corresponding component, the process proceeds along the NO route, that is, proceeds to step A120. Also, when the transaction log data visualization engine 3 determines at step A120 that the “written estimate confirmation” is set as the “next component name” of the component information of a component having the component name of the “written estimate diversion making” that is the corresponding component is set, the process proceeds along the YES route, that is, proceeds to step A140. Also, at step A140, the transaction log data visualization engine 32 renders an arrow (see, e.g., FIG. 35) directing from the corresponding component having the component name of the “written estimate diversion making” to the next component having the component name of the “written estimate confirmation”. When it is determined that not all components have been processed at step A150, the process returns to step A30.

Subsequently, the transaction log data visualization engine 32 determines whether a component having the component name of the “written estimate confirmation” set as the “next component name” of component information of a component, which is included in the transaction of which transaction ID is “0003”, of which component name is the “written estimate diversion making” is already rendered or not (step A30). As a determination result, when it is determined that the component having the component name of the “written estimate confirmation” is already rendered, the process proceeds along the YES route, and when it is determined that the arrow is rendered at step A40, the process proceeds along the YES route. When it is determined that not all components have been processed at step A150, the process returns to step A30.

Subsequently, the transaction log data visualization engine 32 determines whether a component having the component name of the “order making” which is included in the transaction of which transaction ID is “0004” among the component information read out from the component information storage DB 31 (see, e.g., FIGS. 32A and 32B) is already rendered or not (step A30). As a result of the determination, when it is determined that the component having the component name of the “order making” is already rendered, the process proceeds along the YES route, and when it is determined that the arrow is rendered at step A40, the process proceeds along the YES route. When it is determined that not all components have been processed at step A150, the process returns to step A30.

Subsequently, the transaction log data visualization engine 32 whether a component having the component name of the “order confirmation” set as the “next component name” of component information of a component, which is included in the transaction of which transaction ID is “0004”, of which component name is the “order making” is already rendered or not (step A30). As a result of the determination, when it is determined that the component having the component name of the “order confirmation” is already rendered, the process proceeds along the YES route, and when it is determined that the arrow is not rendered, the process proceeds along the NO route, that is proceeds to step A60. Subsequently, when the transaction log data visualization engine 32 determines at step A60 that the “previous component name” of the component information of a component having the component name of the “order confirmation” that is the corresponding component is set, the process proceeds along the YES route, that is proceeds to step A200. Subsequently, when the transaction log data visualization engine 32 determines at step A200 that “Y” is not set as an exclusion flag in the component information of a component of component name is the “order confirmation” that is the corresponding component, the process proceeds along the NO route, that is, proceeds to step A120. Also, when the transaction log data visualization engine 32 determines at step A120 that an “order cancellation” is set as the “next component name” of the component information of a component having the component name of the “order confirmation” that is the corresponding component is set, the process proceeds along the YES route, that is, proceeds to step A140. Also, at step A140, the transaction log data visualization engine 32 renders a component having the component name of the “order cancellation” set as the “next component name” and an arrow (see, e.g., FIG. 35) directing from the corresponding component having the component name of the “order confirmation” to the next component having the component name of the “order cancellation”. When it is determined that not all components have been processed at step A150, the process returns to step A30.

Subsequently, the transaction log data visualization engine 32 determines whether a component having the component name of the “order cancellation” set as the “next component name” of component information of a component, which is included in the transaction of which transaction ID is “0004”, of which component name is the “order confirmation” is already rendered (step A30). As a result of the determination, when it is determined that the component having the component name of the “order cancellation” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60 that the “previous component name” of component information of a component having the component name of the “order cancellation” that is the corresponding component is set, the process proceeds along the YES route, that is, proceeds to step A200. Subsequently, when the transaction log data visualization engine 32 determines at step A200 that “Y” is set as an exclusion flag in component information of a component of component name is the “order cancellation” that is the corresponding component, the process proceeds along the YES route, that is, proceeds to step A210. Also, at step A210, the transaction log data visualization engine 32 associates the corresponding component having the component name of the “order cancellation” with the parent component having the component name of the “order confirmation” to be grouped and set as a component for non-display. Here, as will be described below, when the parent component is selected by manipulating the user terminal 7, the transaction log data visualization engine 32 associates a component having the component name of the “order cancellation” which is grouped with a parent component having the component name of the “order confirmation” to unfold and display the component of which selected parent component is set as a “parent component name” and having the component name of “order cancellation” which is grouped and set as a component for non-display, in the component information (see, e.g., FIGS. 32A and 32B) stored in the component information storage DB 31. For example, the component having the component name of the “order cancellation” which is rendered may be pulled back into another memory area and associated with the parent component having the component name of the “order confirmation”. Subsequently, when the transaction log data visualization engine 32 determines at step A120 that the “order contact” is set as the “next component name” of a component having the component name of the “order cancellation” that is the corresponding component, the process proceeds along the YES route, that is, proceeds to step A140. Also, at step A140, the transaction log data visualization engine 32 renders the component having the component name of the “order contact” set as the “next component name”, and an arrow directing from a corresponding component having the component name of the “order cancellation” to a next component having the component name of the “order contact” (see, e.g., FIG. 35). When it is determined that not all components have been processed at step A150, the process returns to step A30.

Subsequently, the transaction log data visualization engine 32 determines whether a component having the component name of the “order contact” set as the “next component name” of component information of a component, which is included in the transaction of which transaction ID is ID “0004”, of which component name is the “order cancellation” is already rendered or not (step A30). As a result of the determination, when it is determined that the component having the component name of the “order contact” is already rendered, the process proceeds along the YES route, and when it is determined that the arrow is not rendered at step A40, the process proceeds along the NO route, that is, proceeds to step A60. Subsequently, when the transaction log data visualization engine 32 determines at step A60 that the “previous component name” of component information of a component having the component name of the “order contact” that is the corresponding component is set, the process proceeds along the YES route, that is, proceeds to step A200. Subsequently, when the transaction log data visualization engine 32 determines at step A200 that “Y” is set as an exclusion flag in component information of a component of component name is the “order contact” that is the corresponding component, the process proceeds along the YES route, that is, proceeds to step A210. Also, at step A210, the transaction log data visualization engine 32 associates the corresponding component having the component name of the “order contact” with the parent component having the component name of the “order confirmation” to be grouped and set as a component for non-display. Here, as will be described below, when the parent component is selected by manipulating the user terminal 7, the transaction log data visualization engine 32 associates a component having the component name of the “order contact” which is grouped with a parent component having the component name of the “order confirmation” to unfold and display the component of which selected parent component is set as a “parent component name” and having the component name of “order contact” which is grouped and set as a component for non-display, in the component information (see, e.g., FIGS. 32A and 32B) stored in the component information storage DB 31. For example, the component having the component name of the “order contact” which is rendered may be pulled back into another memory area and associated with the parent component having the component name of the “order confirmation”. Subsequently, when the transaction log data visualization engine 32 determines at step A120 that the “next component name” of the component information of a component having the component name of the “order contact” that is the corresponding component is not set, the process proceeds along the NO route, that is, proceeds to step A130. Also, at step A130, the transaction log data visualization engine 32 renders an arrow directing from a corresponding component having the component name of the “order contact” to a next component having the component name of the “end” (see, e.g., FIG. 35). When it is determined that the processing has been performed for all components at step A150, the process ends. Accordingly, information as illustrated in FIG. 35 are created as information indicating an execution sequence of a plurality of components in all transactions of which transaction IDs are “0001”, “0002”, “0003”, “0004”, that is, the transactions for realizing a production business process. The information of execution sequence created as described above is sent to the user terminal 7 and is displayed on a screen of the display device of the user terminal 7.

Further, the processes performed by the transaction log data visualization engine 32 as described above, that is, the processes illustrated in the flowchart of FIG. 36 may be appropriately changed. For example, a process for making a component to set as a component for non-display may be performed by deleting a rendered component for which an exclusion flag is set instead of the process at step A210 in the process performed by the transaction log data visualization engine 32 as describe above. Further, at step A140 of FIG. 36, in a case where the exclusion flag is set in component information of the next component when a next component is rendered, the next component may not be rendered at step A30. In this case, when it is determined that the component is not rendered, it is determined again whether the exclusion flag is set or not. When it is determined that the exclusion flag is set, the component may not be rendered. Further, at step A210, the same process as that of step A90 of the flowchart of FIG. 31 may be performed as described above. Also, steps A200 and A210 of FIG. 36 may be performed before steps A60 and A70.

Accordingly, the analysis program, the analysis method and the analysis apparatus according to the present embodiment have an advantage that the log data related to a business that includes information regarding the calling relationship between programs in a transaction which implements a business process can be analyzed to reduce the redundancy of the analysis result in order to provide more useful analysis result. Therefore, it becomes possible to incorporate and systemize the analysis apparatus 1 into an information processing system which includes the business system 2 to obtain more useful analysis result. Accordingly, it becomes possible to compress the components for which countermeasure are needed to make it easy to improve or optimize the business process.

Further, the present invention is not limited to the configurations described in the embodiments described above, and may be modified variously without departing from the gist of the present invention. For example, in the modifications and embodiments described above, the transaction log data analysis apparatus 1 is configured such that the transaction log data analysis program is installed into a computer. However, the transaction log data analysis program (transaction log data analysis program for causing a computer to implement the functions as described above) that, when executed, causes a computer to execute the processes in the embodiments and their respective modifications described above may be provided by being stored in a computer-readable recording medium.

Here, the recording medium may include, for example, a memory such as a semiconductor memory, a magnetic disc, an optical disc (e.g., CD-ROM, DVD, a blu-ray disc), an MO (Magneto Optical) Disc, in which a program can be recorded. Further, the magnetic disc, the optical disc and the magneto optical disc are also called a portable recording medium.

In this case, the transaction log data analysis program is read out from the portable recording medium through a driver device and installed into a storage device. Accordingly, the transaction log data analysis apparatus and the transaction log data analysis method described in the embodiments and their respective modifications described above are implemented. And a CPU reads out the transaction log data analysis program installed into the storage device onto the memory to execute the transaction log data analysis program as in the embodiments and their respective medications described above, so that the respective processes in the embodiments and their respective modifications described above are performed. Further, the computer may read out the program directly from the portable recording medium and execute the processes according to the program.

Further, the transaction log data analysis program that causes the computer to perform the processes in the embodiments and their respective medications described above may be provided, for example, through a network as a transfer medium (such as, for example, a communication line such as the Internet, a public channel or a dedicated channel). For example, the transaction log data analysis program provided on other computers such as, for example, a server, by a program provider may be installed on a storage device through, for example, a network such as the Internet or the LAN, and a communication interface. Accordingly, the transaction log data analysis apparatus and the transaction log data analysis method described in the embodiments and their respective modifications described above are implemented, and the CPU reads out the transaction log data analysis program installed in the storage device onto the memory and execute the program as in the embodiments and their respective modifications described above, such that the respective processes in the embodiments and their respective modifications described above are performed. Further, the computer may sequentially perform a series of processes according to a program received each time when the program is transferred from other computers such as, for example, a server.

Accordingly, according to the analysis program, the analysis method and the analysis apparatus, there is an advantage that it is possible to analyze the log data related to a business that includes information regarding the calling relationship between programs in a transaction in which a business process is implemented and reduce the redundancy of the analysis result in order to provide more useful analysis result.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a program for causing a computer to execute a process, the process comprising:
analyzing log data related to a business which includes information regarding a calling relationship between programs in a transaction in which a plurality of programs are executed in order to implement a business process; and
generating information which indicates an execution sequence of a plurality of programs in the transaction by excluding a program that has a program executed immediately before and a program executed immediately after, based on the analyzing.

2. The computer-readable storage medium according to claim 1,
wherein the log data includes attribute information, and
the generating leaves a program executed immediately before and a program of which the attribute information is changed among programs each having a program executed immediately before and a program executed immediately after.

3. The computer-readable storage medium according to claim 1,
wherein the generating leaves a program executed first in the transaction and another program that does not have a program executed immediately before and a program executed immediately after.

4. An analysis method comprising:
analyzing log data related to a business which includes information regarding a calling relationship between programs in a transaction in which a plurality of programs are executed in order to implement a business process; and
generating information which indicates an execution sequence of a plurality of programs in the transaction by excluding a program that has a program executed immediately before and a program executed immediately after, based on the analyzing.

5. The analysis method according to claim 4,
wherein the log data includes attribute information, and
the generating leaves a program executed immediately before and a program of which the attribute information is changed among programs each having a program executed immediately before and a program executed immediately after.

6. The analysis method according to claim 4,
wherein the generating leaves a program executed first in the transaction and another program that does not have a program executed immediately before and a program executed immediately after.

7. An analysis apparatus comprising:
a processor configured to analyze log data related to a business which includes information regarding a calling relationship between programs in a transaction in which a plurality of programs are executed in order to implement a business process and to generate information which indicates an execution sequence of a plurality of programs in the transaction by excluding a program that has a program executed immediately before and a program executed immediately after, based on a result of the analyzing.

8. The analysis apparatus according to claim 7,
wherein the log data includes attribute information, and
the processor is configured to leave a program executed immediately before and a program of which the attribute information is changed among programs each having a program executed immediately before and a program executed immediately after when the processor analyzes log data.

9. The analysis apparatus according to claim 7,
wherein the processor is configured to leave a program executed first in the transaction and another program that does not have a program executed immediately before and a program executed immediately after when the processor analyzes log data.
